(19) United States
(12) Patent Application Publication
(10) Pub. No.: US 2025/0202534 A1
(43) Pub. Date: Jun. 19, 2025

(54) BACKSCATTER MODE SWITCHING AND BEAM MANAGEMENT CONSIDERATIONS

(71) Applicant: QUALCOMM Incorporated, San Diego, CA (US)

(72) Inventors: Ahmed ELSHAFIE, San Diego, CA (US); Zhikun WU, Beijing (CN); Yuchul KIM, San Diego, CA (US); Huilin XU, Temecula, CA (US)

(21) Appl. No.: 18/849,432

(22) PCT Filed: May 11, 2022
(86) PCT No.: PCT/CN2022/092173

§ 371 Date: Sep. 20, 2024

(51) Int. Cl. H04B 7/024; H04B 7/06; H04L 5/00

(52) U.S. Cl. CPC H04B 7/024; H04B 7/0626; H04B 7/06952; H04L 5/0051

(57) ABSTRACT

Aspects are provided which allow a source device to indicate a joint operation mode by which the source device may communicate information with a destination device via a backscatter device. The source device transmits, to a destination device, an indication of one of a plurality of joint operation modes of the source device and the backscatter device, and transmits a signal carrying first information. The signal carrying the first information is configured to activate the backscatter device to communicate a signal carrying second information from the backscatter device to the destination device, and the one of the plurality of joint operation modes indicates the first information and the second information. The destination device receives the signal carrying the second information from the backscatter device. Other aspects provide considerations which the source device, the backscatter device, and destination device may apply for beam management.

### BACKGROUND

### Technical Field

The present disclosure generally relates to wireless communication and wireless communication systems, and more particularly, to wireless communication between a source device and a destination device via a backscatter device, as well as a corresponding wireless communication system.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

For example, some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, a computer program, and an apparatus are provided. The apparatus may be a source device. The source device transmits, to a destination device, an indication of one of a plurality of joint operation modes of the source device and a backscatter device. The source device transmits a first signal carrying first information. The first signal carrying the first information is configured to activate the backscatter device to communicate a second signal carrying second information from the backscatter device to the destination device. The one of the plurality of joint operation modes indicates the first information and the second information.

In an aspect of the disclosure, a method, a computer-readable medium, computer program, and an apparatus are provided. The apparatus may be a destination device. The destination device receives, from a source device, an indication of one of a plurality of joint operation modes of the source device and a backscatter device. The destination device receives a first signal from the backscatter device. The first signal includes a second signal carrying first information from the source device and second information from the backscatter device. The second signal is configured to activate the backscatter device to communicate the first signal. The one of the plurality of joint operation modes indicates the first information and the second information.

In an aspect of the disclosure, a method, a computer-readable medium, computer program, and an apparatus are provided. The apparatus may be a backscatter device. The backscatter device may receive, from a source device, an indication of one of a plurality of operation modes of the backscatter device; receive a signal carrying first information from the source device; and in response to receiving the signal carrying the first information from the source device, communicate a signal carrying second information from the backscatter device to a destination device; wherein the one of the plurality of operation modes indicates the second information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 illustrate example aspects of a sidelink slot structure.

FIG. 4 is a diagram illustrating an example of a first device and a second device involved in wireless communication based, e.g., on sidelink communication.

FIG. 5 is a diagram illustrating an example where a radio frequency (RF) source sends data directly to an RF reader and to a backscatter device.

FIGS. 6A-6C are diagrams illustrating examples where the backscatter device applies amplitude shift keying to modulate stored data onto a signal received from the RF source.

FIG. 7 is a diagram illustrating an example of an RF source which may transmit information (e.g., data or reference signals) to an RF reader according to one of multiple configured modes.

FIG. 8 is a diagram illustrating an example of a beam management procedure involving an RF source, an RF reader, and a backscatter device.

FIG. 9 is a diagram illustrating an example of a two-phase process by which an RF source transmits reference signals to an RF reader such that the RF reader may determine best beams for receiving information from the RF source.

FIG. 10 is a diagram illustrating an example of an RF source which transmits a reference signal (RS) to an RF reader via a plurality of backscatter devices.

FIG. 11 is a diagram illustrating another example of an RF source which communicates with an RF reader indirectly via a backscatter device.

FIG. 12 is a diagram illustrating an example showing a difference in frequencies between a source RF signal and a backscatter device signal.

FIG. 13 is a diagram illustrating an example of an RFID reader circuit.

FIG. 14 is a call flow diagram between an RF source, a backscatter device, and an RF reader.

FIG. 15 is a flowchart of a method of wireless communication at a source device.

FIGS. 16A-16B show a flowchart of a method of wireless communication at a destination device.

FIG. 17 is a diagram illustrating an example of a hardware implementation for an example apparatus.

FIG. 18 is a diagram illustrating another example of a hardware implementation for another example apparatus.

FIG. 19 is a flowchart of a method of wireless communication at a backscatter device.

### DETAILED DESCRIPTION

The detailed description set forth below in connection with the appended drawings is intended as a description of various exemplary configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Energy harvesting (EH) technology has acquired a large amount of interest in the context of passive Internet of Things (IoT). An EH device may opportunistically harvest energy from the environment, such as solar, heat or other ambient radiation, and the device may apply the energy for later use (e.g., backscatter communication which will be explained below). Protocol enhancements have been considered to support EH device operation on intermittently available energy harvested from the environment. For example, enhancements have considered variations in the expected amount of harvested energy and traffic experienced by an EH device, or considered EH devices which may not sustain continuous reception or transmission for a long amount of time.

Although some EH devices can store harvested energy in a rechargeable battery, many EH devices typically do not include batteries in which ambient RF energy may be stored or otherwise have limited power capability. These power-limited devices nevertheless support backscatter communication in passive IoT. Additionally, other devices which do not harvest energy from the environment, but which obtain power from an external battery or other power source, may support backscatter communication in semi-passive IoT. Such devices which perform backscatter communication, whether using energy from the environment (e.g., in an ambient RF signal), using energy supplied by an external or internal power source, or using energy from a combination of the foregoing, are referred to throughout this disclosure as backscatter devices. For example, backscatter devices such as passive RFID tags, reduced capability (RedCap) UEs (e.g., UEs with reduced power capability), and other passive IoT devices (e.g., EH devices) or semi-passive IoT devices (e.g., RFID tags connected to an external battery) may collect energy from one or more of a variety of energy sources. For instance, energy may be obtained from a power source, from an ambient RF signal (e.g., a continuous wave (CW), etc.) from an RF source or other source device, from a solar cell which harvests solar energy from the environment, from a rechargeable battery which may be charged from energy harvested from an RF signal or other energy source, from a combination of the foregoing, and the like. The backscatter devices may subsequently redirect or backscatter an RF signal (e.g., the ambient RF signal or another RF signal) to a RF reader or other destination device (which in some cases may be the same device as the RF source). For example, a passive RFID tag may store its own data (e.g., position tracking data, etc.) and, using the collected energy from a received ambient RF signal, the RFID tag may modulate the ambient RF signal with its data to form a backscattered signal to a reader for various purposes (e.g., position tracking, inventorying, etc.). Backscatter devices may include power-consuming RF components such as analog to digital converters, mixers, and oscillators which the devices may apply in order to modulate an RF signal with stored data for backscatter communication.

An RF signal from the source device (referred to here as Device 1) may be used to power, trigger or otherwise activate a backscatter device to provide its own data to the destination device (referred to here as Device 2). For instance, the energy from an incident wave, CW, or other RF signal from Device 1 may activate the mixer(s), oscillator(s), or other RF components of the backscatter device, other hardware of the backscatter device, or one or more processors executing software or firmware on the backscatter device, to modulate the signal received from Device 1 with data stored in the backscatter device to backscatter to Device 2. Alternatively, other energy sources may be used to activate the backscatter device. For instance, a passive IoT device may obtain power from an RF signal fully or partially (e.g., in combination with other power sources). For example, a passive RFID tag may have a solar cell which obtains a portion of the power from harvested solar energy, while the remaining power may be obtained from an RF signal. Similarly, a semi-passive IoT device may obtain power from an already charged battery (e.g., a battery used to activate the backscatter device that is not rechargeable from energy harvesting or RF signals), or even a rechargeable battery that may be charged from harvested energy from RF signals or other sources.

The RF components, hardware, processors, or other components of the backscatter device may be passive (e.g., powered by the RF signal) or non-passive (e.g., powered by an external battery). Device 2 may then receive the modulated, backscattered signal carrying data from Device 1 and the data from the backscatter device. Device 2 may then decode the received data from the backscatter device, for example, using interference cancellation techniques. In this example, the data from the backscatter device may include position data, measurements taken by the backscatter device, sensed data, or other application-specific data (together referred to in this disclosure as user data), which Device 2 may read from the backscattered signal. Similarly, data from Device 1 may include other user data, which Device 2 may also read from the backscattered signal.

However, in other examples, a backscattered signal from a backscatter device may not necessarily carry user data. For instance, the information from Device 1 and the backscatter device may either or both represent reference signals rather than user data, and thus Device 1 or the backscatter device may either or both transmit reference signals for beam management or channel sounding rather than signals carrying user data. Accordingly, aspects of the present disclosure allow Device 1 to indicate whether Device 2 is to receive data signals or other signals such as reference signals from either or both Device 1 and the backscatter device, so that Device 2 may ascertain whether user data from Device 1, user data from the backscatter device, or no user data is to be expected. Based on this information, Device 2 may adjust its decoding (e.g., its interference cancellation technique) accordingly.

Moreover, aspects of the present disclosure provide considerations which Device 1, the backscatter device, and Device 2 may apply for beam management. For instance, in one example, Device 1 or Device 2 may perform beam management using backscattered signals from the backscatter device. In another example, Device 1 may configure the backscatter device (or the backscatter device may be pre-configured) to transmit a reference signal for channel sounding or beam management purposes. In such case, the backscatter device may not transmit user data to Device 2. In a further example, Device 1 may configure the backscatter device (or the backscatter device may be pre-configured) for distributed beamforming of data from signals from Device 1. For example, the backscatter device may operate as a beamforming element for Device 1 which provides beamformed signals via an indirect path between Device 1 and Device 2 for diversity purposes. In an additional example, Device 2 may provide CSI reports to Device 1 and the backscatter device for beamforming purposes.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

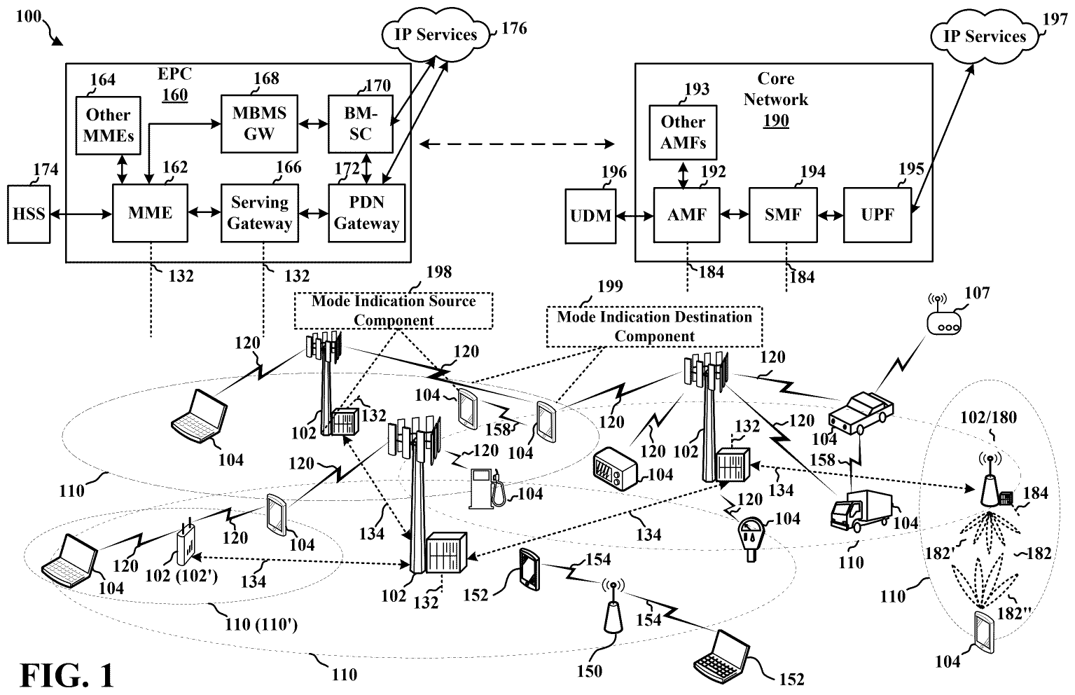

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR. Sidelink may in general refer to wireless communications between wireless devices, such as D2D communications, without relaying their data via the network.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic is spectrum often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

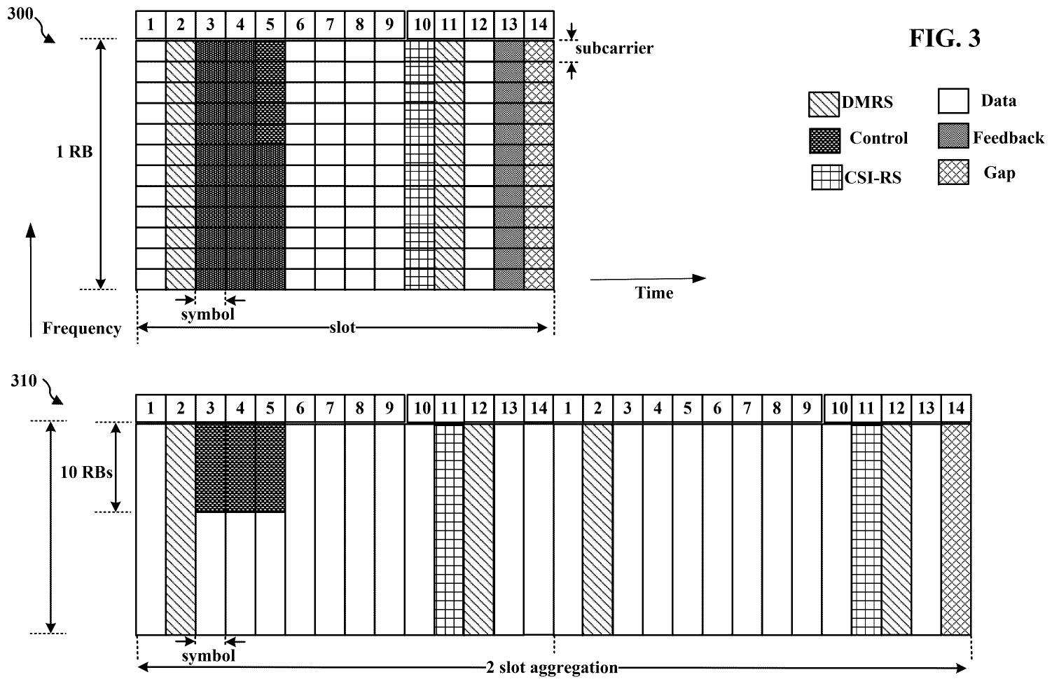

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2V/V2X/V2I or other D2D communication, such as Proximity Services (ProSe), etc. Communication based on V2V, V2X, V2I, and/or D2D may also be transmitted and received by other transmitting and receiving devices, such as Road Side Unit (RSU) 107, etc. Aspects of the communication may be based on PC5 or sidelink communication, e.g., as described in connection with the example in FIG. 3.

Although the present disclosure may focus on NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies. The concepts and various aspects described herein may also be applicable to vehicle-to-everything (V2X) or other similar areas, such as D2D communication, IoT communication, Industrial IoT (IIoT) communication, and/or or other standards/protocols for communication in wireless/access networks. Additionally or alternatively, the concepts and various aspects described herein may be of particular applicability to one or more specific areas, such as vehicle-to-pedestrian (V2P) communication, pedestrian-to-vehicle (P2V) communication, vehicle-to-infrastructure (V2I) communication, and/or other frameworks/models for communication in wireless/access networks.

Referring again to FIG. 1, in certain aspects, the UE 104 or base station 102, 180 may be a source device including a mode indication source component 198. The mode indication source component 198 may be configured to transmit, to a destination device (e.g., a UE), an indication of one of a plurality of joint operation modes of the source device and a backscatter device, and to transmit a signal carrying first information. Here, the signal carrying the first information may be configured to activate the backscatter device to communicate a modulated signal carrying second information from the backscatter device to the destination device, and the one of the plurality of joint operation modes indicates the first information and the second information.

Still referring to FIG. 1, in certain aspects, the UE 104 may be a destination device including a mode indication destination component 199. The mode indication destination component 199 may be configured to receive, from a source device, an indication of one of a plurality of joint operation modes of the source device and a backscatter device, and to receive a modulated signal from the backscatter device. The modulated signal may include a signal carrying first information from the source device and modulated with second information from the backscatter device. The signal may be configured to activate the backscatter device to communicate the modulated signal. The one of the plurality of joint operation modes indicates the first information and the second information.

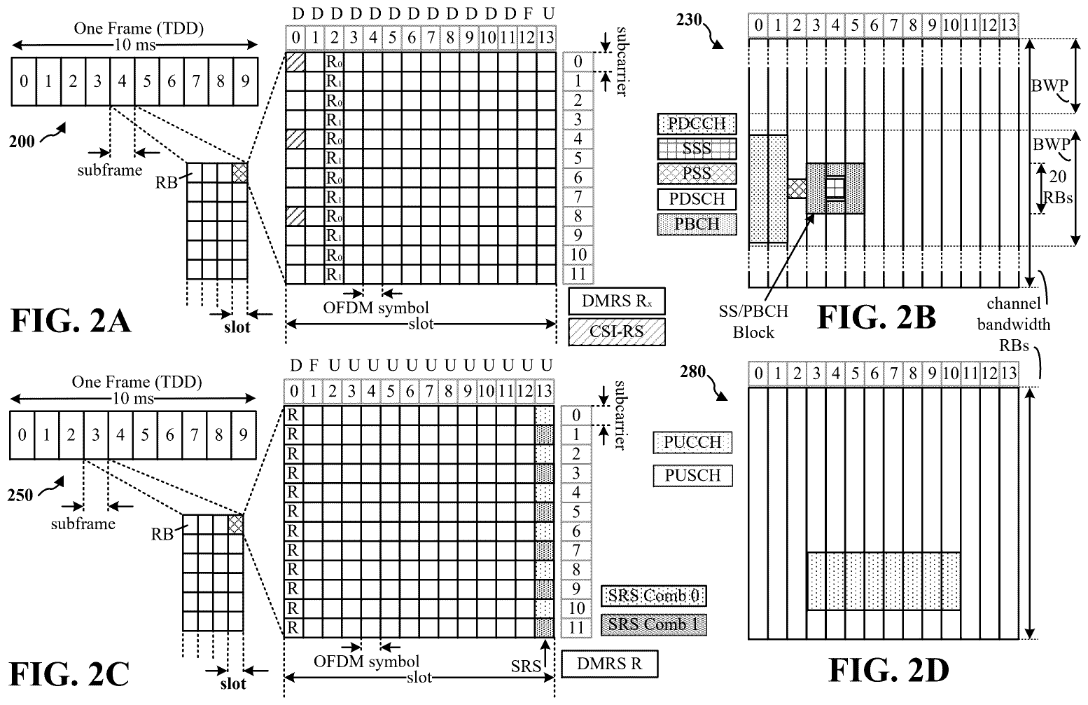

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs may carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS may be used by a UE 104 to determine subframe/symbol timing and a physical layer identity. A secondary synchronization signal (SSS) may be within symbol 4 of particular subframes of a frame. The SSS may be used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

FIG. 3 illustrates example diagrams 300 and 310 illustrating example slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include, for example, 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single slot transmission, e.g., which may correspond to a 0.5 ms transmission time interval (TTI). Diagram 310 illustrates an example two-slot aggregation, e.g., an aggregation of two 0.5 ms TTIs. Diagram 300 illustrates a single RB, whereas diagram 310 illustrates N RBs. In diagram 310, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 3, some of the REs may comprise control information, e.g., along with demodulation RS (DMRS). FIG. 3 also illustrates that symbol(s) may comprise CSI-RS. The symbols in FIG. 3 that are indicated for DMRS or CSI-RS indicate that the symbol comprises DMRS or CSI-RS REs. Such symbols may also comprise REs that include data. For example, if a number of ports for DMRS or CSI-RS is 1 and a comb-2 pattern is used for DMRS/CSI-RS, then half of the REs may comprise the RS and the other half of the REs may comprise data. A CSI-RS resource may start at any symbol of a slot, and may occupy 1, 2, or 4 symbols depending on a configured number of ports. CSI-RS can be periodic, semi-persistent, or aperiodic (e.g., based on DCI triggering). For time/frequency tracking, CSI-RS may be either periodic or aperiodic. CSI-RS may be transmitted in busts of two or four symbols that are spread across one or two slots. The control information may comprise Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 3. Multiple slots may be aggregated together. FIG. 3 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

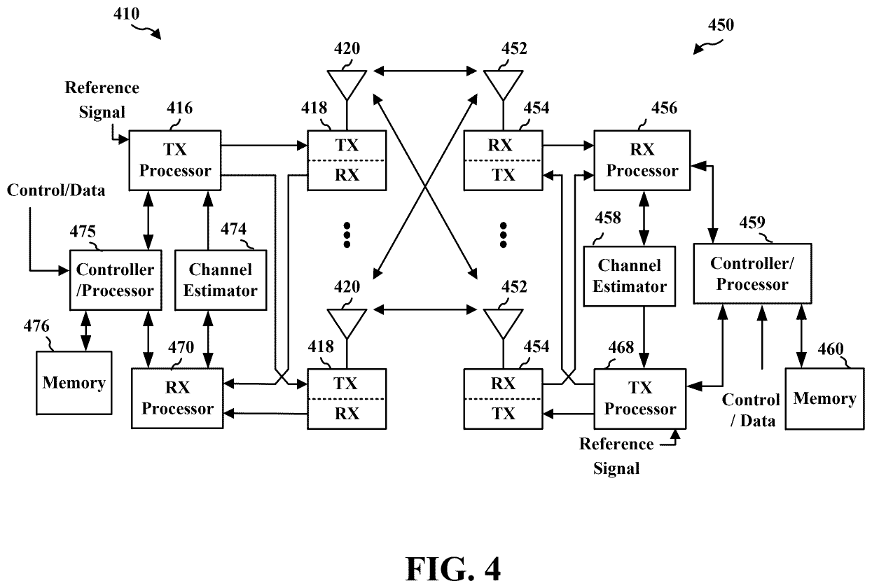

FIG. 4 is a block diagram of a first wireless communication device 410 in communication with a second wireless communication device 450, e.g., via V2V/V2X/D2D communication or in an access network. The device 410 may comprise a transmitting device communicating with a receiving device, e.g., device 450, via V2V/V2X/D2D communication. The communication may be based, e.g., on sidelink. The transmitting device 410 may comprise a UE, a base station, an RSU, etc. The receiving device may comprise a UE, a base station, an RSU, etc.

IP packets from the EPC 160 may be provided to a controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the device 450. Each spatial stream may then be provided to a different antenna 420 via a separate transmitter 418TX. Each transmitter 418TX may modulate an RF carrier with a respective spatial stream for transmission.

At the device 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the device 450. If multiple spatial streams are destined for the device 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the device 410. These soft decisions may be based on channel estimates computed by the channel estimator 458. The soft decisions are then decoded and deinterleaved to recover the data and control signals that were originally transmitted by the device 410 on the physical channel. The data and control signals are then provided to the controller/processor 459, which implements layer 3 and layer 2 functionality.

The controller/processor 459 can be associated with a memory 460 that stores program codes and data. The memory 460 may be referred to as a computer-readable medium. The controller/processor 459 may provide demultiplexing between transport and logical channels, packet reassembly, deciphering, header decompression, and/or control signal processing to recover IP packets from the EPC 160. The controller/processor 459 may be also responsible for error detection using an ACK and/or NACK protocol to support HARQ operations.

Similar to the functionality described in connection with the DL transmission by the device 410, the controller/processor 459 may provide RRC layer functionality associated with system information (e.g., MIB, SIBs) acquisition, RRC connections, and measurement reporting; PDCP layer functionality associated with header compression/decompression, and/or security (ciphering, deciphering, integrity protection, integrity verification); RLC layer functionality associated with the transfer of upper layer PDUs, error correction through ARQ, concatenation, segmentation, and/or reassembly of RLC SDUs, re-segmentation of RLC data PDUs, and/or reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and/or logical channel prioritization.

Channel estimates derived by a channel estimator 458 from a reference signal or feedback transmitted by device 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The transmission may be processed at the device 410 in a manner similar to that described in connection with the receiver function at the device 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. The controller/processor 475 provides demultiplexing between transport and logical channels, packet reassembly, deciphering, header decompression, control signal processing to recover IP packets from the device 450. IP packets from the controller/processor 475 may be provided to the EPC 160. The controller/processor 475 may be also responsible for error detection using an ACK and/or NACK protocol to support HARQ operations.

At least one of the TX processor 416, 468, the RX processor 456, 470, and the controller/processor 459, 475 may be configured to perform aspects in connection with mode indication source component 198 of FIG. 1.

At least one of the TX processor 468, the RX processor 456, and the controller/processor 459 may be configured to perform aspects in connection with mode indication destination component 199 of FIG. 1.

EH technology has acquired a large amount of interest in the context of passive IoT. An EH device may opportunistically harvest energy from the environment, such as solar, heat or other ambient radiation, and the device may apply the energy for later use (e.g., backscatter communication). Protocol enhancements have been considered to support EH device operation on intermittently available energy harvested from the environment. For example, enhancements have considered variations in the expected amount of harvested energy and traffic experienced by an EH device, or considered EH devices which may not sustain continuous reception or transmission for a long amount of time.

EH devices have become prevalent for multiple reasons. One reason is that EH devices may result in power savings. For example, RFID tags that are applied to various goods in a warehouse for position tracking purposes generally do not include batteries and instead harvest energy from the environment. As a result of the energy harvesting capability of these RFID tags, the associated energy costs of the warehouse may be reduced. Moreover, maintenance of EH devices such as RFID tags may be greatly reduced, if no batteries have to be charged or replaced. Another reason relates to spectrum efficiency. For example, in 5G and similar technologies where spectrum efficiency is important, UEs tend to overlap in spectrum usage and therefore experience interference. However, as EH devices typically are implemented in a localized environment such as a warehouse, this interference may be less of an issue. For instance, the localization of EH devices in one warehouse may prevent these devices from overlapping in spectrum usage with other EH devices in another warehouse, and thus the EH devices of one warehouse may utilize the same frequencies as those of another warehouse without interference. Even in the mmW environment where high frequency bands are very close to one another, EH devices may occupy the same frequency spectrum in different environments without one application overlapping with another, and therefore spectrum efficiency may be achieved in mmW bands using EH devices.

Additionally, EH devices may result in lower network costs. For example, when EH devices communicating with a base station, UE, or other RF source are deployed in a localized situational environment, the RF source may also be small and localized, saving network costs. For instance, a base station acting as RF source to EH devices in a warehouse may not include a direct connection to the core network, and instead may be connected to an external base station which communicates with the core network. Thus, the base station in the warehouse may be cost effectively configured to only provide RF signals to EH devices in the warehouse. The EH devices may obtain the signals from the base station, and utilizing energy harvested from that signal, redirect that signal modulated with their own data to an RFID reader (e.g., a reduced capability UE or other UE). The RFID reader may receive the modulated signals and detect the presence of the EH devices accordingly.

Although some EH devices can store harvested energy in a rechargeable battery, many EH devices typically do not include batteries in which ambient RF energy may be stored or otherwise have limited power capability. These power-limited devices nevertheless support backscatter communication in passive IoT. Additionally, other devices which do not harvest energy from the environment, but which obtain power from an external battery or other power source, may support backscatter communication in semi-passive IoT. Such devices which perform backscatter communication, whether using energy from the environment (e.g., in an ambient RF signal), using energy supplied by an external or internal power source, or using energy from a combination of the foregoing, are referred to throughout this disclosure as backscatter devices. For example, backscatter devices such as passive RFID tags, RedCap UEs (e.g., UEs with reduced power capability), and other passive IoT devices (e.g., EH devices) or semi-passive IoT devices (e.g., RFID tags connected to an external battery) may collect energy from one or more of a variety of energy sources. For instance, energy may be obtained from a power source, from an ambient RF signal from an RF source or other source device, from a solar cell which harvests solar energy from the environment, from a rechargeable battery which may be charged from energy harvested from an RF signal or other energy source, from a combination of the foregoing, and the like. The backscatter devices may subsequently redirect or backscatter an RF signal (e.g., the ambient RF signal or another RF signal) to a RF reader or other destination device (which in some cases may be the same device as the RF source). For example, a passive RFID tag may store its own data (e.g., position tracking data, etc.) and, using the collected energy from a received ambient RF signal, the RFID tag may modulate or otherwise modify the ambient RF signal with its data to form a backscattered signal to a reader for various purposes (e.g., position tracking, inventorying, etc.). Backscatter devices may include power-consuming RF components such as analog to digital converters, mixers, and oscillators which the devices may apply in order to modulate or otherwise modify an RF signal with stored data for backscatter communication.

One example of a prevalent method a backscatter device may apply for information modulation is amplitude shift keying (ASK). In ASK, the backscatter device may activate (e.g., switch on) reflection or redirection of a RF signal through transmission of an information bit ‘1’ at a given instant in time. The backscatter device may similarly deactivate (e.g., switch off) reflection or redirection of the RF signal through transmission of an information bit ‘0’ at another given instant in time. The reverse may alternatively occur (e.g., information bit ‘1’ may switch redirection off and information bit ‘0’ may switch redirection on).

Another example of a prevalent method a backscatter device may apply for forming a backscattered signal is to at least partially decode to the incoming RF signal and to provide a backscattered RF signal by coding with data, in particular with data stored in the backscatter device. Thereby, the backscattered RF signal may contain the information of the incoming RF signal as well as information provided by the backscatter device.

While the following examples refer specifically to an application of ASK for backscattering, it should be understood that the aforementioned methods or other modulation schemes may alternatively be applied.

In an example of ASK implementation, a source device (referred to herein as Device 1) transmits a certain radio wave including data x(n), and the backscatter device stores data or information bits s(n). Here, s(n)∈{0,1}, and n is a unit of time such as a symbol. The received signal at the reader or other destination device (referred to herein as Device 2), may include data represented by y(n)=(h_{D1D2}(n)+σ_{f}h_{D1T}(n)h_{TD2}(n)s(n))x(n)+noise, where h_{D1D2}(n) represents the channel between Device 1 and Device 2 at time n, σ_{f} denotes the reflection coefficient applied to the backscattered signal, h_{D1T}(n) represents the channel between Device 1 and the backscatter device at time n, h_{TD2}(n) represents the channel between the backscatter device and Device 2 at time n, s(n) denotes the data modulated by the backscatter device at time n, x(n) denotes the data carried on a radio wave from Device 1 at time n, and noise denotes the noise affecting the received signal at Device 2.

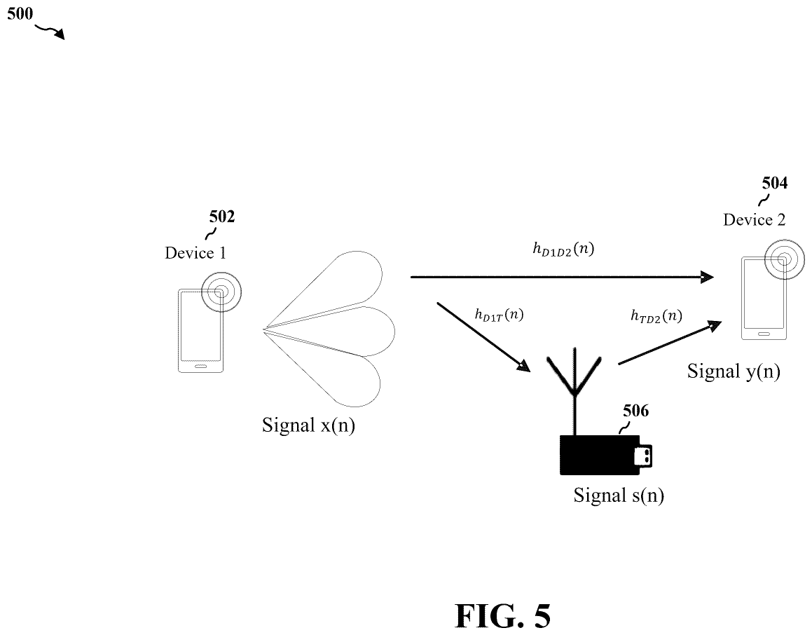

FIG. 5 illustrates an example 500 where a source device 502 (e.g., an RF source) sends data x(n) directly to a destination device 504 (e.g., an RF reader), as well as to a backscatter device 506 (e.g., an RFID tag). Data received by the destination device may be modified by channel h_{D1D2}(n), while data received by the backscatter device may be modified by channel h_{D1T}(n). The backscatter device may redirect or backscatter the data x(n) modulated by data s(n) to the destination device, which data may be further modified by channel h_{TD2}(n) and the reflection coefficient of. Thus, the combined signal y(n) received by Device 2 includes both modified signals x(n) and s(n). While in this example, s(n) represents a pattern of bits representing data from the backscatter device, in other examples, s(n) may represent a reference signal from the backscatter device.

Accordingly in this example, when s(n)=0 (reflection is switched off at the backscatter device), Device 2 only receives a direct link signal from Device 1, i.e., y(n)=h_{D1D2}(n)x(n)+noise. Alternatively, when s(n)=1 (reflection is switched on at the backscatter device), Device 2 may receive the superposition of both the direct link signal and the backscatter link signal, i.e., y(n)=(h_{D1D2}(n)+σ_{f}h_{D1T}(n)h_{TD2}(n)s(n))x(n)+noise. In order to receive the transmitted information bits by the backscatter device, Device 2 may apply conventional interference cancellation techniques. For example, Device 2 may first decode x(n) based on the known h_{D1D2}(n) (e.g., by treating the backscatter link signal as interference and thus only considering the direct link signal). Then Device 2 may detect the existence of the remaining term σ_{f}h_{D1T}(n)h_{TD2}(n)s(n)x(n), for example, by subtracting h_{D1D2}(n)x(n) (which was previously identified) from the received signal y(n). Device 2 may then decode s(n) based on the decoded x(n) and the known σ_{f}h_{D1T}(n)h_{TD2}(n).

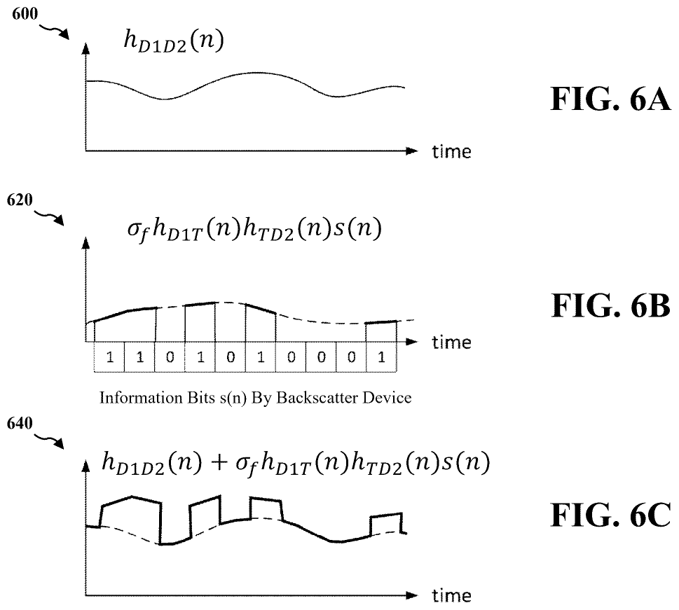

FIGS. 6A-6C illustrate examples 600, 620, 640 where the backscatter device applies ASK to modulate stored data s(n) onto the signal x(n) from Device 1, although other modulation schemes may be applied in other examples. As illustrated in example 600 of FIG. 6A, the backscatter device initially receives signal x(n) modified by channel h_{D1D2}(n) from Device 1 over time n. Moreover, as illustrated in example 620 of FIG. 6B, the backscatter device applies ASK to modulate signal x(n) with data bits s(n) at each instance of time n, for example, by switching on modulation for each information bit ‘1’ and switching off modulation for each information bit ‘0’. This modulated signal may further be modified by σ_{f}h_{D1T}(n)h_{TD2}(n) during transmission. Finally, as illustrated in example 640 of FIG. 6C, Device 2 receives the combined/multiplexed signal y(n) (the signal x(n) as modified by h_{D1D2}(n) from Device 1 and σ_{f}h_{D1T}(n)h_{TD2}(n)s(n) from Device 2). Device 2 may subsequently decode x(n) by applying an interference cancellation technique such as previously described.

Thus, an RF signal from Device 1 may be used to power, trigger or otherwise activate a backscatter device to provide its own data to Device 2. For instance, using the energy from the RF signal from Device 1 and in response to applying ASK, the backscatter device may modulate the RF signal from Device 1 with its own data s(n) to send to Device 2. Alternatively, other energy sources (e.g., alone or in combination with an RF signal) may be used to activate the backscatter device to modulate the RF signal. Device 2 may then receive data x(n) from Device 1 as well as data s(n) from the backscatter device in the modulated signal. Device 2 may then decode the data s(n) from the backscatter device, for example, using interference cancellation techniques. In this example, data s(n) may include position data of the backscatter device, measurements taken by the ambient backscatter, sensed data, or other application-specific data (together referred to in this disclosure as user data), which Device 2 may read from the backscattered signal. Similarly, data x(n) from Device 1 may include other user data, which Device 2 may also read from the modulated signal.

However, in other examples, x(n) and s(n) may not represent data (i.e., user data), and thus the backscattered, modulated signal from a backscatter device may not necessarily carry user data. For instance, x(n) and s(n) may either or both represent reference signals rather than user data, and thus Device 1 or the backscatter device may either or both transmit reference signals for beam management or channel sounding rather than signals carrying user data. Accordingly, aspects of the present disclosure allow Device 1 to indicate whether Device 2 is to receive data or reference signals from either or both Device 1 and the backscatter device, so that Device 2 may ascertain whether user data from Device 1, user data from the backscatter device, or no user data is to be expected. Based on this information, Device 2 may adjust its decoding (e.g., its interference cancellation technique) accordingly.

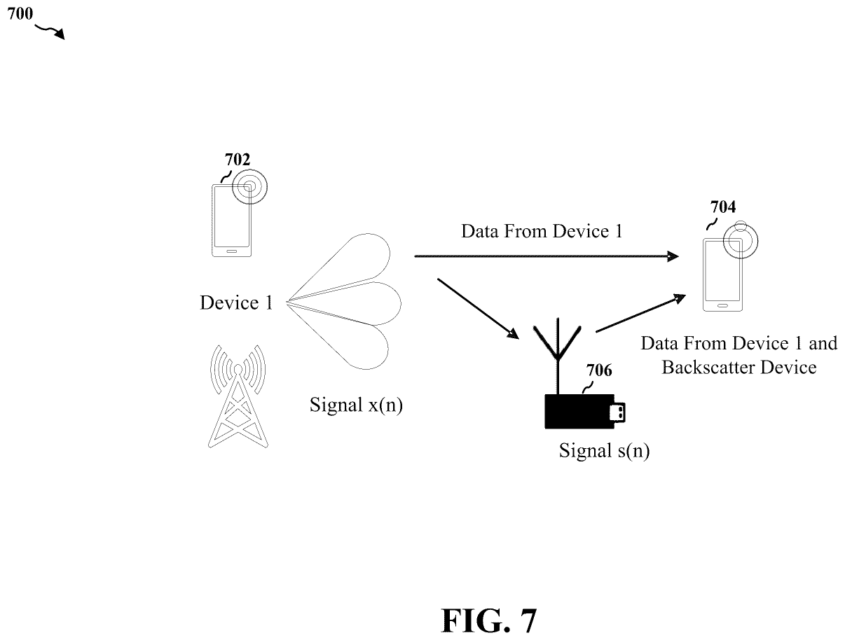

One aspect relates to switching modes between data transmission and reference signal transmission by the RF source. For instance, FIG. 7 illustrates an example 700 of a source device 702 (Device 1) which may transmit information (e.g., data or reference signals) to a destination device 704 (Device 2) according to one of multiple configured modes. Device 1 may be a base station or a UE, for example, while Device 2 may be another UE (or in some cases the same UE), for example. The transmission may be in a direct link between Device 1 and Device 2, and in an indirect link between Device 1 and Device 2 via a backscatter device 706. In one mode, as illustrated in the example of FIG. 7, Device 1 may send data (user data) to Device 2 (e.g., in PSSCH), which data x(n) is modulated by data s(n) from the backscatter device, and Device 2 may receive both the data from Device 1 and from the backscatter device in a combined signal (e.g., in PSSCH). In another mode, Device 1 may send a reference signal (rather than data), which signal is also modulated by data s(n) from the backscatter device, but which signal Device 2 may later cancel in its process of identifying the data s(n). In either mode, Device 1 may be a UE which communicates with Device 2 and the backscatter device in sidelink communication, or a base station which communicates with Device 2 and the backscatter device in downlink communication (or otherwise over a Uu interface). Device 2 may also be a UE.

In cases where the backscatter device transmits its own data for s(n), three modes may be configured for the RF signal from the source device (Device 1). In one mode, Device 1 may transmit its own data x(n) (i.e., user data) in the RF signal, and the backscatter device may modulate or multiplex its own data s(n) (i.e., user data) on the signal from Device 1 and transmit the modulated/multiplexed signal to Device 2. Thus, Device 2 may receive a combined, backscattered signal including both the data from Device 1 and the data from the backscatter device. In another mode, Device 1 may transmit a reference signal (e.g., a CW) including sequence x(n) rather than user data, while the backscatter device may similarly modulate its own data s(n) on the signal from Device 1 and transmit the modulated signal to Device 2. Thus, Device 2 may receive a combined, backscattered signal including both the reference signal/CW from Device 1 and the data from the backscatter device. In a further mode, Device 1 may transmit its own data x(n) (i.e., user data) in the RF signal, but the backscatter device may be powered off, disabled or otherwise deactivated from modulating its own data s(n) on the signal from Device 1 and from transmitting the modulated signal to Device 2. Thus, Device 2 may only receive the data signal directly from Device 1 (without receiving a backscattered signal).

Device 1 may select one of these modes and communicate the selected mode to Device 2. For example, Device 1 may indicate the mode to Device 2 using layer 1 signaling (L1, such as in DCI or SCI), layer 2 signaling (L2, such as in a medium access control (MAC) control element (MAC-CE)), or Layer 3 signaling (L3, such as in an RRC configuration), either in sidelink communication or downlink communication. The mode may indicate whether a current (or subsequent) transmission to Device 2 includes data only from Device 1, multiplexed data from both Device 1 and the backscatter device, or data only from the backscatter device. In response to receiving the communicated mode, Device 2 may determine whether to decode the modulated data signal for s(n) only (e.g., if Device 1 transmits a reference signal rather than user data), or whether to decode the data signal from Device 1 as well as the modulated data signal for both x(n) and s(n) (e.g., if Device 1 and the backscatter device both transmit user data). For example, if the mode indicates that both Device 1 and the backscatter device transmit user data in a modulated data signal including x(n) and s(n), Device 2 may first decode x(n) based on the known h_{D1D2}(n) (e.g., by treating the backscatter link signal as interference and thus only considering the direct link signal from Device 1). Then Device 2 may detect the existence of the remaining term corresponding to the backscatter link signal σ_{f}h_{D1T}(n)h_{TD2}(n)s(n)x(n), for example, by subtracting h_{D1D2}(n)x(n) (which was previously identified) from the received signal y(n). Device 2 may then decode s(n) based on the decoded x(n) and the known σ_{f}h_{D1T}(n)h_{TD2}(n). Alternatively, if the mode indicates that only the backscatter device transmits user data, Device 2 may modify its application of the aforementioned interference cancellation technique to only decode s(n) (and thus disregard x(n)).

While the above-described examples pertain to cases where the backscatter device transmits user data, in other cases, the backscatter device may transmit a reference signal for beam management, rather than its own data. Thus, two modes may be configured for the signal s(n) from the backscatter device, namely, one mode in which the backscatter device transmits a reference signal while Device 1 may transmit its own data, and another mode in which both the backscatter device and Device 1 transmit reference signals. Combining these two modes for the backscatter device with the aforementioned three modes for Device 1, five joint operation modes may be configured for transmissions from Device 1 and the backscatter device. In particular, in a first mode, Device 1 and the backscatter device both transmit data, in a second mode, Device 1 transmits a reference signal while the backscatter device transmits data, in a third mode, Device 1 transmits data and the backscatter device transmits a reference signal, in a fourth mode, Device 1 and the backscatter device both transmit reference signals, and in a fifth mode, Device 1 transmits data and the backscatter device is powered off or otherwise disabled/deactivated from transmitting data or reference signals.

Thus, Device 1 may indicate to Device 2 one of five joint operation modes to be applied to transmissions that Device 2 may receive from the backscatter device or from Device 1. In one example, the selected mode may apply for a single transmission from the backscatter device, and Device 1 may indicate the same or a different selected mode for each subsequent transmission. That is, each mode may be indicated on a transmission-by-transmission basis. For instance, Device 1 may indicate that a transmission from the backscatter device will include multiplexed data from both Device 1 and the backscatter device in one mode, Device 1 may subsequently indicate that a next transmission from the backscatter device will include a reference signal from Device 1 and data from the backscatter device in a different mode, and so forth. Alternatively, Device 1 may indicate a time period or window during which a selected mode may continue to apply, such as a number of transmissions, slots, or other indicated units of time. For instance, Device 1 may indicate that the next X transmissions or slots to be received by Device 2 will include multiplexed data from both Device 1 and the backscatter device in one mode, where X is a number indicated by Device 1 in a same (or a different) message indicating the mode. Thus, Device 1 may indicate a selected mode will be applied for multiple upcoming transmissions, rather than individually on a transmission by transmission basis.

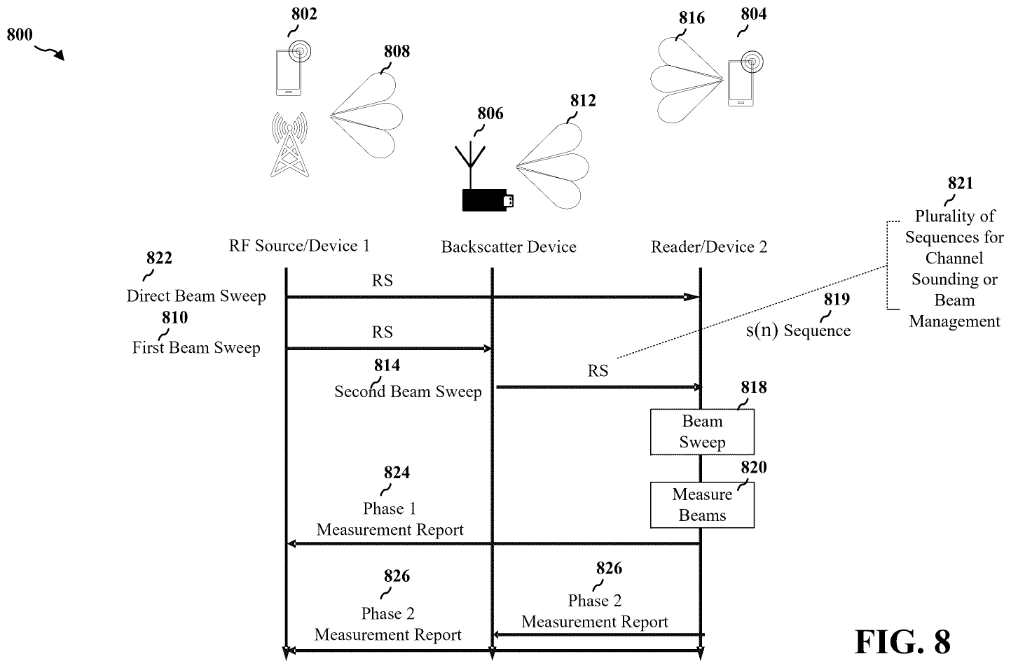

Other aspects of the present disclosure provide considerations which Device 1, the backscatter device, and Device 2 may apply for beam management. In one example, Device 1 or Device 2 may perform beam management using backscattered signals from the backscatter device. In another example, Device 1 may configure the backscatter device (or the backscatter device may be pre-configured) to transmit a reference signal (including sequence s(n)) for channel sounding or beam management purposes. In such case, the backscatter device may not transmit its own data to Device 2. In a further example, Device 1 may configure the backscatter device (or the backscatter device may be pre-configured) for distributed beamforming of data from signals from Device 1. For example, the backscatter device may operate as a beamforming element for Device 1 by setting its sequence s(n) to all 1's (or some other sequence understood by the devices) in order to provide beamformed signals via a different path between Device 1 and Device 2 for diversity purposes. In an additional example, Device 2 may provide CSI reports to Device 1 and the backscatter device for beamforming purposes. Examples related to these various aspects of the present disclosure will be subsequently described with respect to FIG. 8 and later figures.

In one example, the backscatter device may operate as a beamforming device for Device 1. For instance, the backscatter device may reflect or redirect a data signal received from Device 1 in a beam directed to Device 2. The backscatter device may perform such beamforming, for instance, by setting its sequence s(n) to all 1's. For example, the RF components, hardware, software/firmware, or other circuitry or processors of the backscatter device may modulate the x(n) data signal with s(n)=‘1’ for all n times, effectively canceling out s(n) from the received signal y(n) such that y(n)=(h_{D1D2}(n)+σ_{f}h_{D1T}(n)h_{TD2}(n))x(n)+noise. This approach thereby provides another path of communication between Device 1 and Device 2 via the backscatter device for Device 1 to provide its data signal x(n). However, as modulation may result in the backscatter device redirecting the data signal to Device 2 with lower power than that received from Device 1, the ambient backscatter may alternatively apply a short-circuit mode in another example to increase power. For example, if the backscatter device is in the short circuit mode, the backscatter device may be configured such that the data signal received from Device 1 bypasses the aforementioned circuitry or processors of the backscatter device (effectively short-circuiting the modulation by passing the signal directly from an input to an output of the backscatter device), thereby resulting in higher reflective power. This short circuit mode may be in contrast to an open circuit mode that may similarly exist for the backscatter device, which has an effect similar to setting s(n) to all 0's by preventing reflection or redirection of the data signal from Device 1.

Device 1 may indicate whether the backscatter device is to act as a beamforming device for Device 1 (e.g., by reflecting or redirecting source data from Device 1), or whether the backscatter device is to transmit its own data, transmit a reference signal, or power down/de-activate (all as previously described), through one of multiple operation modes. Thus, four operation modes may be configured for transmissions of the backscatter device to Device 2. These four operation modes may be in addition to, or overlap with, one or more of the five joint operation modes previously described, but where the different sets of modes are indicated to different entities; that is, Device 1 indicates one of the four operation modes to the backscatter device and one of the five joint operation modes to Device 2. In particular, in a first mode, the backscatter device acts as a beamforming device by transmitting only the data x(n) received in the signal from Device 1 (e.g., by setting s(n) to all 1's or operating in a short-circuit mode), rather than data or reference signals of the backscatter device. In a second mode, the backscatter device transmits its own data s(n) modulated with the data signal carrying data x(n) such as previously described in one of the joint operation modes. In a third mode, the backscatter device transmits a reference signal s(n) modulated with the data signal carrying data x(n) such as previously described in another one of the joint operation modes. In a fourth mode, the backscatter device may not transmit its own data nor a reference signal (e.g., by operating in an open-circuit mode), such as previously described in another one of the joint operation modes. Device 1 may select one of these modes and communicate the selected mode to the backscatter device. For example, similar to the indication of joint operation modes to Device 2, Device 1 may indicate one of the aforementioned four modes to the backscatter device using layer 1 signaling (L1, such as in DCI or SCI), layer 2 signaling (L2, such as in a MAC-CE), or Layer 3 signaling (L3, such as in an RRC configuration), either in sidelink communication or downlink communication.

Additionally, for operation in the first mode as a beamforming device for Device 1, the backscatter device may determine whether the backscatter device is to set s(n) to all 1's or is to operate in a short-circuit mode in response to a pre-configuration at the backscatter device, or in response to a L1/L2/L3 indication from Device 1. Moreover in this mode, s(n) may be pre-configured or indicated with a sequence (e.g., all 1's) understood between Device 1, the backscatter device and Device 2. Similarly, for operation in the third mode, s(n) may be a reference signal which is pre-configured or indicated by Device 1. However, for operation in the second mode, s(n) may not be pre-configured or indicated since that sequence changes according to the data of the backscatter device.

FIG. 8 illustrates an example 800 of a beam management procedure involving a source device 802 (Device 1), a destination device 804 (Device 2), and a backscatter device 806. Initially, Device 1 may transmit a reference signal (e.g., CSI-RS) including sequence x(n) in first transmission beams 808 to the backscatter device. For example, Device 1 may perform a first beam sweep 810 in which Device 1 transmits (e.g., repeats) the reference signal in each of the first transmission beams. The backscatter device, in turn, may reflect or redirect each of the reference signals from Device 1 to Device 2 in second transmission beams 812 (or a subset of the second transmission beams after deactivating one or more of these beams). For instance, the backscatter device may perform a second beam sweep 814 in which the backscatter device transmits another reference signal (e.g., CSI-RS) including sequence s(n) (modulated with the signal from Device 1) in each of the second transmission beams. The backscatter device here may include multiple antennas which allow for the second beam sweep to be performed. Device 2 may receive the combined reference signals (the modulated, backscattered signal including x(n) and s(n)) in reception beams 816. For instance, Device 2 may perform a reception beam sweep 818 in which Device 2 receives a combined reference signal in each of the reception beams. After receiving the combined reference signals from the backscatter device, Device 2 may perform a measurement 820 of the second transmission beams carrying each combined reference signal. For example, Device 2 may measure a reference signal received power (RSRP), a reference signal received quality (RSRQ), or a signal to interference plus noise ratio (SINR) of the combined reference signal in each of the second transmission beams. Based on these measurements, Device 2 may determine one or more best beam combinations of the first transmission beams and the second transmission beams over which Device 2 received the combined reference signals. For instance, Device 2 may determine one or more strongest pairs of beams (where each pair includes one of the first transmission beams and one of the second transmission beams) over which the backscatter device received the source reference signal from Device 1 and over which Device 2 received the combined reference signals from the backscatter device, respectively. In alternative of in addition, device may determine the beams associated with the highest RSRP, SINR and/or RSRQ. Device 2 may then transmit measurement reports (e.g., CSI reports) to Device 1 and to the backscatter device indicating the best determined beams.

In the illustrated example, the first transmission beams 808 carry reference signals including sequences x(n) from Device 1, and the second transmission beams 812 carry reference signals including s(n) (as well as x(n)) from the backscatter device. The transmission of these reference signals may be in response to an active one of the previously described, joint operation modes for Device 1 and the backscatter device (e.g., the fourth mode). Moreover, the reference signal from the backscatter device may be configured according to one of the previously described operation modes for the backscatter device (e.g., the first mode or the third mode). For example, the reference signals from the backscatter device (including s(n)) may be configured such that s(n) is set to all 1's, or some other sequence understood between Device 1, the backscatter device, and Device 2, based on the indicated mode from Device 1. In some examples, each of the reference signals transmitted by the backscatter device in the second transmission beams may include multiple bits in the sequence s(n) for a slot length or other period of time. In some examples, each of these reference signals may include a different sequence for s(n), or alternatively the same sequence but with a different precoding for each transmission beam. In any of these examples, an applied sequence 819 of s(n) may be pre-configured in the backscatter device, or indicated by Device 1 to the backscatter device, from one of multiple pre-configured or configured sequences 821 for s(n) which are known to Device 2 and available for the backscatter device to apply during the second beam sweep 814 for channel sounding or beam management. Alternatively, in other examples, the backscatter device may be configured in a short circuit mode such that the reference signal transmitted over each of the second transmission beams carries x(n) but not s(n).

In addition to communicating over the first transmission beams 808 indirectly with Device 2 via the backscatter device as described above, Device 1 may communicate over the first transmission beams directly with Device 2. For example, Device 1 may perform a direct beam sweep 822 in which Device 1 transmits a reference signal including x(n) directly to Device 2 over each of the first transmission beams (bypassing the backscatter device). Device 1 may perform the direct beam sweep prior to performing the first beam sweep 810, at which time Device 1 transmits its reference signal including x(n) directly to the backscatter device (for redirection to Device 2) over each of the first transmission beams as previously described. In some cases, Device 1 may transmit its reference signals directly to Device 2 and directly to the backscatter device at the same time (although with split transmission power). In response to receiving the reference signal including x(n) directly from Device 1, Device 2 may perform measurements 820 of the received reference signal from Device 1. Device 2 may perform these measurements in addition to performing measurements 820 of the received combined reference signal including x(n) and s(n) from the backscatter device. Thus, Device 2 may determine the best direct beams from the first transmission beams following the direct beam sweep (e.g., the strongest link(s) between Device 1 and Device 2 and/or the direct beams associated with the highest RSRP, SINR and/or RSRQ), as well as the best beam combinations including the pairs of first transmission beams and second transmission beams following the first beam sweep and the second beam sweep (e.g., the strongest link(s) between Device 1, the backscatter device, and Device 2).

The process by which Device 1 transmits reference signals to Device 2, such that Device 2 may determine best beams, may occur in two phases. In phase 1 of this process, Device 1 performs the direct beam sweep 822, in which Device 1 transmits reference signals including x(n) directly to Device 2 in each of the first transmission beams 808. To this end, Device 1 may configure the backscatter device to power down or deactivate (e.g., by applying a sequence for s(n) of all 0's or an open circuit mode) to prevent reflection or redirection of the signal through the backscatter device. This deactivation may occur, for example, in response to one of the indicated joint operation modes for Device 1 and the backscatter device (e.g., a variation of the fifth mode where Device 1 transmits a reference signal rather than data). Device 2 may subsequently determine the best direct beam(s) from the first transmission beams 808 based on the measurements 820 that Device 2 performs on the reference signals including x(n) during the direct beam sweep. For instance, Device 2 may measure the RSRP, RSRQ, or SINR of the reference signal received from Device 1 over each of the first transmission beams, and determine the best direct beam as corresponding to the reference signal with the highest RSRP, RSRQ, or/and SINR. Device 2 may similarly determine multiple, best direct beams from the measurements (e.g., the beams corresponding to the first, second, and third highest RSRP, RSRQ, or/and SINR).

Afterwards, in phase 2 of this process, Device 1 performs the first beam sweep 810 in which Device 1 transmits reference signals including x(n) directly to the backscatter device in each of the first transmission beams 808, and the backscatter device performs the second beam sweep 814 in which the backscatter device transmits combined reference signals including x(n) and s(n) directly to Device 2 in each of the second transmission beams 812. Phase 2 may occur following phase 1 in response to another mode switch indicated by Device 1. In one example, the backscatter device may perform the second beam sweep multiple times during the first beam sweep (e.g., a nested beam sweep). For instance, in a first iteration, after Device 1 provides its reference signal including x(n) to the backscatter device over one of the first transmission beams, the backscatter device may modulate that same reference signal with its own reference signal s(n) in each of the second transmission beams during the second beam sweep. Afterwards, in a second iteration, Device 1 may repeat the reference signal over a next one of the first transmission beams, and the backscatter device may repeat the same process. This process may continue until the first beam sweep has completed. Alternatively, in a different example, Device 1 may perform the first beam sweep multiple times during the second beam sweep, in which case the process described above for the nested beam sweep may be reversed. In either example, Device 2 may subsequently determine the best beam combinations from the first transmission beams and the second transmission beams based on the measurements 820 which Device 2 performs on the combined reference signals. For instance, during each iteration of the first beam sweep, Device 2 may measure the RSRP, RSRQ, or/and SINR of the backscattered signal received from the backscatter device over each of the second transmission beams (or vice-versa). Device 2 may then determine the best beam combination as including the first transmission beam and the second transmission beam corresponding to the backscattered, combined reference signal with the highest RSRP, RSRQ, or/and SINR. Device 2 may similarly determine multiple, best beam combinations from the measurements (e.g., the beams corresponding to the first, second, and third highest RSRP, RSRQ, or/and SINR).

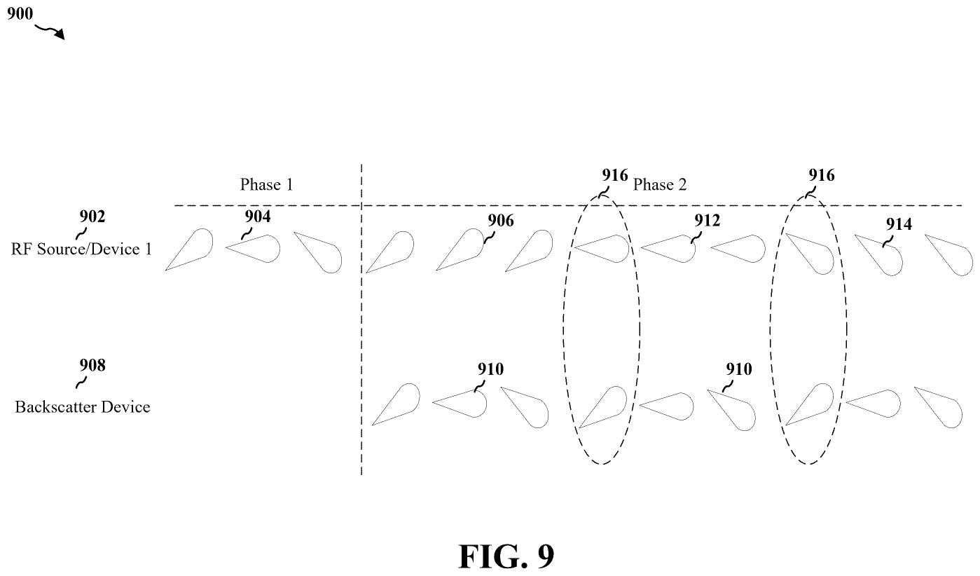

FIG. 9 illustrates an example 900 of the aforementioned two-phase process by which a source device 902 (Device 1) transmits reference signals to a destination device (Device 2) such that Device 2 may determine best beams for receiving information from Device 1. In Phase 1, Device 1 performs a direct beam sweep (e.g., the direct beam sweep 822 of FIG. 8), during which Device 1 transmits its reference signals in different beams 904 directly to Device 2. Device 2 may subsequently determine the best direct beam(s) from the different beams 904 based on performed measurements, for example, the beam(s) corresponding to the highest RSRP, RSRQ, or/and SINR. In Phase 2, Device 1 performs a beam sweep (e.g., the first beam sweep 810 of FIG. 8), during which Device 1 repeatedly transmits its reference signals in a first beam 906 of its different beams 904 directly to a backscatter device 908. During a first iteration of the first beam sweep, the backscatter device 908 performs its own beam sweep (e.g., the second beam sweep 814 of FIG. 8), during which the backscatter device transmits its modulated reference signal in different beams 910 directly to Device 2. Following completion of the second beam sweep by the backscatter device, Device 1 proceeds to the second iteration of its first beam sweep, during which Device 1 repeatedly transmits its reference signals in a second beam 912 of its different beams 904 directly to the backscatter device 908. During this second iteration, the backscatter device repeats its second beam sweep and again transmits its modulated reference signal in the different beams 910 directly to Device 2. This process continues in the next iteration of the first beam sweep for a third beam 914 and any subsequent beam thereafter of Device 1 until the first beam sweep completes. Afterwards, Device 2 may subsequently determine the best beam combinations out of the different pairs 916 of beams over which the RSRP, RSRQ, or/and SINR of the backscattered signal was measured. In response to determining the best direct beams during Phase 1 and the best beam combinations during Phase 2, Device 2 may determine whether to receive subsequent information (e.g., data or reference signals) directly from Device 1 or indirectly from Device 1 via the backscatter device.

Accordingly, in an example of the two-phase process illustrated and described with respect to FIGS. 8 and 9, Device 1 may first provide a configuration of measurement resources (e.g., CSI measurement resources) to Device 2. During Phase 1 of this process, Device 1 may deactivate the backscatter device and transmit its reference signal directly to Device 2 in the configured measurement resources over first transmission beams 808 (e.g., beams 904) during the direct beam sweep 822. Device 1 may deactivate the backscatter device, for example, by configuring the backscatter device to set s(n) to all 0's or to operate in an open circuit mode via a L1/L2/L3 indication. Device 2 may then measure the RSRP, RSRQ or/and SINR of the received reference signal over each beam in the configured resources when performing measurements 820. In response to the measurements, Device 2 may determine the best direct beams (e.g., highest RSRP, RSRQ or/and SINR) associated with the link between Device 1 and Device 2. Subsequently, during Phase 2 of this process, Device 1 may transmit its reference signal directly to the backscatter device in the configured measurement resources over first transmission beams 808 (e.g., beams 906, 912, 914) during the first beam sweep 810. Device 1 may also activate the backscatter device to backscatter the received reference signals to Device 2 in the configured measurement resources over second transmission beams 812 (e.g., beams 910) during the second beam sweep 814. Device 2 may then measure the RSRP, RSRQ or/and SINR of the received reference signal over each beam combination (e.g., pairs 916 of beams) in the configured resources when performing measurements 820. In response to the measurements, Device 2 may determine the best beam combinations (e.g., highest RSRP, RSRQ or/and SINR) associated with the link between Device 1, the backscatter device, and Device 2. Based on a comparison of the measurements identified for the best direct beams and the best beam combinations, Device 2 may determine whether to communicate with Device 1 (and vice-versa) directly, or alternatively indirectly via beams formed by the backscatter device, in subsequent transmissions. For instance, if Device 2 measures a higher RSRP, RSRQ or/and SINR for one of the direct beams in Phase 1 than those measured for any of the beam combinations in Phase 2, Device 1 may subsequently bypass the backscatter device when communicating with Device 2. Alternatively, if Device 2 measures a higher RSRP, RSRQ or/and SINR for one of the beam combinations in Phase 2 than those measured for any of the direct beams in Phase 1, Device 1 may subsequently send information to the backscatter device for communication to Device 2.

In order to inform Device 1 of these measurements to improve subsequent communications with Device 2, Device 2 may provide measurement reports to Device 1 or to the backscatter device. For example, referring back to FIG. 8, after Device 2 performs the measurements 820 during the aforementioned two-phase process, Device 2 may provide measurement reports (e.g., CSI reports) to Device 1 and the backscatter device. The CSI report associated with each of the beam training phases may be transmitted to different entities. For instance, Device 2 may transmit a phase 1 measurement report 824 (e.g., a first CSI report) to Device 1, which includes CSI derived from the measurements 820 of the reference signals received in the first transmission beams 808 (e.g., beams 904). Moreover, Device 2 may transmit a phase 2 measurement report 826 (e.g., a second CSI report) to the backscatter device and to Device 1, which includes CSI derived from the measurements 820 of the reference signals received in the pairs 916 of first transmission beams 808 (e.g., beams 906, 912, 914) and second transmission beams 812 (e.g., beams 910). Thus, Device 2 may transmit separate CSI reports respectively indicating information associated with the direct link between Device 1 and Device 2 and information associated with the indirect link between Device 1, the backscatter device, and Device 2. The signals that Device 2 may measure, which are communicated between Device 1 and Device 2 over this indirect link (via the backscatter device), may include data stored on the backscatter device or data received from Device 1.

In one example, the phase 1 measurement report 824 that Device 2 provides to Device 1 may include a beam index, timestamp, or other indicator of each of the best direct beam(s) between Device 1 and Device 2. For instance, referring to FIG. 9, Device 2 may report an index or timestamp of the beam 904 having the highest RSRP, RSRQ or/and SINR out of the beams 904 measured during the first beam training phase. Similarly, the phase 2 measurement report 826 that Device 2 provides to both Device 1 and the backscatter device may include a beam index, timestamp, or other indicator of each of the best beam combination(s) between Device 1, the backscatter device, and Device 2. For instance, referring to FIG. 9, Device 2 may report an index and timestamp of the beam 910 in one of the beam pairs 916 having the highest RSRP, RSRQ or/and SINR out of the beams 910 in others of the beam pairs 916 measured during the second beam training phase. Device 2 may report this same information in the phase 2 measurement report to both Device 1 and the backscatter device. Based on the reported beam index and timestamp in the phase 2 measurement report, both Device 1 and the backscatter device may ascertain from this same information which of their respective transmission beams correspond to the best beam combination. For example, if Device 2 reports a beam index and timestamp associated with one of the pairs 916 as corresponding to the best beam combination, Device 1 and the backscatter device may respectively determine from the timestamp or beam index the best beam of its beams 906, 912, 914 and beam 910, respectively. In a similar manner, Device 2 may indicate multiple best beams (e.g., K best beams) in its phase 1 measurement report and phase 2 measurement reports, rather than merely a single best beam for each phase.

In some examples, Device 1 may communicate with Device 2 over a different interface than that over which the backscatter device communicates with Device 2. In such cases, Device 2 may provide separate measurement reports to Device 1 and the backscatter device respectively over the different interfaces. For example, Device 2 may unicast two copies of a same phase 2 CSI report to Device 1 and the backscatter device respectively. Device 2 may also bundle the phase 2 measurement report for Device 1 with the phase 1 measurement report to Device 1 in a same communication to save resources. Alternatively, in other examples, Device 1 and the backscatter device may communicate with Device 2 over the same interface. In such cases, Device 2 may provide a single measurement report to Device 1 and the backscatter device. For example, Device 2 may groupcast a single copy of the phase 2 CSI report to Device 1 and the backscatter device.

After Device 2 determines best direct beam(s) and best beam combination(s) during the aforementioned two-phase process, Device 2 may estimate the direct link channel between Device 1 and Device 2 and the backscattered channel between the backscatter device and Device 2 respectively corresponding to those best beams or beam combinations. The direct link channel may be estimated during Phase 1 and the backscattered channel may be estimated during Phase 2. These estimations may facilitate beam refinement at the backscatter device and Device 1. For example, after Device 2 performs channel measurements for beam refinement and reports the backscattered channel measurements to the backscatter device, the backscatter device may refine its transmission beams to Device 2 for subsequent backscattered communications to match the best beam combination(s). Similarly, after Device 2 reports the direct link channel measurements to Device 1, Device 1 may refine its transmission beams to Device 2 for subsequent direct link communications to match the best direct beam(s). However, as these channel measurements do not include information regarding the channel between Device 1 and the backscatter device, Device 1 would be limited to inefficiently performing another beam sweep to refine its transmission beams toward the backscatter device without more information. Accordingly, to facilitate beam refinement at Device 1 towards the backscatter device, Device 2 may estimate the overall channel between Device 1, the backscatter device, and Device 2, and include this overall channel estimate measurement in its phase 2 CSI reporting to Device 1. Using this additional information, Device 1 may change to a particular transmission beam (e.g., the strongest beam) or Device 1 adjust its transmission parameters (e.g., modulation and coding scheme (MCS), transmission power, etc.) for subsequent data or reference signals.

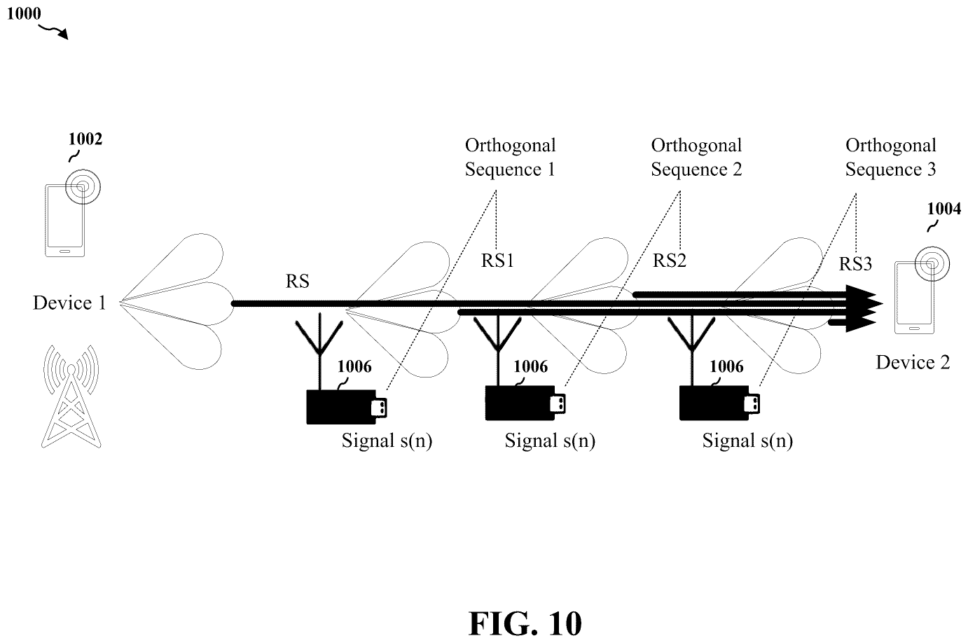

While the above examples all refer to a single backscatter device, it should be understood that Device 1 may communicate with Device 2 via multiple backscatter devices. For instance, FIG. 10 illustrates an example 1000 of a source device 1002 (Device 1) which transmits a reference signal (RS) to a destination device 1004 (Device 2) via a plurality of backscatter devices 1006. In this example, each of the backscatter devices may modulate the reference signal received from Device 1 with a respective reference signal including a respective sequence s(n). For instance, in response to a supply of power, trigger, or other activation from the reference signal (RS) from Device 1 (or from multiple RSs from Device 1), a first backscatter device may transmit a reference signal (RS1) including one sequence for s(n), a second backscatter device may transmit a reference signal (RS2) including another sequence for s(n), a third backscatter device may transmit a reference signal (RS3) including a further sequence for s(n), and so forth. Each of these backscatter devices may be assigned or associated with their respective sequence s(n) (e.g., in a pre-configuration or indication). Moreover, each of these respective sequences s(n) may be orthogonal to the other to allow Device 2 to decouple the beams of one backscatter device from those of another backscatter device. For instance, when Device 1 performs the two-phase beam training process previously described with respect to FIGS. 8 and 9, Device 1 may configure the multiple backscatter devices in the example of FIG. 10 to perform Phase 2 of this process (e.g., in multiple nested beam sweeps, one for each backscatter device). Thus, each beam combination that Device 2 may measure at a given instance in time may include numerous beams (e.g., 4 beams in the example of FIG. 10). As a result, the orthogonality of each reference signal sequence s(n) may allow Device 2 to differentiate the numerous beams of the different backscatter devices when performing CSI measurements and reporting.

Thus, in the examples previously described with respect to FIGS. 5-10, a RF source (Device 1) may communicate with a separate RF Reader (Device 2) via one or more backscatter devices such as an RFID tag or tags. In a first aspect, one or more of the backscatter device(s) may be configured to operate as a beamforming device for Device 1. For instance, Device 1 may send an indication to each of these backscatter device(s) to operate as a beamforming device. To this end, the backscatter devices may each be configured or pre-configured with s(n) of all 1's to enable reflection or redirection of Device 1's data to Device 2. Alternatively, the backscatter device(s) may each be short circuited (i.e., no transmission of s(n)) and the data from Device 1 may be carried through the backscatter device to Device 2 without modulation at the backscatter device. In a second aspect, one or more of the backscatter device(s) may be configured to perform beam management. For instance, Device 1 may send an indication to each of these backscatter device(s) to send an RS (rather than act as beamforming device). To this end, the backscatter device(s) may each be configured or pre-configured with s(n) of all 1's (similar to the first aspect), or an s(n) including a given sequence of O's and 1's, which sequence makes up the RS that the backscatter device sends to Device 2 during a beam sweep.

With respect to the second aspect, the s(n) of a backscatter device may be different than the s(n) of another backscatter device coupled between Device 1 and Device 2. For example, one device may have s(n) of all 1's, and another device may have s(n) of 010101 . . . (continuing), and so forth. The s(n) of one backscatter device may be orthogonal to the s(n) of another backscatter device. Device 2 may then decode the received RS including the s(n) from the backscatter devices using the orthogonality of each RS, for instance, by blindly applying conjugates of the RS (s(n) of each device). For example, referring to FIG. 10, Device 2 may apply the conjugate of s1(n) corresponding to RS1, the conjugate of s2(n) corresponding to RS2, and so forth to a received RS until Device 2 successfully decodes the RS, after which Device 2 may ascertain based on the s(n) that succeeded which device had originated the RS.

Still referring to the second aspect, since Device 1 may communicate with Device 2 via multiple backscatter devices, there may be additional beams swept in nested/multi-stage beam sweeps than illustrated in the examples of FIGS. 8 and 9. For example, Device 1 may perform a beam sweep, and each backscatter device may perform its own beam sweep during each beam of Device 1. The beam sweeps of each backscatter device may be performed sequentially or in parallel. Device 2 may differentiate the beams of each backscatter device based on the orthogonality (e.g., s(n)) of each received RS/s(n) as described above. Similarly, Device 2 may perform its own reception beam sweep throughout the process. An example of possible pseudocode for this nested beam sweep process may be as follows (where the multiple backscatter devices are referred to as tags in this example for simplicity):

```
For each Device 2 reception beam:
  For each Device 1 transmission beam:
    Send RS in direct beam to Device 2
    For each tag 1 transmission beam:
      Send RS to Device 2
    For each tag 2 transmission beam
      Send RS to Device 2
```

The aforementioned process may be performed alone, or as part of one phase (e.g., Phase 2) of a two-phase process for beam training or management. An example of possible pseudocode for the two-phase process may be as follows (where the multiple backscatter devices are again referred to as tags in this example for simplicity):

```
Phase 1
  Power off or deactivate tag
  For each Device 2 reception beam:
    For each Device 1 transmission beam:
      Send RS in direct beam to Device 2
Phase 2
  Power on or activate tag
  For each Device 2 reception beam:
    For each Device 1 transmission beam:
      Send RS in direct beam to Device 2
      For each tag 1 transmission beam:
        Send RS to Device 2
      For each tag 2 transmission beam
        Send RS to Device 2
```

In the aforementioned two-phase process, each time Device 2 receives a RS (whether from Device 1 in direct link, or from a tag in a backscattered link), Device 2 measures and computes one or more of metrics (e.g., RSRP/RSRQ/SINR) for that RS. After Phase 1 completes, Device 2 may send a CSI report of identified best beams to Device 1. After Phase 2 completes, Device 2 may send one CSI report of identified best direct beams to Device 1, and Device 2 may send another CSI report of identified best beam combinations to each backscatter device (respectively). The CSI reports may indicate whether a direct link beam is stronger than any indirect link beam, or vice-versa. For example, if a Phase 1 metric for a Device 1 direct beam is better than the best Phase 2 metric for any Device 1-tag-Device 2 beam, Device 1 may learn this information from both CSI reports and may send subsequent signals directly to Device 2. Alternatively, if a Phase 2 metric for a Device 1-tag-Device 2 beam is better than the best Phase 1 metric for any Device 1 direct beam, Device 1 and the tags may learn this respectively from both CSI reports and will send subsequent signals via one or more of the tags to Device 2.

Following the aforementioned two phase process and the CSI reporting from Device 2, Device 1 and the multiple backscatter devices (e.g., the tags in this example) may each perform beam refinement. For example, Device 1 may determine a best Device 1-tag beam from the first CSI report, and each tag may determine a best tag-Device 2 beam from the second CSI report. Subsequently, if a given tag is configured to send its own data (e.g., if s(n) includes data rather than an RS sequence), Device 1 may send a RS to that tag over the best Device 1-tag beam, and the tag may modulate the RS with its own data and send the modulated signal with its data to Device 2 over the best tag-Device 2 beam. Alternatively, if the tag is configured to act as beamforming device, Device 1 may send its own data to the tag over the best Device 1-tag beam, and the tag may reflect or redirect the signal with the data from Device 1 to Device 2 over the best tag-Device 2 beam.

While the previously described aspects and examples all refer to Device 2 being a separate device than Device 1, the RF reader may alternatively be the same device as the RF source. In the case where Device 1 is the same as Device 2, the previously described examples of mode indications and beam management may continue to apply for reference signals from Device 1, but not for data from Device 1, since an RF source/reader generally does not send user data to itself. Thus, Device 1 may still send RSs to backscatter devices, and Device 1 may still perform the previously described, nested beam sweep procedure, but only for the backscattered link (e.g., Phase 2 only in the aforementioned two-phase procedure). In contrast, Device 1 may not perform the direct beam sweep associated with Phase 1, since that would lead to the RF source/reader unnecessarily sending RSs to itself. Moreover, Device 1 may send CSI reports to the backscatter device only, since Device 1 may similarly not send CSI reports to itself. In any event, the backscatter devices may still send their own data to Device 1/Device 2.

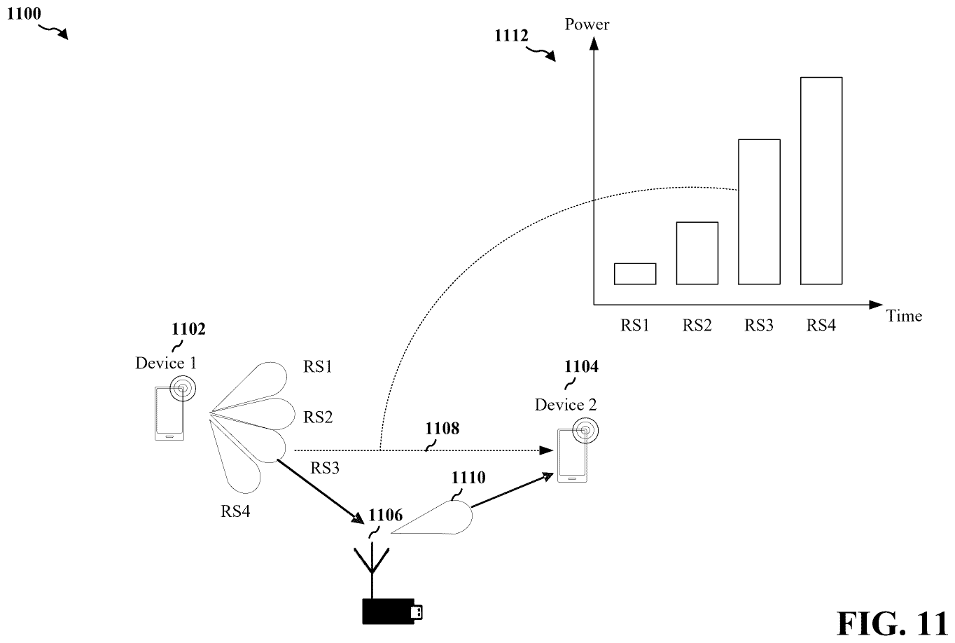

FIG. 11 illustrates an example 1100 of a source device 1102 (Device 1) which communicates with a destination device 1104 (Device 2) indirectly via a backscatter device 1106 (e.g., referred to as a tag in this example for simplicity). As previously described in the two-phase approach for beam management, Device 2 may first measure the RSRP or other energy metric of reference signals received over direct link beams to determine best direct beams, and then the RSRP or other energy metric of combined reference signals received over Device 1-tag-Device 2 beams to determine best beam combinations. However, during the Phase 2 process, when Device 1 performs its beam sweep and transmits data in a given beam to the tag, that beam may include a sidelobe which carries the data in a signal 1108 towards Device 2. Potentially, this signal may have a higher RSRP, RSRQ or/and SINR than that of the backscattered signal communicated in a beam 1110 from the tag to Device 2. For example, the RSRP of the signal 1108 may be higher than the RSRP of data in beam 1110 due to the larger distance between Device 1 and Device 2 via the tag than between Device 1 and Device 2 directly, as well as due to the additional consumption of energy and attenuation of the signal backscattered by the tag. For instance, in the illustrated example of FIG. 11, graph 1112 shows that during the time in which Device 1 transmits RS1, RS2, RS3, and RS4 in different beams to the tag (e.g., during first beam sweep 810 of FIG. 8), Device 2 may measure an RSRP from RS3 which is larger than an RSRP measured from the RS received over beam 1110. If this RSRP of the direct link RS is greater than the RSRP of the backscattered RS that Device 2 receives from the tag, the ability of Device 2 to determine the best tag-Device 2 link in its beam combinations during Phase 2 may be affected. Therefore, it would be helpful for Device 2 to filter out such direct link signals (e.g., signal 1108) during the determination process of the best beam combinations (e.g., during the Phase 2 process).

Accordingly, aspects of the present disclosure allow Device 2 to cancel, filter, or otherwise remove such direct link beams or RSs from the composite received signal to prevent them from affecting the determination of best beam combinations. For example, in the analog domain, a band pass filter may be provided which allows the RS from the backscatter device to pass through to Device 2 (e.g., over beam 1110), but not the RS from Device 1 directly (e.g., signal 1108). In another example, a notch filter may be provided in the analog domain which may cancel the RS from Device 1 directly (e.g., signal 1108), so that Device 2 does not receive such direct link RSs during Phase 2. In another example, in the digital domain, similar filtering based on differences in frequency between the direct link RSs and the backscattered RSs may be provided.

Initially, the RF source may send a single port (or single layer) reference signal or CW x(n) over a duration of time, where n=0,1, . . . , up to N samples. The backscatter device may modulate the RS x(n) with the backscattering signal s(n), which modulated signal may be modified by the channel characteristics (e.g., channels *x(n) s(n)), the precoder P₁ used at RF source, and the precoder P₂ used at the backscatter device. Thus, on one sub-channel (RE) (or a single carrier case), at time n, the received signal at Device 2 is: h₁ P₁ x(n)+h₃ P₂ H₂ P₁ x(n) s(n), where the first term corresponds to the direct link and the second term corresponds to the reflected/backscattered link. Here, P₁ refers to the channel precoder (e.g., an analog beamformer and digital precoder) at Device 1 with size M×1; h₁ is the direct channel between Device 1 and Device 2 with size 1×M; h₃ is the channel between the backscatter device and Device 2 with size 1×N; P₂ is beamformer vector used at the backscatter device with size N×N; and H₂ is the channel matrix between Device 1 and the backscatter device with size N×M.

In order to remove or cancel the direct link term from the received signal at Device 2, one approach may be that, after Device 1 performs beam training and determines the best direct beam in Phase 1, then during Phase 2, Device 1 may down-select the beams swept towards the backscatter device so as to exclude the determined direct link beams in Phase 1. For instance, referring to FIG. 11, Device 1 may refrain from transmitting RS3 in the corresponding beam towards the backscatter device to prevent signal 1108 from occurring. Device 1 may possibly exclude such beam(s) from the beam sweep because the channel h₁ and precoder P₁ are the same between Phase 1 and Phase 2, and thus the direct link channel properties have not changed between phases. However, if the backscatter device happens to be in the direction of the beam(s) that Device 1 excludes (such as in the case illustrated in FIG. 11), then Device 2 may end up determining a less ideal beam combination as its best beam combination.

Therefore, rather than having Device 1 exclude beams from the Phase 2 process which may potentially limit the best beam combinations available, Device 2 may instead filter direct link signals previously estimated during the Phase 1 process from the backscattered signals received during the Phase 2 process. For example, while Device 1 is performing its first beam sweep towards the backscatter device, the backscatter device may transmit a composite or joint signal to Device 2 including the source signal from Device 1 and the backscattered signal from the backscatter device as previously described. After receiving the composite signal, Device 2 may cancel the direct link signal previously estimated during Phase 1 from the composite signal in Phase 2 to estimate the backscattered signal. For instance, using the received direct link signals during Phase 1 training, Device 2 may have acquired an estimate of h₁ P₁ x(n), assuming the channel and precoders/beamformers at Device 1 have not changed between Phase 1 and Phase 2, and Device 2 may apply that estimate to remove the common signal from the joint backscattered signal received from the backscatter device. Thus, Device 2 may utilize its Phase 1 observations or measurements to remove the direct link signal from its reception of the composite Device 1-backscatter device-Device 2 signal, and Device 2 may estimate the composite/joint signal accordingly (subject to different, additive noise between the direct link and the indirect link).

As an example, during Phase 2 of the two-phase process, Device 2 may receive the composite signal h₁ P₁ x(n)+h₃ P₂ H₂ P₁ x(n) s(n) from the backscatter device (e.g., in beam 1110). Device 2 may further obtain directly from Device 1 (e.g., in signal 1108) the same h₁ P₁ x(n) previously obtained in Phase 1, or more practically due to the existence of additive noise, Device 2 may obtain h₁ P₁ x(n)+z(n), where z(n) is the additive noise. However, since the term h₁ P₁ x(n) is common between Phase 1 and Phase 2 (subject to the additive noise), Device 2 may leverage the previously estimated h₁ P₁ x(n) to remove the direct link signal (e.g., signal 1108) from consideration and estimate the backscattered signal h₃ P₂ H₂ P₁ x(n) s(n). For example, Device 2 may subtract the two received signals or terms: h₁ P₁ x(n)+h₃ P₂ H₂ P₁ x(n) s(n)−h₁ P₁ x(n), to result in h₃ P₂ H₂ P₁ x(n) s(n). From this result, Device 2 may obtain an estimate on the backscattered signal, subject to the difference in noise between Phase 1 and Phase 2 (e.g., z₁(n) and z₂(n) for Phase 1 and Phase 2).

Various examples follow by which Device 2 may refrain from considering direct link beams (e.g., filter out the direct link signal) to facilitate determination of the best beam combinations for the joint, backscattered signal received from the backscatter device. In one example, passband filtering of the backscattered signal may be applied at Device 2, since the backscattered signal may be designed with a frequency domain signature such that the joint received signal is shifted in the frequency domain with respect to the from Device 1. In another example, the direct link signal (e.g., the CW/RS from Device 1) may be removed in the analog domain using a notch filter, and thus only the backscattered signal may be processed. In a further example, Device 2 may process the signals in the digital domain due to the added frequency shift or signature applied for the backscattered signal s(n) relative to the source signal x(n). For instance, after performing a discrete Fourier transform (DFT) or otherwise converting the signals to the frequency domain, if the RSs were provided using an OFDM transceiver, Device 2 may digitally process the backscattered signal while ignoring the direct link signal (RS/CW) in the frequency domain.

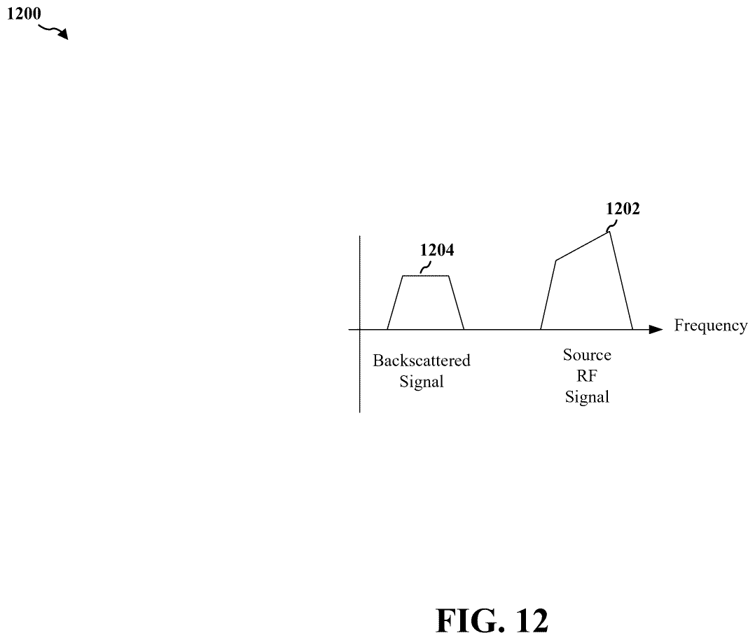

FIG. 12 illustrates an example 1200 illustrating a difference in frequencies between a source RF signal 1202 and a backscattered signal 1204. When the source RF signal x(n) is modulated by the backscattered signal s(n), the modulation adds a frequency shift or signature to the source RF signal so that the signals may be distinguishable in the frequency domain. Thus, due to the difference in frequencies between the signals, in one example, Device 2 may apply a passband filter in the analog domain which is configured to allow the backscattered signal to pass through the filter but not the source RF signal. In another example, due to the difference in frequencies between the signals, Device 2 may apply a notch filter in the analog domain to the source RF signal which is configured to cancel out that signal. In a further example, Device 2 may apply filtering to the signals in the digital domain (rather than in the analog domain using passband filters or notch filters) similarly based on the difference in frequencies between the signals.

In another example, Device 2 may filter the direct link signal from the composite signal by applying a correlation function between x(n) and s(n). For example, Device 2 may multiply the composite received signal by the conjugate of x(n) (represented by x(n)*), multiply that signal by the conjugate of s(n) (represented by s(n)*), and then using an integrator or other averaging function which accumulates the energy across the time duration of the RS transmission, Device 2 may obtain an expected value of the products in both terms. Since the average over time of s(n) is designed to be zero, approximately zero, or otherwise very small, this process effectively cancels out the direct link signal from the composite signal, leaving only the backscattered signal to be estimated. This process may be performed in the digital or analog domain.

For instance, in one example process that Device 2 may perform utilizing correlations between x(n) and s(n), following receipt of the aforementioned composite signal h₁ P₁ x(n)+h₃ P₂ H₂ P₁ x(n) s(n) from the backscatter device, Device 2 may initially multiply both terms with x(n)* to arrive at h₁ P₁|x(n)|2+h₃ P₂ H₂ P₁|x(n)|² s(n). Afterwards, Device 2 may multiply the result with s(n)* to arrive at h₁P1|x(n)|² s(n)++h₃ P₂ H₂ P₁|x(n)|²|s(n)|². Then, Device 2 may integrate the result to arrive at h₁P1 E{|x(n)|² s(n)*}+h₃ P₂ H₂ P₁ E{|x(n)|²|s(n)|²}, where pₓ=E{|x(n)|²} is average power of x(n), and pₛ=E{s(n)|²} is the average power of pₛ. Since E{|x(n)|² s(n)}=E{|x(n)|²} E{s(n)}=pₓ E{s(n)}, and E{s(n)} is designed to be a very small value or zero, the first term h₁P₁ E{|x(n)|² s(n)*}=h₁ P₁pₓ E{s(n)}≈0, and thus the first term (corresponding to the direct link signal) may effectively be filtered or zeroed out from the integrated result, leaving h₃ P₂ H₂ P₁ E{|x(n)|²|s(n)|²}. From this remaining term, Device 2 may estimate the backscattered signal s(n).

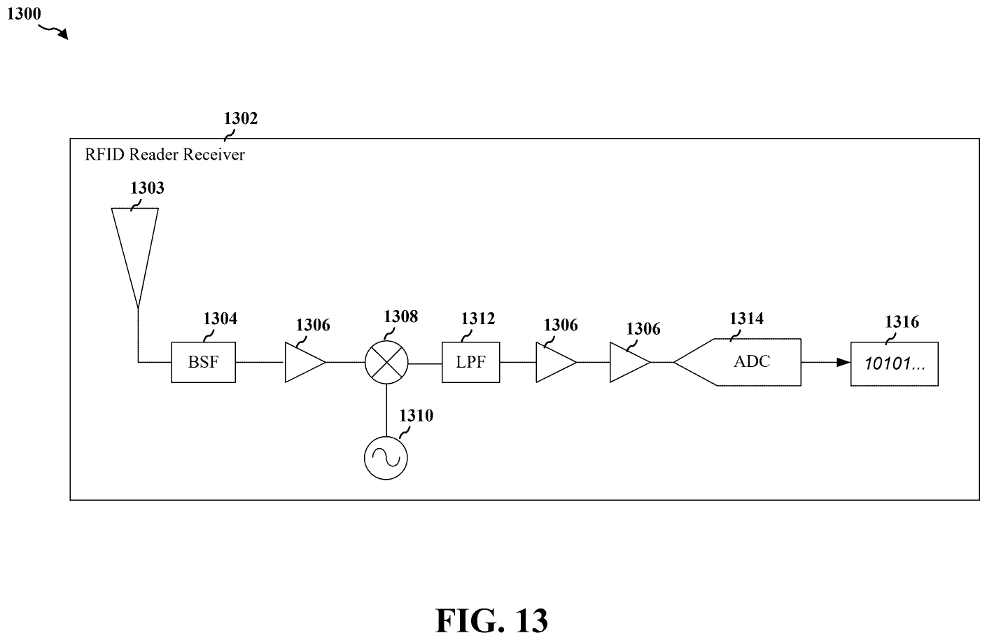

In another example, the receiver of Device 2 (e.g., the RFID reader) may include circuitry which performs the aforementioned correlation function or a similar process in the analog domain (e.g., in the case where the RS received directly from Device 1 is a CW). For instance, FIG. 13 illustrates an example 1300 of an RFID reader circuit 1302 including an antenna 1303, a band select filter 1304, amplifiers 1306, a mixer 1308, a local oscillator 1310, a low pass filter 1312, and an analog to digital converter 1314. Initially, the composite signal h₁ P₁ x(n)+h₃ P₂ H₂ P₁ x(n) s(n) may be received via the antenna and passed through the band select filter. The local oscillator may be configured based on the frequency of the direct link signal x(n) to provide conjugated signal x(n)* to the mixer, which the mixer may apply to the received composite signal to result in h₁ P₁|x(n)|²+h₃ P₂ H₂ P₁|x(n)|² s(n). The local oscillator, or another local oscillator in the RFID reader circuit (not shown), may also be configured based on the frequency of the backscattered signal s(n) to provide conjugated signal s(n)* to the mixer, or to a different mixer in the RFID reader circuit, which the mixer may apply to the previous result to arrive at h₁P₁|x(n)|² s(n)*+h₃ P₂ H₂ P₁|x(n)|²|s(n)|². Then, the low pass filter may only allow the lower frequency reflected signal to pass through to the ADC, for example, in response to performing the aforementioned integration function to zero out the direct link signal. The ADC may then convert the remaining backscattered signal to digital data 1316 for Device 2 to apply in its best beam combination determinations.

In each of the above filtering examples, Device 2 determines the best direct link signal from Device 1 in the Phase 1 process, and subsequently filters out this signal from the composite signal during the Phase 2 process to arrive at the backscattered signal. Device 2 may then determine the best beam combinations between Device 1, the backscatter device, and Device 2 from the backscattered signal. However, the Phase 1 process may in some cases take significant time to complete before Phase 2 can begin (e.g., if Device 1 sweeps through numerous beams), delaying Device 2 from determining the best beam combinations. Therefore, in another aspect of the present disclosure, to reduce the number of total beam sweeps performed and speed up the best beam determination process, Device 2 may jointly process direct link RSs and backscattered RSs in a single phase (i.e., Phase 1 may be removed from the two-phase process). For instance, rather than determining the best direct beam from signals communicated by Device 1 directly, Device 1 may direct communication only to the backscatter device to be backscattered to Device 2, and Device 2 may instead determine the best direct link signals from the composite signal received from the ambient backscattered device. Afterwards, to determine the best backscattered link signal, Device 2 may cancel or filter the determined direct link signal from the composite received signal, such as previously described.

As an example, to completely remove Phase 1 from the aforementioned two-phase process, Device 1 may apply a similar correlation/integration function as in the previous examples, but here combine the processing of direct link beams (Phase 1) with the processing of backscattered beams (Phase 2) in a single phase. That is, instead of determining the best direct link signal by itself in the Phase 1 sub-process, and subsequently filtering out this signal from the composite signal later on to determine best beam combinations during the Phase 2 sub-process (as was done in the various aforementioned examples), Device 2 here instead determines the best direct beams and the best beam combinations from the composite signal in effectively one phase or process. For instance, after Device 2 receives the composite signal h₁ P₁ x(n)+h₃ P₂ H₂ P₁ x(n) s(n), Device 2 may modify the composite received signal with x(n)* similar to the previous examples, but before modifying this result by s(n)*, Device 2 first performs the integration of the result to cancel out the backscattered signal from the composite signal and thereby determine the best direct link beam. Since the average/expected value of s(n) is or approximately 0, Device 2 may effectively cancel or filter out the backscattered signal from the composite signal and leave only the direct link signal for Device 2 to process and obtain the best direct beams (e.g., the indices of the RSs corresponding to the best direct beams). Afterwards, Device 2 may modify the result with s(n)* and apply integration such as previously described to cancel out the direct link signal from the composite signal, thereby allowing Device 2 to obtain the best Device 1-ambient backscatter device-Device 2 beams as well (e.g., the indices of the RSs corresponding to the best beam combinations).

In one example, Device 2 initially stores the received composite signal (including all n samples) in memory. To obtain the direct beams, Device 2 may modify the received composite signal (including x(n) and s(n)) with x(n)* and average the result over time. For instance, Device 2 may multiply the received composite signal h₁ P₁ x(n)+h₃ P₂ H₂ P₁ x(n) s(n) with x(n)* to obtain h₁P₁|x(n)|²+h₃ P₂ H₂ P₁|x(n)|² s(n). Device 2 may then average/integrate this result over time, and since

$$E \{ s ( n ) \} = \frac{1}{N} {\sum }_{n = 0}^{N - 1} s ( n )$$

is designed to be a very small value or zero or approximately zero, the result effectively cancels or filters out the backscattered signal, leaving h₁P₁ pₓ+noise. Device 2 may determine the direct link beam from the result accordingly. Similarly, to obtain the backscattered beam, Device 2 may again modify the received composite signal with x(n)*, but instead of averaging or integrating this result as before, Device 2 may modify this result with s(n)* and average this result over time. For instance, after Device 2 modifies the received composite signal (including x(n) and s(n)) with x(n)*, Device 2 may further modify this result with s(n)* to obtain h₁P₁|x(n)|² s(n)++h₃ P₂ H₂ P₁|x(n)|²|s(n)|². Then, after integrating this result (e.g., accumulating the energy across the time duration of the RS transmission), Device 2 may arrive at h₁P₁ E{|x(n)|² s(n)}+h₃ P₂ H₂ P₁ E{|x(n)|²|s(n)|²}, where pₓ=E{|x(n)|²} is the average power of x(n) and pₛ=E{|s(n)|²} is the average power of pₛ. As previously described in the earlier examples, this result is equivalent to (or approximately) h₃ P₂ H₂ P₁ E{|x(n)|²|s(n)|²} due to E{s(n)} being equal to or approximately zero, effectively cancelling or filtering out the direct signal and allowing Device 2 to determine the beam combination including the Device 1 beam and the backscatter device beam accordingly.

As the source signal and backscattered signal are received according to a nested beam sweep, Device 2 may perform the above calculations for each source signal and for each backscattered signal accordingly (e.g., for each n samples of a signal received in a given beam during the nested beam sweep). For example, if Device 1 transmits a signal to the backscatter device in a first beam sweep over four transmission beams, and if the backscatter device transmits a backscattered signal to Device 2 in a second beam sweep over four transmission beams, Device 2 may receive a composite received signal sixteen times and thus may similarly perform the above calculations sixteen times. This process can be quite time-consuming as the number of transmission beams in a beam sweep increases.

Therefore, to reduce the number of beam sweeps and calculations and thus operate more efficiently, Device 2 may reuse a same source RS metric for each iteration in a beam sweep of the backscatter device (or in reverse, a same tag RS metric for each iteration in a beam sweep of Device 1). In this example, assume that the backscatter device performs the first beam sweep, and that Device 1 performs the second beam sweep (i.e., the reverse of that shown in FIG. 8). In such case, in the calculations above, for each beam of the first beam sweep, Device 2 may calculate a source signal energy metric h₁P₁ pₓ, and determine the best beam corresponding to the largest energy metric. Afterwards, for each beam in the second beam sweep, Device 2 may calculate the backscattered signal energy metric h₃ P₂ H₂ P₁ p_x p_s based on the same source signal energy metric h₁P₁ pₓ corresponding to the best Device 1 beam. This is in contrast to the previous example approach, where Device 2 calculates the backscattered signal energy metric based on a different source signal energy metric during each iteration of the first beam sweep. As a result, in the above case where the first beam sweep includes four transmission beams and the second beam sweep includes four transmission beams, Device 2 may receive and perform calculations for a composite received signal eight times (e.g., after one completion of the first beam sweep and one completion of the second beam sweep). Thus, as the number of beams in a beam sweep increases, more time may be saved than in the previous example approach.

In the above examples, the nested beam sweep may be such that the source beam sweep is performed first and the backscatter beam sweep is performed second (during each iteration of the source beam sweep), or vice-versa such that the backscatter beam sweep is performed first and the source beam sweep is performed second (during each iteration of the backscatter beam sweep). Therefore, Device 1 and Device 2 may initially acquire a common understanding on which order of beam sweeping is performed, prior to the beam sweeping and the best beam combination determination. For example, in the former case, in the above calculations, Device 2 may apply the same source signal metric for each backscattered beam in a single beam sweep of the backscatter device, since the best direct beam may not change during the backscattered beam sweep. However, in the latter case, the calculations may change accordingly. For instance, Device 2 may initially calculate the backscattered beam energy metric h₃ P₂ H₂ P₁ p_x p_s for every backscattered beam, determine the best beam from those calculated metrics, and apply the energy metric corresponding to the best backscattered beam (e.g., the largest energy metric) to every calculation for every source beam following. For example, when Device 2 performs the aforementioned calculations to arrive at the source signal energy metric h₁P₁ pₓ for every source beam, Device 2 may apply the same, best backscattered beam energy metric which Device 2 previously obtained in each calculation.

In any of the above examples, for each source beam, after performing the above calculations to arrive at the source signal energy metric h₁P₁ pₓ, Device 2 may obtain and store this energy metric of the source beams. Device 2 afterwards may compare the different stored metrics to identify the largest metric(s) (strongest signal(s)), and these largest metric(s) correspond to the best source beams that Device 2 may report in one CSI report. Similarly, for each backscattered beam, after performing the aforementioned calculations to arrive at the backscattered beam energy metric h₃ P₂ H₂ P₁ p_x p_s, Device 2 may obtain and store this energy metric of the backscattered beams. Device 2 afterwards may compare the different stored metrics to identify the largest metric(s) (strongest signal(s)), and these largest metric(s) correspond to the best backscattered beams that Device 2 may report to Device 1 and to the backscatter device in another CSI report. The best beam combination which Device 2 determines includes one of the best source beams and one of the best backscattered beams. The energy metrics here (e.g., the calculated terms), may represent the RSRP of the corresponding RS, or may be converted to RSRQ or/and SINR (e.g., if divided by the noise).

Thus, in one of the above-described examples, Device 2 may initially fix the energy metric corresponding to a backscattered beam and go through the aforementioned calculations using that fixed energy metric to determine best source beams and report these beams to Device 1. Device 2 may similarly proceed in this manner for each backscattered beam, and Device 2 may report the best combinations of source beams and backscattered beam to Device 1 and the backscatter device. Alternatively, in another of the above-described examples, since a nested beam sweep would involve a same source beam being applied during a backscattered beam sweep, Device 2 may fix the energy metric corresponding to a best source beam (e.g., one with the highest RSRP, RSRQ or/and SINR) and apply that fixed energy metric when determining best backscattered beams and report these beams to the backscatter device. In an alternative to the above-described examples, the reverse may be applied (e.g., Device 2 may initially fix the energy metric corresponding to a source beam first). However, these examples assume that the fixed source beam has the same strength across all the backscattered beams (or vice-versa in the case of the reverse approach), which may practically not be the case due to each backscattered beam resulting in different noise or due to s(n) being very small but not 0 and thus different for each backscattered beam (or vice-versa in the case of the reverse approach).

Therefore, in another aspect of the present disclosure, Device 2 may not immediately report the best source beam following the first calculation of h₁P₁ pₓ across all source beams given one backscattered beam. Instead, Device 2 may average that calculation with other obtained values of h₁P₁ pₓ for each other backscattered beam, since h₁ P₁ pₓ for the same source beam may change during other backscattered beams due to different noise. For example, for better estimation of source beams, Device 2 may average the observations of the source beam for each beam value at the backscatter device (e.g., a tag) according to the following formula:

$${h}_{1} {P}_{1} {p}_{x} + \frac{E \{ s ( n ) \} + noise}{\# beams at tag} ;$$

assuming that h₁ (and other channels) do not change significantly across the whole process. After Device 2 averages all the different h₁ P₁ pₓ terms together for the same source beam across all the tag beams, Device 2 may report that average value rather than only the first obtained value. Thus, rather than only averaging the best source beam given a fixed backscattered beam as described in the previous examples, Device 2 here may perform this averaging for each source beam across all the backscattered beams, and determine a better source beam accordingly.

In an additional example, Device 2 may apply the aforementioned source beam averaging to further consolidate the direct link beam determination in Phase 1. That is, rather than forgoing Phase 1 and only applying Phase 2 to determine the best source beams (whether or not using averaging) and the best tag beams as in the previously described examples, here Device 1 may still perform the direct beam sweep of Phase 1, and Device 2 may still determine the best direct beam in Phase 1 as previously described. However, here in Phase 2, Device 2 may apply the aforementioned averaging calculations to account for different noise between tag beams across the tag beams when reporting the best source beam. Moreover, the energy metric for the best direct beam obtained in Phase 1 may not have the E{s(n)}+noise terms since the backscatter device is deactivated, but the energy metric for the best source beam obtained in Phase 2 may have the E{s(n)}+noise terms. Thus, Device 2 may average the energy metric from Phase 2 with the energy metric in Phase 1 to find the best source beam across the tag beams while accounting for the difference in (or lack of) noise between the energy metrics.

Overall, the above examples indicate that Device 2 may perform any of the following when determining best beam combinations: 1) cancel or filter out the direct link signal obtained from Phase 1 during the Phase 2 calculation in order to prevent direct link beam strength from affecting tag beam determinations; or 2) jointly determine best direct link beams and best tag beams in the same phase. In the latter case, Phase 1 may be disabled and Device 2 may determine best direct link beams with the tag beams in Phase 2 using (or not using) averaging across different tag beams. This allows Device 1 and Device 2 to save time and power through the elimination of Phase 1. Alternatively, Phase 1 may be enabled, and Device 2 may fine tune the best direct link beam determined in Phase 1 using averaging across different tag beams in Phase 2, along with determining the best tag beams as previously described, in order to improve the Phase 1 process.

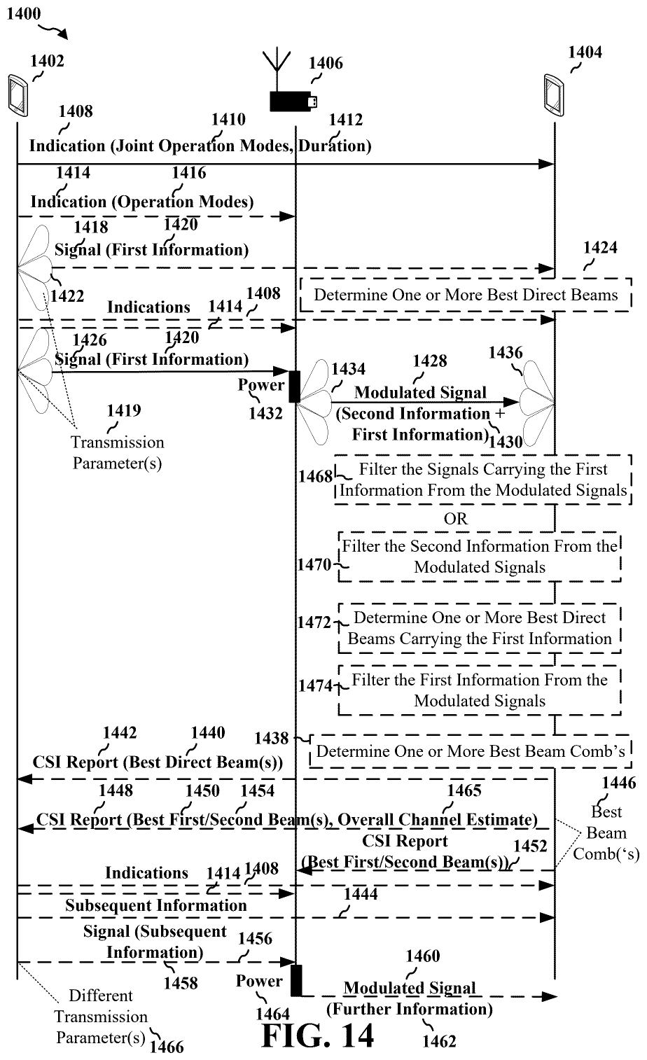

FIG. 14 is an example 1400 of a call flow between a source device 1402 (Device 1), a destination device 1404 (Device 2), and a backscatter device 1406. In the illustrated example, the source device and the destination device are different UEs, but the various aspects of the present disclosure are not limited to this example. For instance, in other examples, the source device may be a base station while the destination device may be a UE. Alternatively, the source device may be the same as the destination device (e.g., there is one device rather than two devices). The backscatter device may be an RFID tag, a UE (e.g., a RedCap UE), or some other passive IoT or semi-passive IoT device.

Initially, Device 1 transmits an indication 1408 to Device 2 of an active one of a plurality of joint operation modes 1410 to be applied to transmissions of the source device and the backscatter device. The plurality of joint operation modes 1410 may, for example, include a first mode in which Device 1 and the backscatter device both transmit data, a second mode in which Device 1 transmits a reference signal while the backscatter device transmits data, a third mode in which Device 1 transmits data and the backscatter device transmits a reference signal, a fourth mode in which Device 1 and the backscatter device both transmit reference signals, and a fifth mode in which Device 1 transmits data (or a reference signal in a variation of the fifth mode) and the backscatter device is powered off or otherwise disabled/deactivated from transmitting data or reference signals. Any one of these joint operation modes may be provided to Device 2 in the indication 1408, which indication may be provided, for example, via a DCI, SCI, MAC-CE, or RRC configuration. The indication 1408 may also include a duration 1412 (e.g., a number of transmissions, slots, etc.) over which the indicated, active one of the joint operation modes is to apply to transmissions of the source device and the backscatter device.

Additionally, Device 1 may transmit an indication 1414 to the backscatter device of an active one of a plurality of operation modes 1416 to be applied to transmissions of the backscatter device. The plurality of operation modes 1416 may, for example, include a first mode in which the backscatter device acts as a beamforming device which transmits data of Device 1 to Device 2, a second mode in which the backscatter device transmits its own data to Device 2, a third mode in which the backscatter device transmits a reference signal to Device 2, and a fourth mode in which the backscatter device does not transmit any data or reference signals. Any one of these operation modes may be provided to the backscatter device in the indication 1414, which indication may similarly be provided, for example, via a DCI, SCI, MAC-CE, or RRC configuration.

In some examples, Device 1 may transmit a signal 1418 carrying first information 1420 directly to Device 2 using one or more transmission parameters 1419 (e.g., MCS, transmission power, etc.). The first information 1420 may be data or a reference signal sequence depending on the active one of the joint operation modes indicated to Device 2 in the indication 1408. For example, Device 1 may configure the active joint operation mode such that the first information is data when Device 1 intends to transmit user data directly to Device 2. The active joint operation mode here may be, for example, the fifth mode previously described. Alternatively, Device 1 may configure the active joint operation mode such that the first information is a reference signal sequence when Device 1 intends to perform beam management, for example. The active joint operation mode here may be, for example, the variation of the fifth mode previously described. Similarly, in either case, the indication 1414 to the backscatter device may apply, for example, the fourth operation mode in which the backscatter device does not transmit any data or reference signals. In the latter case, Device 1 may perform a direct beam sweep (e.g., Phase 1 of the aforementioned two-phase beam training process) in which Device 1 transmits the signal 1418 (e.g., a reference signal) in each of its transmission beams 1422 to Device 2. After Device 2 receives the signal 1418 in each of the transmission beams 1422 directly from Device 1, at block 1424, Device 2 may determine one or more best direct beams out of the transmission beams 1422. For instance, Device 2 may measure the RSRP, RSRQ, SINR, or other energy metric of the signal 1418 received in each of the transmission beams, and identify the transmission beam(s) or reference signal indices corresponding to the highest energy metric(s). In other examples, Device 1 may not transmit signal 1418 directly to Device 2 for beam management, for instance, when performing a single phase beam training process.

Afterwards, Device 1 may transmit another one of indication 1408 to Device 2, and another one of indication 1414 to the backscatter device, respectively changing the active joint operation mode to one of the first, second, third, or fourth modes previously described, and the operation mode to one of the first, second, or third modes previously described. Device 1 may transmit a signal 1426 carrying first information 1420 to the backscatter device (e.g., for the backscatter device to re-direct to Device 2) using the one or more transmission parameters 1419. The first information 1420 may be data x(n) or a reference signal sequence x(n) depending on the active one of the joint operation modes indicated to Device 2 in the another one of indication 1408. For example, Device 1 may configure the active joint operation mode such that the first information is data when Device 1 intends to transmit user data indirectly to Device 2 via the backscatter device. Alternatively, Device 1 may configure the active joint operation mode such that the first information is a reference signal sequence when Device 1 intends to perform beam management, for example. In the latter case, Device 1 may perform a first beam sweep (e.g., in Phase 2 of the aforementioned two-phase beam training process, or in a single phase beam training process) in which Device 1 transmits the signal 1426 in each of its transmission beams 1422 to the backscatter device.

Upon receiving the signal 1426 from Device 1, the backscatter device 1406 may transmit a modulated signal 1428 carrying second information 1430 to Device 2. For instance, the received signal may supply power 1432 (e.g., energy) to, trigger, or otherwise activate the mixer(s), oscillator(s), processor(s) or other components of the backscatter device to modulate the signal 1426 with the second information 1430 and to communicate the second information as well as the first information 1420 in the modulated signal 1428 to Device 2. The second information 1430 may be data s(n) or a reference signal sequence s(n) depending on the active one of the joint operation modes indicated to Device 2 in the another one of indication 1408 and depending on the active one of the operation modes indicated to the backscatter device in the another one of indication 1414. For example, Device 1 may configure the active joint operation mode and the active operation mode such that the second information is data when Device 1 intends the backscatter device to transmit user data to Device 2 (e.g., for position tracking, inventorying, etc.). Alternatively, Device 1 may configure the active joint operation mode and the active operation mode such that the second information is a reference signal sequence when Device 1 intends the backscatter device to perform beam management, for example. In the latter case, the backscatter device may perform a second beam sweep (e.g., in Phase 2 of the aforementioned two-phase beam training process, or in a single phase beam training process) in which the backscatter device transmits the modulated signal 1428 in each of its transmission beams 1434 to Device 2.

Device 2 may receive the modulated signal 1428 carrying the second information 1430 as well as the first information 1420 according to the active joint operation mode indicated in the indication 1408. For example, if Device 1 configured the active joint operation mode such that the first information and the second information are reference signal sequences (e.g., for beam management), Device 2 may perform a reception beam sweep in which Device 2 receives the modulated signal in each of its reception beams 1436 from the backscatter device. Afterwards, at block 1438, Device 2 may determine one or more best beam combinations of the transmission beams 1422 (first beams) and transmission beams 1434 (second beams) over which the modulated signal 1428 was received. For example, Device 2 may measure the RSRP, RSRQ, SINR, or other energy metric of the modulated signal 1428 received in each iteration of a nested beam sweep including the first beam sweep and the second beam sweep, and identify a combination of the transmission beams 1422, 1434 or reference signal indices corresponding to the highest energy metric(s) in associated iteration(s). Alternatively, if Device 1 configured the active joint operation mode such that Device 2 will receive user data, Device 2 may not perform the reception beam sweep and instead receive the data in a single reception beam.

If Device 2 determines one or more best direct beams 1440 from the signals 1418 (e.g., CSI-RS) of Device 1, Device 2 may transmit a CSI report 1442 to Device 1 indicating the best direct beam(s). For example, Device 2 may provide Device 1 an index, timestamp, or other information of the reference signal(s) or transmission beams 1422 determined at block 1424 to have the highest energy metric(s), and Device 1 may perform beam refinement of its transmission beams 1422 accordingly. For example, Device 1 may transmit subsequent information 1444 (e.g., data or a reference signal) in one of the indicated best direct beams to Device 2 following receipt of the CSI report 1442.

If Device 2 determines one or more best beam combinations 1446 from the modulated signals 1428 (e.g., CSI-RS) of the backscatter device, Device 2 may transmit a CSI report 1448 to Device 1 indicating one or more best first beams 1450 from transmission beams 1422 and one or more best second beams 1454 from the transmission beams 1434. For example, Device 2 may provide Device 1 an index, timestamp, or other information of the reference signal(s) or transmission beams 1422 determined at block 1438 to have the highest energy metric(s), and this index, timestamp, or other information may further indicate to Device 1 the transmission beams 1434 also having the highest energy metric(s). Similarly, Device 2 may transmit a CSI report 1452 to the backscatter device indicating the one or more best first beams 1450 from transmission beams 1422 and the one or more best second beams 1454 from the transmission beams 1434. For example, Device 2 may provide the backscatter device an index, timestamp, or other information of the reference signal(s) or transmission beams 1434 determined at block 1438 to have the highest energy metric(s), and this index, timestamp, or other information may further indicate to the backscatter device the transmission beams 1422 also having the highest energy metric(s).

Device 1 and the backscatter device may accordingly perform beam refinement of their respective transmission beams 1422, 1434 in response to the respective CSI reports. For example, if Device 1 receives the CSI report 1442 indicating the best direct beam(s) and the CSI report 1448 indicating the best beam combination(s), and if Device 1 determines from the CSI reports that one of the best direct beam(s) is associated with a higher energy metric than any of the best first beam(s) in the best beam combinations, Device 1 may transmit subsequent information 1444 (e.g., data or a reference signal) in one of the indicated best direct beams to Device 2 following receipt of the CSI reports 1442, 1448. Device 1 may transmit the subsequent information 1444 following sending of another one of indication 1408 to Device 2 changing the joint operation mode, for example, to the fifth mode or variation of the fifth mode previously described, and following sending of another one of indication 1414 to the backscatter device changing the operation mode, for example, to the fourth mode previously described. On the other hand, if Device 1 determines from the CSI reports that one of the best first beam(s) in the best beam combinations is associated with a higher energy metric than any of the best direct beam(s), Device 1 may transmit a signal 1456 including subsequent information 1458 (e.g., data or a reference signal sequence) in one of the indicated best first beams to the backscatter device following receipt of the CSI reports 1442, 1448. Device 1 may transmit the signal 1456 following sending of another one of indication 1408 to Device 2 changing the joint operation mode, for example, to one of the first, second, third, or fourth modes previously described, and following sending of another one of indication 1414 to the backscatter device changing the operation mode, for example, to one of the first, second, or third modes previously described. Then, following receipt of the CSI report 1452 and upon receiving the signal 1456 from Device 1, the backscatter device 1406 may transmit a modulated signal 1460 carrying further information 1462 (e.g., data or a reference signal sequence) in one of the indicated best second beams to Device 2. For instance, the received signal may supply power 1464 (e.g., energy) to, trigger, or otherwise activate the mixer(s), oscillator(s), processor(s) or other components of the backscatter device to modulate the signal 1456 carrying the subsequent information 1458 with the further information 1462 and to communicate both information in the modulated signal 1460 to Device 2.

Additionally, Device 2 may include an overall channel estimate 1465 of the channel between Device 1, the backscatter device, and Device 2 in the CSI report 1448. For example, the overall channel estimate may include the channel given by one of the best first beams indicated in the CSI report 1448. Device 1 may perform beam refinement of its transmission beams 1422 accordingly in response to the overall channel estimate. For example, Device 1 may transmit the signal 1456 in one of the best first beams indicated in the CSI report 1448, which beam corresponds to the channel indicated in the overall channel estimate. Alternatively or additionally, Device 1 may transmit the signal 1456 using one or more different transmission parameters 1466 than the one or more transmission parameters 1419 applied to the signal 1418 or signal 1426 (e.g., a different MCS, transmission power, etc.).

In some examples of the two-phase beam training process, after Device 2 has received from Device 1 the signals 1418 carrying first information 1420 (e.g., following the direct beam sweep), and after Device 2 has received from the backscatter device 1406 at least one of the modulated signals 1428 (e.g., during or after the nested beam sweep), then at block 1468, Device 2 may filter the signal(s) 1418 from the modulated signals 1428 prior to determining the one or more best beam combinations at block 1438. For example, Device 2 may apply a passband filter to the modulated signal 1428 or a notch filter to the signal 1418 in the analog domain, similar filtering in the digital domain, or a correlation or integration function such as previously described which cancels the signal from the modulated signal in the digital domain or analog domain, and determine the best beam combinations from the filtered signals accordingly (e.g., in response to obtaining an energy metric corresponding to each of the transmission beams 1434 and identifying the best beam combinations from the highest energy metrics).

In other examples of the single phase beam training process where Device 1 has not transmitted the signals 1418 to Device 2 directly, after Device 2 has received from the backscatter device 1406 at least one of the modulated signals 1428 (e.g., during or after the nested beam sweep), then prior to determining the one or more best beam combinations at block 1438, Device 2 may perform a different filtering process. First, at block 1470, Device 2 may filter the second information 1430 from the modulated signals. For example, the second information may be a backscattered reference signal, and Device 2 may apply a correlation or integration function such as previously described which cancels the backscattered reference signal from the modulated signal. Then, at block 1472, Device 2 may determine one or more best direct beams carrying the first information. For example, the first information 1420 may be a reference signal received from Device 1 (e.g., in transmission beams 1422) which remains in the modulated signal following the filtering at block 1470, and Device 2 may obtain an energy metric corresponding to each of these reference signals and identify the best direct beams from the highest energy metrics. Next, at block 1474, Device 2 may filter the first information 1420 from the modulated signals. For example, Device 2 may apply a correlation or integration function such as previously described which cancels the signal 1418 from the modulated signal, leaving only the backscattered reference signal. Following the filtering at block 1474, Device 2 may determine the one or more best beam combinations at block 1438 such as previously described. For instance, Device 2 may obtain an energy metric corresponding to each of the backscattered reference signals, and Device 2 may identify the best beam combinations from the highest energy metrics.

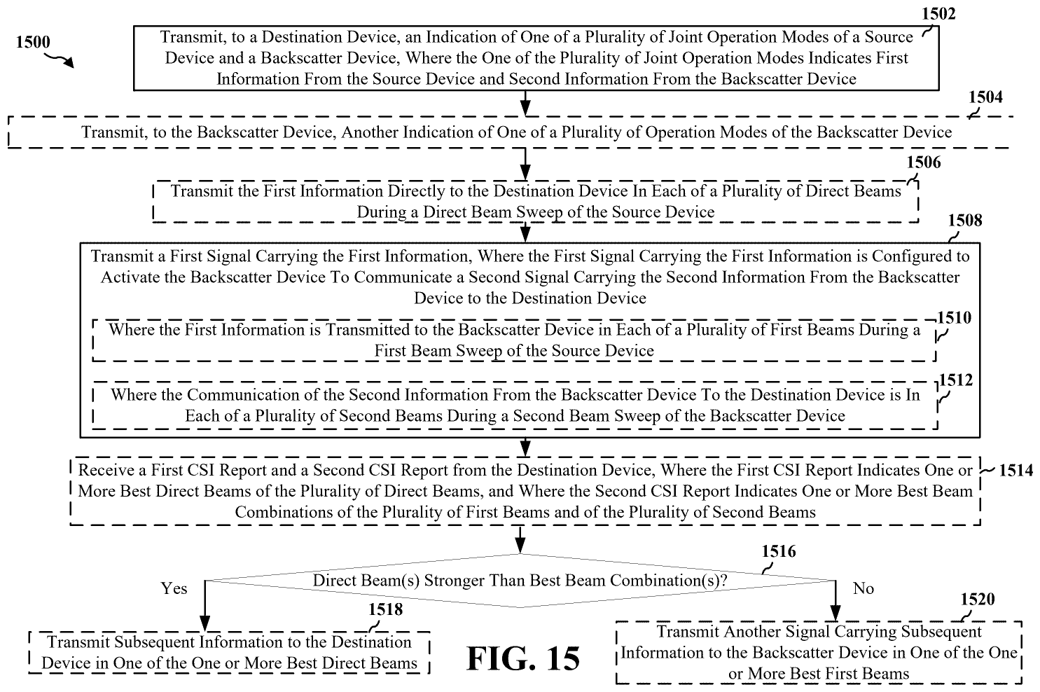

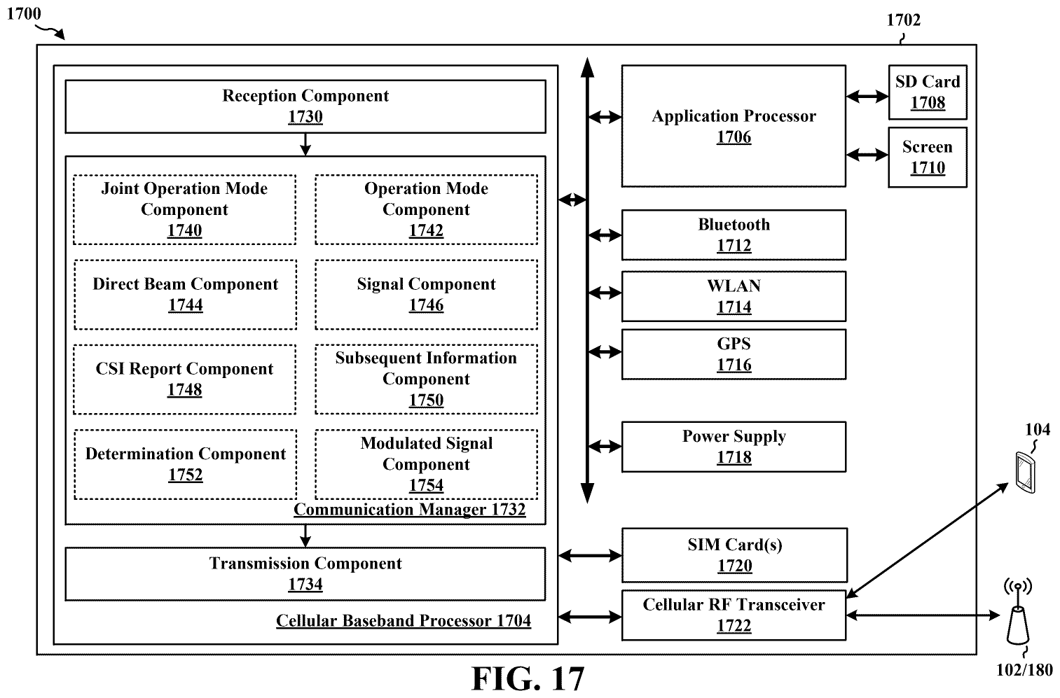

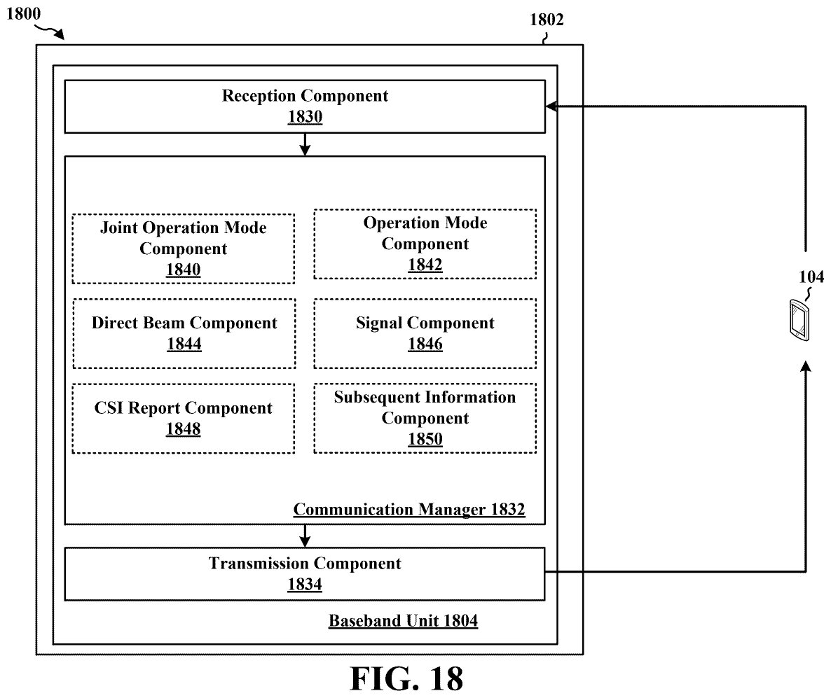

FIG. 15 is a flowchart 1500 of a method of wireless communication. The method may be performed by a source device (e.g., the UE 104, the base station 102/180; the first wireless communication device 410; the source device 502, 702, 802, 902, 1002, 1102, 1402; the apparatus 1702 (FIG. 17); the apparatus 1802 (FIG. 18)). Optional aspects are illustrated in dashed lines. The method allows the source device to indicate to a destination device (e.g., the UE 104; the second wireless communication device 450; the destination device 504, 704, 804, 1004, 1104, 1404) a joint operation mode of the source device and a backscatter device (e.g., backscatter device 506, 706, 806, 908, 1006, 1106, 1406). The joint operation mode indicates the information that the source device may send to the destination device via the backscatter device, as well as other information that the backscatter device may send to the destination device, thereby facilitating decoding of the information by the destination device. The method also specifies various considerations for beam management in view of the backscatter device.

At 1502, the source device transmits to a destination device, an indication of one of a plurality of joint operation modes of the source device and a backscatter device. For example, 1502 may be performed by joint operation mode component 1740, 1840. For instance, referring to FIG. 14, Device 1 transmits an indication 1408 to Device 2 of an active one of a plurality of joint operation modes 1410 to be applied to transmissions of the source device and the backscatter device.

In one example, the indication at 1502 may be transmitted in one of DCI, SCI, a MAC-CE, or a RRC configuration. For instance, referring to FIG. 14, any one of the joint operation modes may be provided to Device 2 in the indication 1408, which indication may be provided, for example, via a DCI, SCI, MAC-CE, or RRC configuration.

In one example, the indication at 1502 may include a duration over which the one of the plurality of joint operation modes is active. For instance, referring to FIG. 14, the indication 1408 may also include a duration 1412 (e.g., a number of transmissions, slots, etc.) over which the indicated, active one of the joint operation modes is to apply to transmissions of the source device and the backscatter device.

At 1504, the source device may transmit, to the backscatter device, another indication of one of a plurality of operation modes of the backscatter device. For example, 1504 may be performed by operation mode component 1742, 1842. For instance, referring to FIG. 14, Device 1 may transmit an indication 1414 to the backscatter device of an active one of a plurality of operation modes 1416 to be applied to transmissions of the backscatter device.

At 1506, the source device may transmit, prior to a first beam sweep at 1510, first information directly to the destination device in each of a plurality of direct beams during a direct beam sweep of the source device. For example, 1506 may be performed by direct beam component 1744, 1844. For instance, referring to FIG. 14, Device 1 may transmit a signal 1418 carrying first information 1420 directly to Device 2 using one or more transmission parameters 1419 (e.g., MCS, transmission power, etc.). The first information 1420 may be data or a reference signal sequence depending on the active one of the joint operation modes indicated to Device 2 in the indication 1408. For example, Device 1 may configure the active joint operation mode such that the first information is data when Device 1 intends to transmit user data directly to Device 2. Alternatively, Device 1 may configure the active joint operation mode such that the first information is a reference signal sequence when Device 1 intends to perform beam management, for example. In the latter case, Device 1 may perform a direct beam sweep (e.g., Phase 1 of the aforementioned two-phase beam training process) in which Device 1 transmits the signal 1418 (e.g., a reference signal) in each of its transmission beams 1422 to Device 2. The direct beam sweep here may correspond to direct beam sweep 822 of FIG. 8, illustrated in Phase 1 of the example of FIG. 9.

At 1508, the source device transmits a first signal carrying the first information, where the first signal carrying the first information is configured to activate the backscatter device to communicate a second signal carrying second information from the backscatter device to the destination device. The second signal carrying the second information may be a signal carrying the first information modulated with the second information. For example, 1508 may be performed by signal component 1746, 1846. As an example, at 1510, the first information may be transmitted to the backscatter device in each of a plurality of first beams during a first beam sweep of the source device, and at 1512, the communication of the second information from the backscatter device to the destination device may be in each of a plurality of second beams during a second beam sweep of the backscatter device. For instance, referring to FIG. 14, Device 1 may transmit a signal 1426 carrying first information 1420 to the backscatter device (e.g., for the backscatter device to re-direct to Device 2) using the one or more transmission parameters 1419. In one example, Device 1 may perform a first beam sweep (e.g., in Phase 2 of the aforementioned two-phase beam training process, or in a single phase beam training process) in which Device 1 transmits the signal 1426 in each of its transmission beams 1422 to the backscatter device. The first beam sweep here may correspond to first beam sweep 810 of FIG. 8, illustrated in Phase 2 of the example of FIG. 9. Upon receiving the signal 1426 from Device 1, the backscatter device 1406 may transmit a modulated signal 1428 carrying second information 1430 to Device 2. For instance, the received signal may supply power 1432 (e.g., energy) to, trigger, or otherwise activate the mixer(s), oscillator(s), processor(s) or other components of the backscatter device to modulate the signal 1426 with the second information 1430 and to communicate the second information as well as the first information 1420 in the modulated signal 1428 to Device 2. In one example, the backscatter device may perform a second beam sweep (e.g., in Phase 2 of the aforementioned two-phase beam training process, or in a single phase beam training process) in which the backscatter device transmits the modulated signal 1428 in each of its transmission beams 1434 to Device 2. The second beam sweep here may correspond to second beam sweep 814 of FIG. 8, illustrated in Phase 2 of the example of FIG. 9.

The one of the plurality of joint operation modes (indicated at 1502) indicates the first information and the second information. For instance, referring to FIG. 14, the first information 1420 may be data x(n) or a reference signal sequence x(n) depending on the active one of the joint operation modes indicated to Device 2 in the indication 1408. For example, Device 1 may configure the active joint operation mode such that the first information is data when Device 1 intends to transmit user data indirectly to Device 2 via the backscatter device. Alternatively, Device 1 may configure the active joint operation mode such that the first information is a reference signal sequence when Device 1 intends to perform beam management, for example. Moreover, the second information 1430 may be data s(n) or a reference signal sequence s(n) depending on the active one of the joint operation modes indicated to Device 2 in the indication 1408 and depending on the active one of the operation modes indicated to the backscatter device in the indication 1414. For example, Device 1 may configure the active joint operation mode and the active operation mode such that the second information is data when Device 1 intends the backscatter device to transmit user data to Device 2 (e.g., for position tracking, inventorying, etc.). Alternatively, Device 1 may configure the active joint operation mode and the active operation mode such that the second information may be a reference signal sequence when Device 1 intends the backscatter device to perform beam management, for example.

In one example, the plurality of joint operation modes may comprise a first mode in which the first information may be first data and the second information may be second data, a second mode in which the first information may be a first reference signal sequence and the second information may be the second data, a third mode in which the first information may be the first data and the second information may be a second reference signal sequence, and a fourth mode in which the first information may be the first reference signal sequence and the second information may be the second reference signal sequence. The source device and the backscatter device may further include a fifth mode indicating the backscatter device to power down. For instance, referring to FIG. 14, the plurality of joint operation modes 1410 may, for example, include a first mode in which Device 1 and the backscatter device both transmit data, a second mode in which Device 1 transmits a reference signal while the backscatter device transmits data, a third mode in which Device 1 transmits data and the backscatter device transmits a reference signal, a fourth mode in which Device 1 and the backscatter device both transmit reference signals, and a fifth mode in which Device 1 transmits data and the backscatter device is powered off or otherwise disabled/deactivated from transmitting data or reference signals.

In one example, the one of the plurality of operation modes (indicated at 1504) further indicates whether the second information is the second data or the second reference signal sequence. For example, the plurality of operation modes may comprise: a first mode indicating the backscatter device to re-direct the first data from the source device in a beam towards the destination device, a second mode indicating the backscatter device to transmit the second data to the destination device, and a third mode indicating the backscatter device to transmit the second reference signal sequence to the destination device. The backscatter device may further include a fourth mode indicating the backscatter device to power down. For instance, referring to FIG. 14, the plurality of operation modes 1416 may, for example, include a first mode in which the backscatter device acts as a beamforming device which transmits data of Device 1 to Device 2, a second mode in which the backscatter device transmits its own data to Device 2, a third mode in which the backscatter device transmits a reference signal to Device 2, and a fourth mode in which the backscatter device does not transmit any data or reference signals.

In one example, the second information in each of the second beams may be a reference signal sequence, and each of the reference signal sequences may be one of a plurality of configured sequences for channel sounding or beam management. For instance, referring to FIGS. 8 and 14, an applied sequence 819 of s(n) in the modulated signal 1428 may be pre-configured in the backscatter device, or indicated by Device 1 to the backscatter device, from one of multiple pre-configured or configured sequences 821 for s(n) which are known to Device 2 and available for the backscatter device to apply during the second beam sweep 814 for channel sounding or beam management.

At 1514, the source device may receive a first CSI report and a second CSI report from the destination device, where the first CSI report indicates one or more best direct beams of the plurality of direct beams (swept at 1506), and where the second CSI report indicates one or more best beam combinations of the plurality of first beams (swept at 1510) and of the plurality of second beams (swept at 1512). For example, 1514 may be performed by CSI report component 1748, 1848. For instance, referring to FIG. 14, Device 1 may receive CSI report 1442 (the first CSI report) from Device 2 indicating the best direct beam(s) 1440. For example, Device 1 may receive from Device 2 an index, timestamp, or other information of the reference signal(s) or transmission beams 1422 which have the highest energy metric(s). Here, CSI report 1442 may correspond to phase 1 measurement report 824 in the example of FIG. 8. Moreover, Device 1 may receive CSI report 1448 (e.g., the second CSI report) from Device 2 indicating the best beam combination(s) 1446 of one or more best first beams 1450 from transmission beams 1422 and one or more best second beams 1454 from the transmission beams 1434. For example, Device 1 may receive from Device 2 an index, timestamp, or other information of the reference signal(s) or transmission beams 1422 which have the highest energy metric(s), and this index, timestamp, or other information may further indicate to Device 1 the transmission beams 1434 also having the highest energy metric(s). Here, CSI report 1448 may correspond to phase 2 measurement report 826 in the example of FIG. 8. Moreover, the best beam combinations here may correspond to the pairs 916 of beams 906, 910, 912, 914 identified, for example, as having the highest RSRP, RSRQ, or SINR of each pair of beams illustrated in Phase 2 of the example of FIG. 9.

Afterwards, at 1516, the source device may determine from the CSI reports whether the one or more best direct beams are stronger than the one or more best beam combinations of the plurality of first beams and of the plurality of second beams. In response to the one or more best direct beams being stronger than the one or more best beam combinations of the plurality of first beams and of the plurality of second beams, at 1518, the source device may transmit subsequent information to the destination device in one of the one or more best direct beams. For example, 1518 may be performed by subsequent information component 1750, 1850. For instance, referring to FIG. 14, if Device 1 receives the CSI report 1442 indicating the best direct beam(s) 1440 and the CSI report 1448 indicating the best beam combination(s) 1446, and if Device 1 determines from the CSI reports that one of the best direct beam(s) 1440 is associated with a higher energy metric than any of the best first beam(s) 1450 in the best beam combinations 1446, Device 1 may transmit subsequent information 1444 (e.g., data or a reference signal) in one of the indicated best direct beams to Device 2 following receipt of the CSI reports 1442, 1448.

Alternatively, in response to the one or more best beam combinations of the plurality of first beams and of the plurality of second beams being stronger than the one or more best direct beams, at 1520, the source device may transmit a third signal carrying subsequent information to the backscatter device in one of the one or more best first beams of the plurality of first beams. For example, 1520 may be performed by subsequent information component 1750, 1850. The third signal may be configured to activate the backscatter device to communicate a fourth signal carrying further information from the backscatter device to the destination device in one of the one or more best second beams of the plurality of second beams. The further information may be data of the backscatter device or of the source device. For instance, referring to FIG. 14, if Device 1 determines from the CSI reports 1442, 1448 that one of the best first beam(s) 1450 in the best beam combinations 1446 is associated with a higher energy metric than any of the best direct beam(s) 1440, Device 1 may transmit signal 1456 including subsequent information 1458 (e.g., data or a reference signal sequence) in one of the indicated best first beams to the backscatter device following receipt of the CSI reports 1442, 1448. Then, following receipt of the CSI report 1452 and upon receiving the signal 1456 from Device 1, the backscatter device 1406 may transmit modulated signal 1460 carrying further information 1462 (e.g., data or a reference signal sequence) in one of the indicated best second beams to Device 2. For instance, the received signal may supply power 1464 (e.g., energy) to, trigger, or otherwise activate the mixer(s), oscillator(s), processor(s) or other components of the backscatter device to modulate the signal 1456 carrying the subsequent information 1458 with the further information 1462 and to communicate both information in the modulated signal 1460 to Device 2.

In one example pertaining to 1520, the second CSI report may include a channel estimate for an overall channel between the source device and the destination device via the backscatter device. In response to the channel estimate, the third signal may be transmitted from the source device (at 1520): in one of the one or more first best beams, or using a different transmission parameter than a transmission parameter associated with the first signal carrying the first information (at 1508). For instance, referring to FIG. 14, the CSI report 1448 may include overall channel estimate 1465 of the channel between Device 1, the backscatter device, and Device 2. For example, the overall channel estimate may include the channel given by one of the best first beams 1450 indicated in the CSI report 1448. Device 1 may perform beam refinement of its transmission beams 1422 accordingly in response to the overall channel estimate. For example, Device 1 may transmit the signal 1456 in one of the best first beams 1450 indicated in the CSI report 1448, which beam corresponds to the channel indicated in the overall channel estimate 1465. Alternatively or additionally, Device 1 may transmit the signal 1456 using one or more different transmission parameters 1466 than the one or more transmission parameters 1419 applied to the signal 1418 or signal 1426 (e.g., a different MCS, transmission power, etc.).

In one example, the first signal carrying the first information (at 1508) may be configured to activate each of a plurality of backscatter devices including the backscatter device, to communicate a reference signal to the destination device. The second signal carrying the second information comprises one of the reference signals. Each of the reference signals may include an orthogonal sequence relative to other ones of the reference signals, and each of the orthogonal sequences may be associated with a different one of the backscatter devices. For instance, referring to FIGS. 10 and 14, Device 1 may transmit the signal 1426 carrying the first information 1420 to a plurality of backscatter devices 1006, 1406. Each of the backscatter devices may modulate the signal 1426 received from Device 1 with a respective reference signal including a respective sequence s(n) (e.g., modulated signal 1428). For instance, in response to a supply of power from or trigger or other activation by the signal 1426 from Device 1 (or from multiple RSs from Device 1), a first backscatter device may transmit a reference signal (RS1) including one sequence for s(n), a second backscatter device may transmit a reference signal (RS2) including another sequence for s(n), a third backscatter device may transmit a reference signal (RS3) including a further sequence for s(n), and so forth. Each of these backscatter devices may be assigned or associated with their respective sequence s(n) (e.g., in a pre-configuration or indication). Moreover, each of these respective sequences s(n) may be orthogonal to the other to allow Device 2 to decouple the beams of one backscatter device from those of another backscatter device.

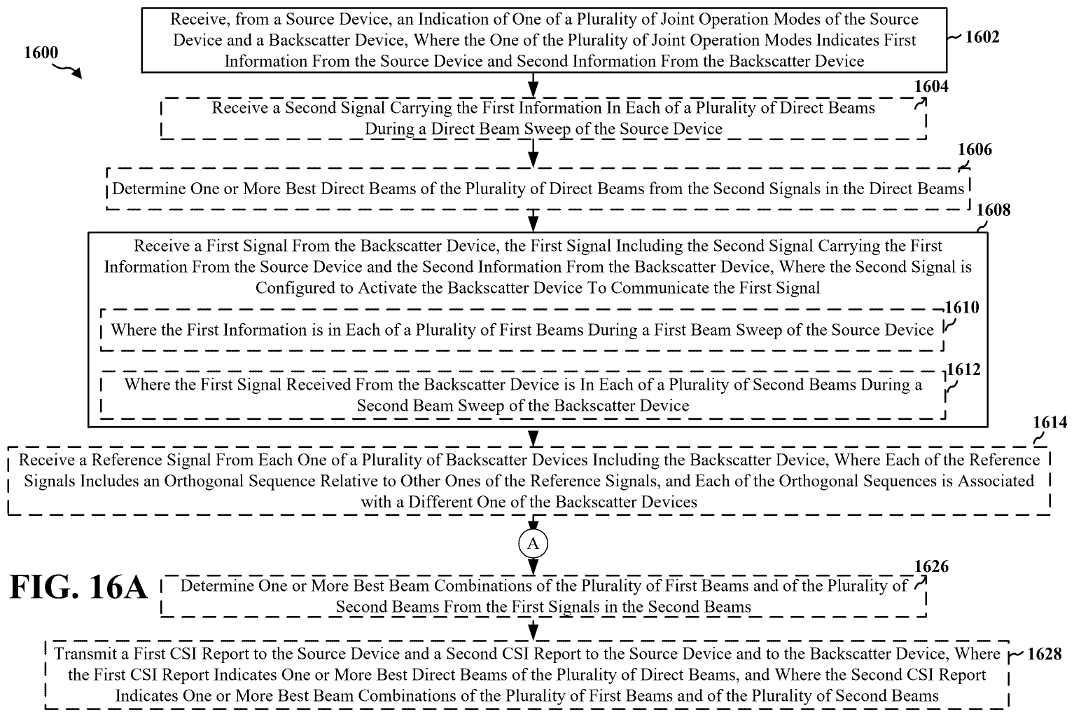

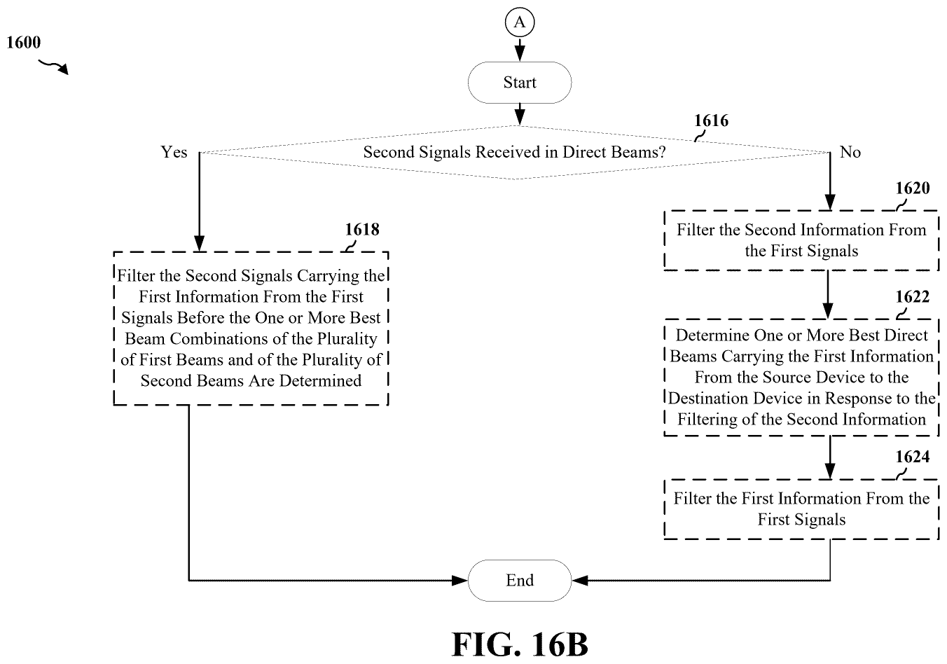

FIGS. 16A-16B show a flowchart 1600 of a method of wireless communication. The method may be performed by a destination device (e.g., the UE 104; the second wireless communication device 450; the destination device 504, 704, 804, 1004, 1104, 1404; the apparatus 1702). Optional aspects are illustrated in dashed lines. The method allows the destination device to obtain from a source device (e.g., the UE 104, the base station 102/180; the first wireless communication device 410; the source device 502, 702, 802, 902, 1002, 1102, 1402) a joint operation mode of the source device and a backscatter device (e.g., backscatter device 506, 706, 806, 908, 1006, 1106, 1406). The joint operation mode indicates the information that the destination device may obtain from the source device via the backscatter device, as well as other information that the destination device may obtain from the backscatter device, thereby facilitating decoding of the information by the destination device. The method also specifies various considerations for beam management in view of the backscatter device.

Referring to FIG. 16A, at 1602, the destination device receives, from a source device, an indication of one of a plurality of joint operation modes of the source device and a backscatter device. For example, 1602 may be performed by joint operation mode component 1740. For instance, referring to FIG. 14, Device 2 may receive an indication 1408 from Device 1 of an active one of a plurality of joint operation modes 1410 to be applied to transmissions of the source device and the backscatter device. In one example, the indication may be received in one of DCI, SCI, a MAC-CE, or a RRC configuration. For instance, referring to FIG. 14, any one of the joint operation modes may be received by Device 2 in the indication 1408, which indication may be provided, for example, via a DCI, SCI, MAC-CE, or RRC configuration. In one example, the indication may include a duration over which the one of the plurality of joint operation modes is active. For instance, referring to FIG. 14, the indication 1408 may also include a duration 1412 (e.g., a number of transmissions, slots, etc.) over which the indicated, active one of the joint operation modes is to apply to transmissions of the source device and the backscatter device.

At 1604, the destination device may receive, prior to a first beam sweep of the source device at 1610 and prior to determining one or more best beam combinations at 1626, a second signal carrying first information from the source device in each of a plurality of direct beams during a direct beam sweep of the source device. For example, 1604 may be performed by direct beam component 1744. For instance, referring to FIG. 14, Device 2 may receive a signal 1418 carrying first information 1420 directly from Device 1 using one or more transmission parameters 1419 (e.g., MCS, transmission power, etc.). The first information 1420 may be data or a reference signal sequence depending on the active one of the joint operation modes indicated to Device 2 in the indication 1408. For example, Device 1 may configure the active joint operation mode such that the first information is data when Device 1 intends to transmit user data directly to Device 2. Alternatively, Device 1 may configure the active joint operation mode such that the first information is a reference signal sequence when Device 1 intends to perform beam management, for example. In the latter case, Device 1 may perform a direct beam sweep (e.g., Phase 1 of the aforementioned two-phase beam training process) in which Device 2 receives the signal 1418 (e.g., a reference signal) from Device 1 in each of the transmission beams 1422 of Device 1. The direct beam sweep here may correspond to direct beam sweep 822 of FIG. 8, illustrated in Phase 1 of the example of FIG. 9.

At 1606, the destination device may determine one or more best direct beams of the plurality of direct beams from the second signals in the direct beams. For example, 1606 may be performed by determination component 1752. For instance, referring to FIG. 14, after Device 2 receives the signal 1418 in each of the transmission beams 1422 directly from Device 1, at block 1424, Device 2 may determine one or more best direct beams out of the transmission beams 1422. For example, Device 2 may measure the RSRP, RSRQ, SINR, or other energy metric of the signal 1418 received in each of the transmission beams, and identify the transmission beam(s) or reference signal indices corresponding to the highest energy metric(s). Similarly, referring to FIG. 8, in response to receiving the reference signal including x(n) directly from Device 1, Device 2 may perform measurements 820 of the received reference signal from Device 1 in each of the first transmission beams 808 during direct beam sweep 822, and based on the measurements, Device 2 may identify the best direct beams from the first transmission beams following the direct beam sweep (e.g., the strongest link(s) between Device 1 and Device 2).

At 1608, the destination device may receive a first signal from the backscatter device. For example, 1608 may be performed by modulated signal component 1754. The first signal may include the second signal carrying first information from the source device and second information from the backscatter device, and the second signal may be configured to activate the backscatter device to communicate the first signal. The first signal may include the second signal modulated with the second information from the backscatter device. As an example, at 1610, the second signal carrying the first information may be in each of a plurality of first beams during a first beam sweep of the source device, and at 1612, the first signal received from the backscatter device may be in each of a plurality of second beams during a second beam sweep of the backscatter device. Moreover, the first signal may be received from the backscatter device in each of a plurality of reception beams during a reception beam sweep of the destination device.

For instance, referring to FIG. 14, Device 2 may receive modulated signal 1428 from ambient backscatter device 1406, which modulated signal includes signal 1426 carrying first information 1420 from Device 1 (e.g., for the backscatter device to re-direct to Device 2). In one example, Device 1 may perform a first beam sweep (e.g., in Phase 2 of the aforementioned two-phase beam training process, or in a single phase beam training process) in which the signal 1426 may be communicated in each of its transmission beams 1422 to the backscatter device. The first beam sweep here may correspond to first beam sweep 810 of FIG. 8, illustrated in Phase 2 of the example of FIG. 9. Upon receiving the signal 1426 from Device 1, the backscatter device 1406 may transmit the modulated signal 1428 carrying second information 1430 to Device 2. For instance, the received signal may supply power 1432 (e.g., energy) to, trigger, or otherwise activate the mixer(s), oscillator(s), processor(s) or other components of the backscatter device to modulate the signal 1426 with the second information 1430 and to communicate the second information as well as the first information 1420 in the modulated signal 1428 to Device 2. In one example, the backscatter device may perform a second beam sweep (e.g., in Phase 2 of the aforementioned two-phase beam training process, or in a single phase beam training process) in which Device 2 receives the modulated signal 1428 in each of the transmission beams 1434 of the backscatter device. The second beam sweep here may correspond to second beam sweep 814 of FIG. 8, illustrated in Phase 2 of the example of FIG. 9. Device 2 may also perform a reception beam sweep in which Device 2 receives the modulated signal in each of its reception beams 1436 from the backscatter device. The reception beam sweep here may correspond to reception beam sweep 818 of FIG. 8.

The one of the plurality of joint operation modes (received in the indication at 1602) indicates the first information and the second information. For instance, referring to FIG. 14, the first information 1420 may be data x(n) or a reference signal sequence x(n) depending on the active one of the joint operation modes indicated to Device 2 in the indication 1408. For example, Device 1 may configure the active joint operation mode such that the first information is data when Device 1 intends to transmit user data indirectly to Device 2 via the backscatter device. Alternatively, Device 1 may configure the active joint operation mode such that the first information is a reference signal sequence when Device 1 intends to perform beam management, for example. Moreover, the second information 1430 may be data s(n) or a reference signal sequence s(n) depending on the active one of the joint operation modes indicated to Device 2 in the indication 1408 and depending on the active one of the operation modes indicated to the backscatter device in the indication 1414. For example, Device 1 may configure the active joint operation mode and the active operation mode such that the second information is data when Device 1 intends the backscatter device to transmit user data to Device 2 (e.g., for position tracking, inventorying, etc.). Alternatively, Device 1 may configure the active joint operation mode and the active operation mode such that the second information is a reference signal sequence when Device 1 intends the backscatter device to perform beam management, for example.

At 1614, the destination device may receive a reference signal from each one of a plurality of ambient backscatter devices including the backscatter device, where the first signal comprises one of the reference signals. For example, 1614 may be performed by signal component 1746. Each of the reference signals may include an orthogonal sequence relative to other ones of the reference signals, and each of the orthogonal sequences may be associated with a different one of the backscatter devices. For instance, referring to FIGS. 10 and 14, Device 1 may transmit the signal 1426 carrying the first information 1420 to a plurality of backscatter devices 1006, 1406. Each of the backscatter devices may modulate the signal 1426 received from Device 1 with a respective reference signal including a respective sequence s(n) (e.g., modulated signal 1428). For instance, in response to a supply of power from or a trigger or other activation by the signal 1426 from Device 1 (or from multiple RSs from Device 1), a first backscatter device may transmit to Device 2 a reference signal (RS1) including one sequence for s(n), a second backscatter device may transmit to Device 2 a reference signal (RS2) including another sequence for s(n), a third backscatter device may transmit to Device 2 a reference signal (RS3) including a further sequence for s(n), and so forth. Each of these backscatter devices may be assigned or associated with their respective sequence s(n) (e.g., in a pre-configuration or indication). Moreover, each of these respective sequences s(n) may be orthogonal to the other to allow Device 2 to decouple the beams of one backscatter device from those of another backscatter device.

Referring now to FIG. 16B, the process described in FIG. 16B may be optionally performed at the position “A” in FIG. 16A before proceeding to the subsequent steps in FIG. 16A. At 1616, the destination device may determine whether second signals carrying the first information were received at 1604 from the source device in direct beams. If so, then at 1618, the destination device may filter the second signals carrying the first information from the first signals before the one or more best beam combinations of the plurality of first beams and of the plurality of second beams are determined at 1626. For example, 1618 may be performed by modulated signal component 1754. For instance, referring to FIG. 14, after Device 2 has received from Device 1 the signals 1418 carrying first information 1420 (e.g., following the direct beam sweep), and after Device 2 has received from the backscatter device 1406 at least one of the modulated signals 1428 (e.g., during or after the nested beam sweep), then at block 1468, Device 2 may filter the signal(s) 1418 from the modulated signals 1428 prior to determining the one or more best beam combinations at block 1438. For example, Device 2 may apply in the analog domain a passband filter to the modulated signal 1428 (e.g., the backscattered signal 1204 of the modulated signal in FIG. 12), a notch filter to the signal 1418 (e.g., the source RF signal 1202 in FIG. 12), or apply similar filtering in the digital domain, which cancels the signal from the modulated signal in the digital domain or analog domain. Alternatively, Device 2 may apply a correlation function between x(n) and s(n) such as previously described (e.g., a function which modifies the modulated signal 1428 by x(n)* and by s(n)* and then integrates or averages the result, either digitally or in the analog domain, using for example, RFID reader circuit 1302 of FIG. 13). The destination device may then determine the best beam combinations from the filtered signals accordingly (e.g., in response to obtaining an energy metric corresponding to each of the transmission beams 1434 and identifying the best beam combinations from the highest energy metrics).

Otherwise, if second signals carrying the first information were not received from the source device in direct beams, then the destination device may apply a different filtering process than that performed at 1618. First, at 1620, the destination device may filter the second information from the first signals. For example, 1620 may be performed by modulated signal component 1754. Second, at 1622, the destination device may determine one or more best direct beams carrying the first information from the source device to the destination device in response to the filtering of the second information at 1620. For example, 1622 may be performed by determination component 1752. Then, at 1624, the destination device may filter the first information from the first signals. For example, 1624 may be performed by modulated signal component 1754. The one or more best beam combinations of the plurality of first beams and of the plurality of second beams carrying the second information may be determined at 1626 in response to the filtering of the first information.

For instance, referring to FIG. 14, at block 1470, Device 2 may filter the second information 1430 from the modulated signals 1428. For example, the second information may be a backscattered reference signal, and Device 2 may apply a correlation or integration function such as previously described which cancels the backscattered reference signal from the modulated signal. For instance, Device 2 may modify the modulated signal 1428 including x(n) and s(n) with x(n)* similar to the previous example, but before modifying this result by s(n)*, Device 2 may first perform integration or averaging of the result to cancel out the backscattered signal from the composite signal and thereby determine the best direct link beam. Then, at block 1472, Device 2 may determine one or more best direct beams carrying the first information. For example, the first information 1420 may be a reference signal received from Device 1 (e.g., in transmission beams 1422) which remains in the modulated signal following the filtering at block 1470, and Device 2 may obtain an energy metric corresponding to each of these reference signals and identify the best direct beams from the highest energy metrics. Next, at block 1474, Device 2 may filter the first information 1420 from the modulated signals. For example, Device 2 may apply a correlation or integration function such as previously described which cancels the signal 1418 from the modulated signal, leaving only the backscattered reference signal. For instance, Device 2 may modify the modulated signal 1428 including x(n) and s(n) with x(n)* and s(n)* before performing integration of the result to cancel out the direct link signal from the composite signal. Following the filtering at block 1474, Device 2 may determine the one or more best beam combinations at block 1438 such as previously described. For instance, Device 2 may obtain an energy metric corresponding to each of the backscattered reference signals, and Device 2 may identify the best beam combinations from the highest energy metrics.

Referring back to FIG. 16A, at 1626, the destination device may determine one or more best beam combinations of the plurality of first beams and of the plurality of second beams from the first signals in the second beams. For example, 1626 may be performed by determination component 1752. For instance, referring to FIG. 14, at block 1438, Device 2 may determine one or more best beam combinations of the transmission beams 1422 (first beams) and transmission beams 1434 (second beams) over which each of the modulated signals 1428 was received. For example, Device 2 may measure the RSRP, RSRQ, SINR, or other energy metric of the modulated signal 1428 received in each iteration of a nested beam sweep including the first beam sweep (e.g., first beam sweep 810 of FIG. 8) and the second beam sweep (e.g., second beam sweep 814 of FIG. 8), and identify a combination of the transmission beams 1422, 1434 or reference signal indices corresponding to the highest energy metric(s) in associated iteration(s). Device 2 may also determine the one or more best beam combinations in response to filtering of the modulated signal 1428, such as previously described with respect to FIG. 16B.

Finally, at 1628, the destination device may transmit a first CSI report to the source device and a second CSI report to the source device and to the backscatter device. For example, 1628 may be performed by CSI report component 1748. The first CSI report may indicate the one or more best direct beams of the plurality of direct beams determined at 1606 or 1622. The second CSI report may indicate the one or more best beam combinations of the plurality of first beams and of the plurality of second beams determined at 1626. The second CSI report may also indicate a channel estimate for an overall channel between the source device and the destination device via the backscatter device. For instance, referring to FIG. 14, Device 2 may transmit CSI report 1442 (the first CSI report) to Device 1 indicating the best direct beam(s) 1440. For example, Device 2 may provide Device 1 an index, timestamp, or other information of the reference signal(s) or transmission beams 1422 determined at block 1424 to have the highest energy metric(s), and Device 1 may perform beam refinement of its transmission beams 1422 accordingly. Device 2 may also transmit CSI report 1448, 1452 (the second CSI report) to Device 1 and to the backscatter device 1406 respectively indicating one or more best first beams 1450 from transmission beams 1422 and one or more best second beams 1454 from the transmission beams 1434. For example, Device 2 may provide Device 1 an index, timestamp, or other information of the reference signal(s) or transmission beams 1422 determined at block 1438 to have the highest energy metric(s), and this index, timestamp, or other information may further indicate to Device 1 the transmission beams 1434 also having the highest energy metric(s). Similarly, Device 2 may provide the backscatter device an index, timestamp, or/and other information of the reference signal(s) or transmission beams 1434 determined at block 1438 to have the highest energy metric(s), and this index, timestamp, or other information may further indicate to the backscatter device the transmission beams 1422 also having the highest energy metric(s). Device 2 may also include overall channel estimate 1465 of the channel between Device 1, the backscatter device, and Device 2 in the CSI report 1448. For example, the overall channel estimate may include the channel given by one of the best first beams indicated in the CSI report 1448.

FIG. 17 is a diagram 1700 illustrating an example of a hardware implementation for an apparatus 1702 that may be used to implement the examples described above. The apparatus 1702 may be a UE and may include a cellular baseband processor 1704 (also referred to as a modem) coupled to a cellular RF transceiver 1722 and one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, and a power supply 1718. The cellular baseband processor 1704 may communicate through the cellular RF transceiver 1722 with the UE 104 and/or BS 102/180. The cellular baseband processor 1704 may include a computer-readable medium/memory. The computer-readable medium/memory may be non-transitory. The cellular baseband processor 1704 may be responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 may further include a reception component 1730, a communication manager 1732, and a transmission component 1734. The communication manager 1732 may include the one or more illustrated components. The components within the communication manager 1732 may be stored in the computer-readable medium/memory and/or configured as hardware within the cellular baseband processor 1704. The cellular baseband processor 1704 may be a component of the device 410, 450 and may include the memory 460 and/or at least one of the TX processor 416, 468, the RX processor 456, 470, and the controller/processor 459, 475. In one configuration, the apparatus 1702 may be a modem chip and include just the baseband processor 1704, and in another configuration, the apparatus 1702 may be the entire UE (e.g., see 450 of FIG. 4) and include the aforediscussed additional modules of the apparatus 1702.

The communication manager 1732 may include a joint operation mode component 1740 that may be configured to transmit, to a destination device, an indication of one of a plurality of joint operation modes of the source device and a backscatter device, where the one of the plurality of joint operation modes indicates first information and second information, e.g., as described in connection with 1502.

The communication manager 1732 may further include an operation mode component 1742 that may be configured to transmit, to the backscatter device, another indication of one of a plurality of operation modes of the backscatter device, where the one of the plurality of operation modes may further indicate whether the second information is second data or a second reference signal sequence, e.g., as described in connection with 1504.

The communication manager 1732 may further include a direct beam component 1744 that may be configured to transmit, prior to a first beam sweep, the first information directly to the destination device in each of a plurality of direct beams during a direct beam sweep of the source device, e.g., as described in connection with 1506.

The communication manager 1732 may further include a signal component 1746 that may receive input in the form of first information and second information from the joint operation mode component 1740 and may be configured to transmit a signal carrying first information, where the signal carrying the first information may be configured to activate the backscatter device to communicate a modulated signal carrying second information from the backscatter device to the destination device, e.g., as described in connection with 1508. The signal component 1746 may be configured to transmit the first information to the backscatter device in each of a plurality of first beams during a first beam sweep of the source device, e.g., as described in connection with 1510, and the communication of the second information from the backscatter device to the destination device may be in each of a plurality of second beams during a second beam sweep of the backscatter device, e.g., as described in connection with 1512.

The communication manager 1732 may further include a CSI report component 1748 that may be configured to receive the direct beams from the direct beam component 1744 and the first beams and the second beams from the signal component 1746, and may be configured to receive a first CSI report and a second CSI report from the destination device, where the first CSI report indicates one or more best direct beams of the plurality of direct beams, and where the second CSI report indicates one or more best beam combinations of the plurality of first beams and of the plurality of second beams, e.g., as described in connection with 1514.

The communication manager 1732 may further include a subsequent information component 1750 that may receive input in the form of the first CSI report and the second CSI report and may be configured to, in response to the one or more best direct beams being stronger than the one or more best beam combinations of the plurality of first beams and of the plurality of second beams, transmit subsequent information to the destination device in one of the one or more best direct beams, e.g., as described in connection with 1516 and 1518. The subsequent information component 1750 may be further configured to, in response to the one or more best beam combinations of the plurality of first beams and of the plurality of second beams being stronger than the one or more best direct beams, transmit another signal carrying subsequent information to the backscatter device in one of the one or more best first beams of the plurality of first beams, where the another signal may be configured to activate the backscatter device to communicate another modulated signal carrying further information from the backscatter device to the destination device in one of the one or more best second beams of the plurality of second beams, and where the further information may be data of the backscatter device or of the source device, e.g., as described in connection with 1516 and 1520.

The joint operation mode component 1740 may be further configured to receive, from a source device, an indication of one of a plurality of joint operation modes of the source device and a backscatter device, where the one of the plurality of joint operation modes indicates the first information and the second information, e.g., as described in connection with 1602.

The direct beam component 1744 may be further configured to receive, prior to the first beam sweep and prior to a determination component 1752 of the communication manager 1732 determining the one or more best beam combinations, the signal carrying the first information from the source device in each of a plurality of direct beams during a direct beam sweep of the source device, e.g., as described in connection with 1604.

The communication manager 1732 may further include the determination component 1752 which may further receive input in the form of the direct beams from the direct beam component 1744 and may be further configured to determine one or more best direct beams of the plurality of direct beams from the signals in the direct beams, e.g., as described in connection with 1606.

The communication manager 1732 may further include a modulated signal component 1754 that may be configured to receive a modulated signal from the backscatter device, the modulated signal including a signal carrying first information from the source device and modulated with second information from the backscatter device, the signal being configured to activate the backscatter device to communicate the modulated signal, e.g., as described in connection with 1608. The signal carrying the first information may be in each of a plurality of first beams during a first beam sweep of the source device, e.g., as described in connection with 1610, and the modulated signal component 1754 may be further configured to receive the modulated signal from the backscatter device in each of a plurality of second beams during a second beam sweep of the backscatter device, e.g., as described in connection with 1612. The modulated signal component 1754 may be further configured to receive the modulated signal from the backscatter device in each of a plurality of reception beams during a reception beam sweep of the destination device.

The modulated signal component 1754 may be further configured to receive a reference signal from each one of a plurality of backscatter devices including the backscatter device, where the modulated signal may comprise one of the reference signals, where each of the reference signals may include an orthogonal sequence relative to other ones of the reference signals, and each of the orthogonal sequences may be associated with a different one of the backscatter devices, e.g., as described in connection with 1614.

The modulated signal component 1754 may be further configured to filter the signals carrying the first information from the modulated signals before the one or more best beam combinations of the plurality of first beams and of the plurality of second beams are determined by the determination component 1752, e.g., as described in connection with 1616 and 1618.

The modulated signal component 1754 may be further configured to filter the second information from the modulated signals, e.g., as described in connection with 1620. The determination component 1752 may receive input in the form of the filtered modulated signals from the modulated signal component and may be further configured to determine one or more best direct beams carrying the first information from the source device to the destination device in response to the filtering of the second information, e.g., as described in connection with 1622. The modulated signal component 1754 may be further configured to filter the first information from the modulated signals, e.g., as described in connection with 1624. The one or more best beam combinations of the plurality of first beams and of the plurality of second beams carrying the second information may be determined by the determination component 1752 in response to the filtering of the first information.

The determination component 1752 may be further configured to determine one or more best beam combinations of the plurality of first beams and of the plurality of second beams from the modulated signals in the second beams, e.g., as described in connection with 1626.

The CSI report component 1748 may be further configured to transmit a first CSI report to the source device and a second CSI report to the source device and to the backscatter device, where the first CSI report may indicate the one or more best direct beams of the plurality of direct beams, and where the second CSI report may indicate the one or more best beam combinations of the plurality of first beams and of the plurality of second beams, e.g., as described in connection with 1628.

The operation component 1742 may be further configured to receive, from a source device, an indication of one of a plurality of operation modes of the backscatter device, e.g., as described in connection with 1902.

The signal component 1746 may be further configured to receive a signal carrying first information from the source device, and in response to receiving the signal carrying the first information from the source device, to communicate a signal carrying second information from the backscatter device to a destination device, where the one of the plurality of operation modes indicates the second information, e.g., as described in connection with 1904, 1906, 1908.

The apparatus may include additional components that perform each of the blocks of the algorithm in the aforementioned flowcharts of FIGS. 15 and 16A-16B. As such, each block in the aforementioned flowcharts of FIGS. 15 and 16A-16B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the cellular baseband processor 1704, may include means for transmitting, to a destination device, an indication of one of a plurality of joint operation modes of the source device and a backscatter device, and means for transmitting a signal carrying first information; wherein the signal carrying the first information may be configured to activate the backscatter device to communicate a modulated signal carrying second information from the backscatter device to the destination device; wherein the one of the plurality of joint operation modes may indicate the first information and the second information.

In one configuration, the indication may be transmitted in one of DCI, SCI, a MAC-CE, or a RRC configuration.

In one configuration, the indication may include a duration over which the one of the plurality of joint operation modes is active.

In one configuration, the plurality of joint operation modes may comprise a first mode in which the first information may be first data and the second information may be second data, a second mode in which the first information may be a first reference signal sequence and the second information may be the second data, a third mode in which the first information may be the first data and the second information may be a second reference signal sequence, a fourth mode in which the first information may be the first reference signal sequence and the second information may be the second reference signal sequence, and a fifth mode that may indicate the backscatter device to power down.

In one configuration, the apparatus 1702, and in particular the cellular baseband processor 1704, may include means for transmitting, to the backscatter device, another indication of one of a plurality of operation modes of the backscatter device; wherein the one of the plurality of operation modes further indicates whether the second information may be the second data or the second reference signal sequence.

In one configuration, the plurality of operation modes may comprise: a first mode indicating the backscatter device to re-direct the first data from the source device in a beam towards the destination device, a second mode indicating the backscatter device to transmit the second data to the destination device, a third mode indicating the backscatter device to transmit the second reference signal sequence to the destination device, and a fourth mode indicating the backscatter device to power down.

In one configuration, the first information may be transmitted to the backscatter device in each of a plurality of first beams during a first beam sweep of the source device, and the communication of the second information from the backscatter device to the destination device may be in each of a plurality of second beams during a second beam sweep of the backscatter device.

In one configuration, the second information in each of the second beams may be a reference signal sequence, and each of the reference signal sequences may be one of a plurality of configured sequences for channel sounding or beam management.

In one configuration, the apparatus 1702, and in particular the cellular baseband processor 1704, may include means for transmitting, prior to the first beam sweep, the first information directly to the destination device in each of a plurality of direct beams during a direct beam sweep of the source device.

In one configuration, the apparatus 1702, and in particular the cellular baseband processor 1704, may include means for receiving a first channel state information (CSI) report and a second CSI report from the destination device; wherein the first CSI report may indicate one or more best direct beams of the plurality of direct beams; and wherein the second CSI report may indicate one or more best beam combinations of the plurality of first beams and of the plurality of second beams.

In one configuration, in response to the one or more best direct beams being stronger than the one or more best beam combinations of the plurality of first beams and of the plurality of second beams, the apparatus 1702, and in particular the cellular baseband processor 1704, may include means for transmitting subsequent information to the destination device in one of the one or more best direct beams.

In one configuration, in response to the one or more best beam combinations of the plurality of first beams and of the plurality of second beams being stronger than the one or more best direct beams, the apparatus 1702, and in particular the cellular baseband processor 1704, may include means for transmitting another signal carrying subsequent information to the backscatter device in one of the one or more best first beams of the plurality of first beams; wherein the another signal may be configured to activate the backscatter device to communicate another modulated signal carrying further information from the backscatter device to the destination device in one of the one or more best second beams of the plurality of second beams; and wherein the further information may be data of the backscatter device or of the source device.

In one configuration, the second CSI report may include a channel estimate for an overall channel between the source device and the destination device via the backscatter device, and wherein in response to the channel estimate, the another signal may be transmitted from the source device: in one of the one or more first best beams, or using a different transmission parameter than a transmission parameter associated with the signal carrying the first information.

In one configuration, the signal carrying the first information may be configured to supply power, to a plurality of backscatter devices including the backscatter device, to communicate a reference signal from each of the backscatter devices to the destination device, the modulated signal comprising one of the reference signals; and wherein each of the reference signals may include an orthogonal sequence relative to other ones of the reference signals, and each of the orthogonal sequences may be associated with a different one of the backscatter devices.

In one configuration, the apparatus 1702, and in particular the cellular baseband processor 1704, may include means for receiving, from a source device, an indication of one of a plurality of joint operation modes of the source device and a backscatter device; means for receiving a modulated signal from the backscatter device, the modulated signal including a signal carrying first information from the source device and modulated with second information from the backscatter device, the signal being configured to activate the backscatter device to communicate the modulated signal; wherein the one of the plurality of joint operation modes indicates the first information and the second information.

In one configuration, the modulated signal may be received from the backscatter device in each of a plurality of reception beams during a reception beam sweep of the destination device.

In one configuration, the signal carrying the first information may be in each of a plurality of first beams during a first beam sweep of the source device, and the modulated signal received from the backscatter device may be in each of a plurality of second beams during a second beam sweep of the backscatter device.

In one configuration, the apparatus 1702, and in particular the cellular baseband processor 1704, may include means for determining one or more best beam combinations of the plurality of first beams and of the plurality of second beams from the modulated signals in the second beams.

In one configuration, the apparatus 1702, and in particular the cellular baseband processor 1704, may include means for receiving, prior to the first beam sweep and prior to determining the one or more best beam combinations, the signal carrying the first information from the source device in each of a plurality of direct beams during a direct beam sweep of the source device.

In one configuration, the apparatus 1702, and in particular the cellular baseband processor 1704, may include means for determining one or more best direct beams of the plurality of direct beams from the signals in the direct beams.

In one configuration, the apparatus 1702, and in particular the cellular baseband processor 1704, may include means for transmitting a first channel state information (CSI) report to the source device and a second CSI report to the source device and to the backscatter device; wherein the first CSI report may indicate the one or more best direct beams of the plurality of direct beams; and wherein the second CSI report may indicate the one or more best beam combinations of the plurality of first beams and of the plurality of second beams.

In one configuration, the second CSI report may indicate a channel estimate for an overall channel between the source device and the destination device via the backscatter device.

In one configuration, the apparatus 1702, and in particular the cellular baseband processor 1704, may include means for filtering the signals carrying the first information from the modulated signals before the one or more best beam combinations of the plurality of first beams and of the plurality of second beams are determined.

In one configuration, the apparatus 1702, and in particular the cellular baseband processor 1704, may include means for filtering the second information from the modulated signals; means for determining one or more best direct beams carrying the first information from the source device to the destination device in response to the filtering of the second information; and means for filtering the first information from the modulated signals; wherein the one or more best beam combinations of the plurality of first beams and of the plurality of second beams carrying the second information may be determined in response to the filtering of the first information.

In one configuration, the apparatus 1702, and in particular the cellular baseband processor 1704, may include means for receiving a reference signal from each one of a plurality of backscatter devices including the backscatter device, wherein the modulated signal may comprise one of the reference signals; wherein each of the reference signals may include an orthogonal sequence relative to other ones of the reference signals, and each of the orthogonal sequences may be associated with a different one of the backscatter devices.

In one configuration, the apparatus 1702, and in particular the cellular baseband processor 1704, may include means for receiving, from a source device, an indication of one of a plurality of operation modes of the backscatter device; wherein the means for receiving is further configured to receive a signal carrying first information from the source device; and in response to receiving the signal carrying the first information from the source device, communicate a signal carrying second information from the backscatter device to a destination device; wherein the one of the plurality of operation modes indicates the second information.

In one configuration, communicating the signal carrying second information from the backscatter device to the destination device includes modulating the signal carrying the first information with the second information.

The aforementioned means may be one or more of the aforementioned components of the apparatus 1702 configured to perform the functions recited by the aforementioned means. As described supra, the apparatus 1702 may include the TX Processor 416, 468, the RX Processor 456, 470, and the controller/processor 459, 475. As such, in one configuration, the aforementioned means may be the TX Processor 416, 468, the RX Processor 456, 470, and the controller/processor 459, 475 configured to perform the functions recited by the aforementioned means.

FIG. 18 is a diagram 1800 illustrating an example of a hardware implementation for an apparatus 1802. The apparatus 1802 may be a BS and may include a baseband unit 1804. The baseband unit 1804 may communicate through a cellular RF transceiver with the UE 104. The baseband unit 1804 may include a computer-readable medium/memory. The baseband unit 1804 may be responsible for general processing, including the execution of software stored on the computer-readable medium/memory. The software, when executed by the baseband unit 1804, may cause the baseband unit 1804 to perform the various functions described supra. The computer-readable medium/memory may also be used for storing data that is manipulated by the baseband unit 1804 when executing software. The baseband unit 1804 may further include a reception component 1830, a communication manager 1832, and a transmission component 1834. The communication manager 1832 may include the one or more illustrated components. The components within the communication manager 1832 may be stored in the computer-readable medium/memory and/or configured as hardware within the baseband unit 1804. The baseband unit 1804 may be a component of the device 410 and may include the memory 476 and/or at least one of the TX processor 416, the RX processor 470, and the controller/processor 475.

The communication manager 1832 may include a joint operation mode component 1840 that may be configured to transmit, to a destination device, an indication of one of a plurality of joint operation modes of the source device and a backscatter device, where the one of the plurality of joint operation modes may indicate first information and second information, e.g., as described in connection with 1502.

The communication manager 1832 may further include an operation mode component 1842 that may be configured to transmit, to the backscatter device, another indication of one of a plurality of operation modes of the backscatter device, where the one of the plurality of operation modes may further indicate whether the second information is second data or a second reference signal sequence, e.g., as described in connection with 1504.

The communication manager 1832 may further include a direct beam component 1844 that may be configured to transmit, prior to a first beam sweep, the first information directly to the destination device in each of a plurality of direct beams during a direct beam sweep of the source device, e.g., as described in connection with 1506.

The communication manager 1832 may further include a signal component 1846 that receives input in the form of first information and second information from the joint operation mode component 1840 and may be configured to transmit a signal carrying first information, where the signal carrying the first information may be configured to activate the backscatter device to communicate a modulated signal carrying second information from the backscatter device to the destination device, e.g., as described in connection with 1508. The signal component 1846 may be configured to transmit the first information to the backscatter device in each of a plurality of first beams during a first beam sweep of the source device, e.g., as described in connection with 1510, and the communication of the second information from the backscatter device to the destination device may be in each of a plurality of second beams during a second beam sweep of the backscatter device, e.g., as described in connection with 1512.

The communication manager 1832 may further include a CSI report component 1848 that may be configured to receive the direct beams from the direct beam component 1844 and the first beams and the second beams from the signal component 1846, and may be configured to receive a first CSI report and a second CSI report from the destination device, where the first CSI report may indicate one or more best direct beams of the plurality of direct beams, and where the second CSI report may indicate one or more best beam combinations of the plurality of first beams and of the plurality of second beams, e.g., as described in connection with 1514.

The communication manager 1832 may further include a subsequent information component 1850 that may receive input in the form of the first CSI report and the second CSI report and may be configured to, in response to the one or more best direct beams being stronger than the one or more best beam combinations of the plurality of first beams and of the plurality of second beams, transmit subsequent information to the destination device in one of the one or more best direct beams, e.g., as described in connection with 1516 and 1518. The subsequent information component 1850 may be further configured to, in response to the one or more best beam combinations of the plurality of first beams and of the plurality of second beams being stronger than the one or more best direct beams, transmit another signal carrying subsequent information to the backscatter device in one of the one or more best first beams of the plurality of first beams, where the another signal may be configured to activate the backscatter device to communicate another modulated signal carrying further information from the backscatter device to the destination device in one of the one or more best second beams of the plurality of second beams, and where the further information may be data of the backscatter device or of the source device, e.g., as described in connection with 1516 and 1520.

The apparatus may include additional components that perform each of the blocks of the algorithm in the aforementioned flowchart of FIG. 15. As such, each block in the aforementioned flowcharts of FIG. 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, may include means for transmitting, to a destination device, an indication of one of a plurality of joint operation modes of the source device and a backscatter device, and means for transmitting a signal carrying first information; wherein the signal carrying the first information may be configured to activate the backscatter device to communicate a modulated signal carrying second information from the backscatter device to the destination device; wherein the one of the plurality of joint operation modes may indicate the first information and the second information.

In one configuration, the indication may be transmitted in one of DCI, SCI, a MAC-CE, or a RRC configuration.

In one configuration, the indication may include a duration over which the one of the plurality of joint operation modes is active.

In one configuration, the plurality of joint operation modes may comprise a first mode in which the first information may be first data and the second information may be second data, a second mode in which the first information may be a first reference signal sequence and the second information may be the second data, a third mode in which the first information may be the first data and the second information may be a second reference signal sequence, a fourth mode in which the first information may be the first reference signal sequence and the second information may be the second reference signal sequence, and a fifth mode that may indicate the backscatter device to power down.

In one configuration, the apparatus 1802, and in particular the baseband unit 1804, may include means for transmitting, to the backscatter device, another indication of one of a plurality of operation modes of the backscatter device; wherein the one of the plurality of operation modes may further indicate whether the second information is the second data or the second reference signal sequence.

In one configuration, the plurality of operation modes may comprise: a first mode indicating the backscatter device to re-direct the first data from the source device in a beam towards the destination device, a second mode indicating the backscatter device to transmit the second data to the destination device, a third mode indicating the backscatter device to transmit the second reference signal sequence to the destination device, and a fourth mode indicating the backscatter device to power down.

In one configuration, the first information may be transmitted to the backscatter device in each of a plurality of first beams during a first beam sweep of the source device, and the communication of the second information from the backscatter device to the destination device may be in each of a plurality of second beams during a second beam sweep of the backscatter device.

In one configuration, the second information in each of the second beams may be a reference signal sequence, and each of the reference signal sequences may be one of a plurality of configured sequences for channel sounding or beam management.

In one configuration, the apparatus 1802, and in particular the baseband unit 1804, may include means for transmitting, prior to the first beam sweep, the first information directly to the destination device in each of a plurality of direct beams during a direct beam sweep of the source device.

In one configuration, the apparatus 1802, and in particular the baseband unit 1804, may include means for receiving a first channel state information (CSI) report and a second CSI report from the destination device; wherein the first CSI report may indicate one or more best direct beams of the plurality of direct beams; and wherein the second CSI report may indicate one or more best beam combinations of the plurality of first beams and of the plurality of second beams.

In one configuration, in response to the one or more best direct beams being stronger than the one or more best beam combinations of the plurality of first beams and of the plurality of second beams, the apparatus 1802, and in particular the baseband unit 1804, may include means for transmitting subsequent information to the destination device in one of the one or more best direct beams.

In one configuration, in response to the one or more best beam combinations of the plurality of first beams and of the plurality of second beams being stronger than the one or more best direct beams, the apparatus 1802, and in particular the baseband unit 1804, may include means for transmitting another signal carrying subsequent information to the backscatter device in one of the one or more best first beams of the plurality of first beams; wherein the another signal may be configured to activate the backscatter device to communicate another modulated signal carrying further information from the backscatter device to the destination device in one of the one or more best second beams of the plurality of second beams; and wherein the further information may be data of the backscatter device or of the source device.

In one configuration, the second CSI report may include a channel estimate for an overall channel between the source device and the destination device via the backscatter device, and wherein in response to the channel estimate, the another signal may be transmitted from the source device: in one of the one or more first best beams, or using a different transmission parameter than a transmission parameter associated with the signal carrying the first information.

In one configuration, the signal carrying the first information may be configured to supply power, to a plurality of backscatter devices including the backscatter device, to communicate a reference signal from each of the backscatter devices to the destination device, the modulated signal comprising one of the reference signals; and wherein each of the reference signals may include an orthogonal sequence relative to other ones of the reference signals, and each of the orthogonal sequences may be associated with a different one of the backscatter devices.

The aforementioned means may be one or more of the aforementioned components of the apparatus 1802 configured to perform the functions recited by the aforementioned means. As described supra, the apparatus 1802 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

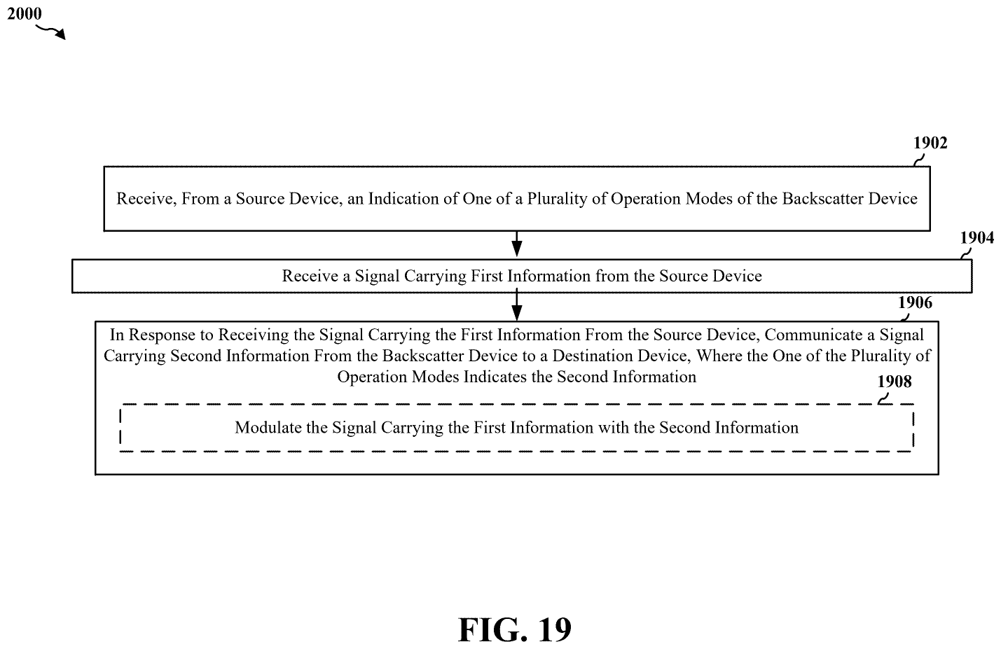

FIG. 19 is a flowchart 1900 of a method of wireless communication. The method may be performed by a backscatter device (e.g., backscatter device 506, 706, 806, 908, 1006, 1106, 1406; the apparatus 1702 (FIG. 17)). Optional aspects are illustrated in dashed lines.

At 1902, the backscatter device may receive, from a source device, an indication of one of a plurality of operation modes of the backscatter device. For example, 1902 may be performed by operation mode component 1742. For instance, referring to FIG. 14, Device 1 may transmit an indication 1414 to the backscatter device of an active one of a plurality of operation modes 1416 to be applied to transmissions of the backscatter device.

At 1904, the backscatter device may receive a signal carrying first information from the source device, and at 1906, in response to receiving the signal carrying the first information from the source device, the backscatter device communicates a signal carrying second information from the backscatter device to a destination device. For instance, at 1908, the backscatter device may modulate the signal carrying the first information with the second information. For example, 1904, 1906, and 1908 may each be performed by signal component 1746. For instance, referring to FIG. 14, Device 1 may transmit a signal 1426 carrying first information 1420 to the backscatter device (e.g., for the backscatter device to re-direct to Device 2) using the one or more transmission parameters 1419. Upon receiving the signal 1426 from Device 1, the backscatter device 1406 may transmit a modulated signal 1428 carrying second information 1430 to Device 2. For instance, the received signal may supply power 1432 (e.g., energy) to, trigger, or otherwise activate the mixer(s), oscillator(s), processor(s) or other components of the backscatter device to modulate the signal 1426 with the second information 1430 and to communicate the second information as well as the first information 1420 in the modulated signal 1428 to Device 2.

The one of the plurality of operation modes indicates the second information. In one example, the one of the plurality of operation modes further indicates whether the second information is the second data or the second reference signal sequence. For example, the plurality of operation modes may comprise: a first mode indicating the backscatter device to re-direct the first data from the source device in a beam towards the destination device, a second mode indicating the backscatter device to transmit the second data to the destination device, a third mode indicating the backscatter device to transmit the second reference signal sequence to the destination device, and a fourth mode indicating the backscatter device to power down. For instance, referring to FIG. 14, the plurality of operation modes 1416 may, for example, include a first mode in which the backscatter device acts as a beamforming device which transmits data of Device 1 to Device 2, a second mode in which the backscatter device transmits its own data to Device 2, a third mode in which the backscatter device transmits a reference signal to Device 2, and a fourth mode in which the backscatter device does not transmit any data or reference signals.

Accordingly, aspects of the present disclosure allow a source device (e.g., an RF source) to indicate to a destination device (e.g., an RF reader) a joint operation mode of the source device and a backscatter device (e.g., an EH device or a semi-passive IoT device). The joint operation mode may indicate the information (e.g., data or reference signal) that the source device may send to the destination device via the backscatter device, as well as the information (e.g., data or reference signal) that the backscatter device may send to the destination device, thereby facilitating decoding of the information (e.g., with respect to interference cancellation) by the destination device. The utilization of a backscatter device for communications between the source device and the destination device may result in power savings, spectrum efficiency, and lower network costs.

Other aspects of the present disclosure provide considerations which the source device, the backscatter device, and destination device may apply for beam management. For example, the operation of the backscatter device as a beamforming element for the source device may provide a different path of communication between the source device and destination device for diversity purposes. A nested beam sweep of first beams from the source device and second beams from the backscatter device, as well as a reception beam sweep of the destination device, may allow for the various devices to determine best beam combinations for subsequent communications. Managing beams in a two phase process, in which the source device may perform a beam sweep of direct beams towards the destination device in a first phase and the nested beam sweep in a second phase, may allow the different devices to determine whether direct communication or indirect communications (via the backscatter device) are stronger, leading to improved beam refinement. CSI reports may be provided from the destination device to the source device for direct link beam refinement and separately to both the source device and the backscatter device for backscattered beam refinement, resulting in improved subsequent communications based on the CSI reports. Filtering of undesired direct beams from the determination of best beam combinations in the nested beam sweep may be accomplished to further improve the beam management process. Additionally, reduction of the two phase process into a single phase, combined with separate filtering of direct beams and backscattered beams, may speed up the determination of best direct beams and beam combinations for subsequent beam refinement. Moreover, utilization of multiple backscatter devices may provide additional paths of communication for improved diversity (e.g., following beam refinement).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following embodiments are illustrative only and may be combined with aspects of other embodiments or teachings described herein, without limitation.

1. An apparatus for wireless communication, comprising:
a processor;
memory coupled with the processor; and
instructions stored in the memory and operable, when executed by the processor, to cause the apparatus to:
   transmit, to a destination device, an indication of one of a plurality of joint operation modes of the apparatus and a backscatter device, and
   transmit a first signal carrying first information;
   wherein the first signal carrying the first information is configured to activate the backscatter device to communicate a second signal carrying second information from the backscatter device to the destination device;
   wherein the one of the plurality of joint operation modes indicates the first information and the second information.

2. The apparatus of embodiment 1, wherein the second signal carrying the second information is a signal carrying the first information modulated with the second information.

3. The apparatus of embodiment 1 or 2, wherein the indication is transmitted in one of downlink control information, DCI, sidelink control information, SCI, a medium access control, MAC, control element, MAC-CE, or a radio resource control, RRC, configuration.

4. The apparatus of any of the preceding embodiments, wherein the indication includes a duration over which the one of the plurality of joint operation modes is active.

5. The apparatus of any of the preceding embodiments, wherein the plurality of joint operation modes comprises:
a first mode in which the first information is first data and the second information is second data,
a second mode in which the first information is a first reference signal sequence and the second information is the second data,
a third mode in which the first information is the first data and the second information is a second reference signal sequence, and
a fourth mode in which the first information is the first reference signal sequence and the second information is the second reference signal sequence,
wherein the apparatus and the backscatter device further include a fifth mode indicating the backscatter device to power down.

6. The apparatus of embodiment 5, wherein the instructions, when executed by the processor, further cause the apparatus to:
transmit, to the backscatter device, another indication of one of a plurality of operation modes of the backscatter device;
wherein the one of the plurality of operation modes further indicates whether the second information is the second data or the second reference signal sequence.

7. The apparatus of embodiment 6, wherein the plurality of operation modes comprises:
a first mode indicating the backscatter device to re-direct the first data from the apparatus in a beam towards the destination device,
a second mode indicating the backscatter device to transmit the second data to the destination device, and
a third mode indicating the backscatter device to transmit the second reference signal sequence to the destination device,
wherein the backscatter device further includes a fourth mode indicating the backscatter device to power down.

8. The apparatus of any of the preceding embodiments,
wherein the first information is transmitted to the backscatter device in each of a plurality of first beams during a first beam sweep of the apparatus, and
wherein the communication of the second information from the backscatter device to the destination device is in each of a plurality of second beams during a second beam sweep of the backscatter device.

9. The apparatus of embodiment 8, wherein the second information in each of the second beams is a reference signal sequence, and each of the reference signal sequences is one of a plurality of configured sequences for channel sounding or beam management.

10. The apparatus of embodiment 8, wherein the instructions, when executed by the processor, further cause the apparatus to:
transmit, prior to the first beam sweep, the first information directly to the destination device in each of a plurality of direct beams during a direct beam sweep of the apparatus.

11. The apparatus of embodiment 10, wherein the instructions, when executed by the processor, further cause the apparatus to:
receive a first channel state information, CSI, report and a second CSI report from the destination device;
wherein the first CSI report indicates one or more best direct beams of the plurality of direct beams; and
wherein the second CSI report indicates one or more best beam combinations of the plurality of first beams and of the plurality of second beams.

12. The apparatus of embodiment 11, wherein the instructions, when executed by the processor, further cause the apparatus to:
in response to the one or more best direct beams being stronger than the one or more best beam combinations of the plurality of first beams and of the plurality of second beams,
transmit subsequent information to the destination device in one of the one or more best direct beams.

13. The apparatus of embodiment 11, wherein the instructions, when executed by the processor, further cause the apparatus to:
in response to the one or more best beam combinations of the plurality of first beams and of the plurality of second beams being stronger than the one or more best direct beams,
transmit a third signal carrying subsequent information to the backscatter device in one of the one or more best first beams of the plurality of first beams;
wherein the third signal is configured to activate the backscatter device to communicate a fourth signal carrying further information from the backscatter device to the destination device in one of the one or more best second beams of the plurality of second beams; and
wherein the further information is data of the backscatter device or the apparatus.

14. The apparatus of embodiment 13,
wherein the second CSI report includes a channel estimate for an overall channel between the apparatus and the destination device via the backscatter device, and
wherein in response to the channel estimate, the third signal is transmitted from the apparatus:
   in one of the one or more first best beams, or
   using a different transmission parameter than a transmission parameter associated with the first signal carrying the first information.

13. The apparatus of any of the preceding embodiments,
wherein the first signal carrying the first information is configured to activate a plurality of backscatter devices including the backscatter device to communicate a reference signal from each of the backscatter devices to the destination device, wherein the signal carrying the second information comprises one of the reference signals; and
wherein each of the reference signals includes an orthogonal sequence relative to other ones of the reference signals, and each of the orthogonal sequences is associated with a different one of the backscatter devices.

16. A method of wireless communication at a source device, comprising:
transmitting, to a destination device, an indication of one of a plurality of joint operation modes of the source device and a backscatter device, and
transmitting a first signal carrying first information;
wherein the first signal carrying the first information is configured to activate the backscatter device to communicate a second signal carrying second information from the backscatter device to the destination device;
wherein the one of the plurality of joint operation modes indicates the first information and the second information.

17. The method of embodiment 16, wherein the second signal carrying the second information is a signal carrying the first information modulated with the second information.

18. The method of embodiment 16,
wherein the first information is transmitted to the backscatter device in each of a plurality of first beams during a first beam sweep of the source device, and
wherein the communication of the second information from the backscatter device to the destination device is in each of a plurality of second beams during a second beam sweep of the backscatter device.

19. An apparatus for wireless communication, comprising:
a processor;
memory coupled with the processor; and
instructions stored in the memory and operable, when executed by the processor, to cause the apparatus to:
   receive, from a source device, an indication of one of a plurality of joint operation modes of the source device and a backscatter device;
   receive a first signal from the backscatter device, the first signal including a second signal carrying first information from the source device and second information from the backscatter device, the second signal being configured to activate the backscatter device to communicate the first signal;
   wherein the one of the plurality of joint operation modes indicates the first information and the second information.

20. The apparatus of embodiment 19, wherein the first signal includes the second signal modulated with the second information from the backscatter device.

21. The apparatus of any of the preceding embodiments 19 to 20, wherein the first signal is received from the backscatter device in each of a plurality of reception beams during a reception beam sweep of the apparatus.

22. The apparatus of any of the preceding embodiments 19 to 21,
wherein the second signal carrying the first information is in each of a plurality of first beams during a first beam sweep of the source device, and
wherein the first signal received from the backscatter device is in each of a plurality of second beams during a second beam sweep of the backscatter device.

23. The apparatus of embodiment 22, wherein the instructions, when executed by the processor, further cause the apparatus to:
determine one or more best beam combinations of the plurality of first beams and of the plurality of second beams from the first signals in the second beams.

24. The apparatus of embodiment 23, wherein the instructions, when executed by the processor, further cause the apparatus to:
receive, prior to the first beam sweep and prior to determining the one or more best beam combinations, the second signal carrying the first information from the source device in each of a plurality of direct beams during a direct beam sweep of the source device.

25. The apparatus of embodiment 24, wherein the instructions, when executed by the processor, further cause the apparatus to:
determine one or more best direct beams of the plurality of direct beams from the second signals in the direct beams.

26. The apparatus of embodiment 25, wherein the instructions, when executed by the processor, further cause the apparatus to:
transmit a first channel state information, CSI, report to the source device and a second CSI report to the source device and to the backscatter device;
wherein the first CSI report indicates the one or more best direct beams of the plurality of direct beams; and
wherein the second CSI report indicates the one or more best beam combinations of the plurality of first beams and of the plurality of second beams.

27. The apparatus of embodiment 26, wherein the second CSI report indicates a channel estimate for an overall channel between the source device and the apparatus via the backscatter device.

28. The apparatus of embodiment 23, wherein the instructions, when executed by the processor, further cause the apparatus to:
filter the second signals carrying the first information from the first signals before the one or more best beam combinations of the plurality of first beams and of the plurality of second beams are determined.

29. The apparatus of embodiment 23, wherein the instructions, when executed by the processor, further cause the apparatus to:
filter the second information from the first signals;
determine one or more best direct beams carrying the first information from the source device to the apparatus in response to the filtering of the second information; and
filter the first information from the first signals;
wherein the one or more best beam combinations of the plurality of first beams and of the plurality of second beams carrying the second information are determined in response to the filtering of the first information.

30. The apparatus of any of the preceding embodiments 19 to 29, wherein the instructions, when executed by the processor, further cause the apparatus to:
receive a reference signal from each one of a plurality of backscatter devices including the backscatter device, wherein the first signal comprises one of the reference signals;
wherein each of the reference signals includes an orthogonal sequence relative to other ones of the reference signals, and each of the orthogonal sequences is associated with a different one of the backscatter devices.

31. A method of wireless communication at a destination device, comprising:
receiving, from a source device, an indication of one of a plurality of joint operation modes of the source device and a backscatter device;
receiving a first signal from the backscatter device, the modulated signal including a second signal carrying first information from the source device and modulated with second information from the backscatter device, the second signal being configured to activate the backscatter device to communicate the first signal;
wherein the one of the plurality of joint operation modes indicates the first information and the second information.

32. The method of embodiment 30, wherein the first signal includes the second signal modulated with the second information from the backscatter device.

33. The method of any of the preceding embodiments 31 to 32,
wherein the second signal carrying the first information is in each of a plurality of first beams during a first beam sweep of the source device, and
wherein the first signal received from the backscatter device is in each of a plurality of second beams during a second beam sweep of the backscatter device.

34. The method of embodiment 33, further comprising:
determining one or more best beam combinations of the plurality of first beams and of the plurality of second beams from the first signals in the second beams.

35. A method of wireless communication at a backscatter device, the method comprising:
receiving, from a source device, an indication of one of a plurality of operation modes of the backscatter device;
receiving a signal carrying first information from the source device; and
in response to receiving the signal carrying first information from the source device, communicating a signal carrying second information from the backscatter device to a destination device;
wherein the one of the plurality of operation modes indicates the second information.

36. The method of embodiment 35, wherein communicating the signal carrying second information from the backscatter device to the destination device includes modulating the signal carrying the first information with the second information.

37. A backscatter device, comprising:
a processor;
memory coupled with the processor; and
instructions stored in the memory and operable, when executed by the processor, to cause the backscatter device to:
receive, from a source device, an indication of one of a plurality of operation modes of the backscatter device;
receive a signal carrying first information from the source device; and
in response to receiving the signal carrying the first information from the source device, communicate a signal carrying second information from the backscatter device to a destination device;
wherein the one of the plurality of operation modes indicates the second information.

38. The backscatter device of embodiment 37, wherein communicating the signal carrying second information from the backscatter device to the destination device includes modulating the signal carrying the first information with the second information.

39. A computer program comprising instructions that, when executed on a processor, cause the processor to perform the steps according to any one of the embodiments 16 to 18 or 31 to 35.

What is claimed is:

1. An apparatus for wireless communication, comprising:
a processor;
memory coupled with the processor; and
instructions stored in the memory and operable, when executed by the processor, to cause the apparatus to:
transmit, to a destination device, an indication of one of a plurality of joint operation modes of the apparatus and a backscatter device, and
transmit a first signal carrying first information;
wherein the first signal carrying the first information is configured to activate the backscatter device to communicate a second signal carrying second information from the backscatter device to the destination device;
wherein the one of the plurality of joint operation modes indicates the first information and the second information.

2. The apparatus of claim 1, wherein the second signal carrying the second information is a signal carrying the first information modulated with the second information.

3. The apparatus of claim 1, wherein the indication is transmitted in one of downlink control information, DCI, sidelink control information, SCI, a medium access control, MAC, control element, MAC-CE, or a radio resource control, RRC, configuration.

4. The apparatus of claim 1, wherein the indication includes a duration over which the one of the plurality of joint operation modes is active.

5. The apparatus of claim 1, wherein the plurality of joint operation modes comprises
a first mode in which the first information is first data and the second information is second data,
a second mode in which the first information is a first reference signal sequence and the second information is the second data,
a third mode in which the first information is the first data and the second information is a second reference signal sequence, and
a fourth mode in which the first information is the first reference signal sequence and the second information is the second reference signal sequence,
wherein the apparatus and the backscatter device further include a fifth mode indicating the backscatter device to power down.

6. The apparatus of claim 5, wherein the instructions, when executed by the processor, further cause the apparatus to:
transmit, to the backscatter device, another indication of one of a plurality of operation modes of the backscatter device;
wherein the one of the plurality of operation modes further indicates whether the second information is the second data or the second reference signal sequence.

7. The apparatus of claim 6, wherein the plurality of operation modes comprises:
a first mode indicating the backscatter device to re-direct the first data from the apparatus in a beam towards the destination device,
a second mode indicating the backscatter device to transmit the second data to the destination device, and
a third mode indicating the backscatter device to transmit the second reference signal sequence to the destination device,
wherein the backscatter device further includes a fourth mode indicating the backscatter device to power down.

8. The apparatus of claim 1,
wherein the first information is transmitted to the backscatter device in each of a plurality of first beams during a first beam sweep of the apparatus, and
wherein the communication of the second information from the backscatter device to the destination device is in each of a plurality of second beams during a second beam sweep of the backscatter device.

9. The apparatus of claim 8, wherein the second information in each of the second beams is a reference signal sequence, and each of the reference signal sequences is one of a plurality of configured sequences for channel sounding or beam management.

10. The apparatus of claim 8, wherein the instructions, when executed by the processor, further cause the apparatus to:
transmit, prior to the first beam sweep, the first information directly to the destination device in each of a plurality of direct beams during a direct beam sweep of the apparatus.

11. The apparatus of claim 10, wherein the instructions, when executed by the processor, further cause the apparatus to:
receive a first channel state information, CSI, report and a second CSI report from the destination device;
wherein the first CSI report indicates one or more best direct beams of the plurality of direct beams; and
wherein the second CSI report indicates one or more best beam combinations of the plurality of first beams and of the plurality of second beams.

12. The apparatus of claim 11, wherein the instructions, when executed by the processor, further cause the apparatus to:
in response to the one or more best direct beams being stronger than the one or more best beam combinations of the plurality of first beams and of the plurality of second beams,
transmit subsequent information to the destination device in one of the one or more best direct beams.

13. The apparatus of claim 11, wherein the instructions, when executed by the processor, further cause the apparatus to:
in response to the one or more best beam combinations of the plurality of first beams and of the plurality of second beams being stronger than the one or more best direct beams,
transmit a third signal carrying subsequent information to the backscatter device in one of the one or more best first beams of the plurality of first beams;
wherein the third signal is configured to activate the backscatter device to communicate a fourth signal carrying further information from the backscatter device to the destination device in one of the one or more best second beams of the plurality of second beams; and
wherein the further information is data of the backscatter device or the apparatus.

14. The apparatus of claim 13,
wherein the second CSI report includes a channel estimate for an overall channel between the apparatus and the destination device via the backscatter device, and
wherein in response to the channel estimate, the third signal is transmitted from the apparatus:
in one of the one or more first best beams, or
using a different transmission parameter than a transmission parameter associated with the first signal carrying the first information.

15. The apparatus of claim 1,
wherein the first signal carrying the first information is configured to activate each of a plurality of backscatter devices including the backscatter device to communicate a reference signal to the destination device, wherein the second signal carrying the second information comprises one of the reference signals; and
wherein each of the reference signals includes an orthogonal sequence relative to other ones of the reference signals, and each of the orthogonal sequences is associated with a different one of the backscatter devices.

16. A method of wireless communication at a source device, comprising:
transmitting, to a destination device, an indication of one of a plurality of joint operation modes of the source device and a backscatter device, and
transmitting a first signal carrying first information;
wherein the first signal carrying the first information is configured to activate the backscatter device to communicate a second signal carrying second information from the backscatter device to the destination device;
wherein the one of the plurality of joint operation modes indicates the first information and the second information.

17. An apparatus for wireless communication, comprising:
a processor;
memory coupled with the processor; and
instructions stored in the memory and operable, when executed by the processor, to cause the apparatus to:
receive, from a source device, an indication of one of a plurality of joint operation modes of the source device and a backscatter device;
receive a first signal from the backscatter device, the first signal including a second signal carrying first information from the source device and second information from the backscatter device, the second signal being configured to activate the backscatter device to communicate the first signal;
wherein the one of the plurality of joint operation modes indicates the first information and the second information.

18. The apparatus of claim 17, wherein the first signal is received from the backscatter device in each of a plurality of reception beams during a reception beam sweep of the apparatus.

19. The apparatus of claim 17,
wherein the second signal carrying the first information is in each of a plurality of first beams during a first beam sweep of the source device, and
wherein the first signal received from the backscatter device is in each of a plurality of second beams during a second beam sweep of the backscatter device.

20. The apparatus of claim 19, wherein the instructions, when executed by the processor, further cause the apparatus to:
determine one or more best beam combinations of the plurality of first beams and of the plurality of second beams from the first signals in the second beams.

21. The apparatus of claim 20, wherein the instructions, when executed by the processor, further cause the apparatus to:
receive, prior to the first beam sweep and prior to determining the one or more best beam combinations, the second signal carrying the first information from the source device in each of a plurality of direct beams during a direct beam sweep of the source device.

22. The apparatus of claim 21, wherein the instructions, when executed by the processor, further cause the apparatus to:
determine one or more best direct beams of the plurality of direct beams from the second signals in the direct beams.

23. The apparatus of claim 22, wherein the instructions, when executed by the processor, further cause the apparatus to:
transmit a first channel state information, CSI, report to the source device and a second CSI report to the source device and to the backscatter device;
wherein the first CSI report indicates the one or more best direct beams of the plurality of direct beams; and
wherein the second CSI report indicates the one or more best beam combinations of the plurality of first beams and of the plurality of second beams.

24. The apparatus of claim 23, wherein the second CSI report indicates a channel estimate for an overall channel between the source device and the apparatus via the backscatter device.

25. The apparatus of claim 20, wherein the instructions, when executed by the processor, further cause the apparatus to:
filter the second signals carrying the first information from the first signals before the one or more best beam combinations of the plurality of first beams and of the plurality of second beams are determined.

26. The apparatus of claim 20, wherein the instructions, when executed by the processor, further cause the apparatus to:
filter the second information from the first signals;
determine one or more best direct beams carrying the first information from the source device to the apparatus in response to the filtering of the second information; and
filter the first information from the first signals;
wherein the one or more best beam combinations of the plurality of first beams and of the plurality of second beams carrying the second information are determined in response to the filtering of the first information.

27. The apparatus of claim 17, wherein the instructions, when executed by the processor, further cause the apparatus to:
receive a reference signal from each one of a plurality of backscatter devices including the backscatter device, wherein the first signal comprises one of the reference signals;
wherein each of the reference signals includes an orthogonal sequence relative to other ones of the reference signals, and each of the orthogonal sequences is associated with a different one of the backscatter devices.

28. The apparatus of claim 17, wherein the first signal includes the second signal modulated with the second information from the backscatter device.

29. A backscatter device, comprising:
a processor;
memory coupled with the processor; and
instructions stored in the memory and operable, when executed by the processor, to cause the backscatter device to:
receive, from a source device, an indication of one of a plurality of operation modes of the backscatter device;
receive a signal carrying first information from the source device; and
in response to receiving the signal carrying the first information from the source device, communicate a signal carrying second information from the backscatter device to a destination device;
wherein the one of the plurality of operation modes indicates the second information.

30. The backscatter device of claim 29, wherein communicating the signal carrying second information from the backscatter device to the destination device includes modulating the signal carrying the first information with the second information.
